(19) United States
(12) Patent Application Publication
(10) Pub. No.: US 2017/0116560 A1
(43) Pub. Date: Apr. 27, 2017

(54) REAL ESTATE CONSTRUCTION LOAN MANAGEMENT SYSTEM AND METHOD WITH FIELD INSPECTOR INTERFACE AND GEOTAG VERIFICATION

(71) Applicant: Built Technologies, Inc., Nashville, TN (US)

(72) Inventors: Timothy John Wickstrom, Nashville, TN (US); David Chase Gilbert, Nashville, TN (US); Andrew Patrick Sohr, Nashville, TN (US)

(21) Appl. No.: 15/151,018

(22) Filed: May 10, 2016

Related U.S. Application Data
(63) Continuation-in-part of application No. 15/150,198, filed on May 9, 2016.
(60) Provisional application No. 62/244,573, filed on Oct. 21, 2015.
(60) Provisional application No. 62/245,047, filed on Oct. 22, 2015.
(60) Provisional application No. 62/390,945, filed on Apr. 15, 2016.

(51) Int. Cl. G06Q 10/06; H04L 9/32; G06F 3/0484; G06Q 40/02

(52) U.S. Cl. CPC G06Q 10/063114; G06Q 40/025; H04L 9/3247; G06F 3/0484; G06Q 50/08

(57) ABSTRACT

The present invention is directed to a real estate construction loan management system and method for managing various aspects of construction loan portfolios. The construction loan management system includes a computer, accessible over a wired or wireless communication network by one or more electronic devices, and hosting executable construction loan management software that provides user-specific interfaces including a loan administrator interface, a bank administrator interface, a borrower interface, and an inspector interface, where each interface is navigated by authenticated users, to create and manage construction loans. The inspector interface is accessible by field inspectors to remotely manage scheduled inspections, and related inspection reports. The inspection reports are uploaded onto the construction loan management system, and verified according to geotag information.

### CROSS-REFERENCE TO RELATED APPLICATION

This application claims the benefit of co-pending U.S. patent application Ser. No. 15/150,198, entitled “Real Estate Construction Loan Management System With Field Inspector Interface and Geotag Verification,” filed May 9, 2016; Provisional Patent Application Serial No. 62/244,573, entitled, “Distributed Jurisdictional Construction Lending Services,” filed Oct. 21, 2015; Application Ser. No. 62/245,047, entitled, “Distributed Jurisdictional Construction Lending Services,” filed Oct. 22, 2015; and Application Ser. No. 62/390,945, entitled, “Real Estate Construction Loan Services and Method with Mobile APP Field Inspection and Verification,” filed Apr. 15, 2016, all which are incorporated herein in its entirety.

### FIELD OF INVENTION

The present invention relates to loan management systems, and more particularly, to a real estate construction loan management system and method including, user-specific interfaces for managing construction loans and field inspections, and geo-tag verification of field inspection reports.

### BACKGROUND OF THE INVENTION

Borrowers or builders generally visit financial institutions to consult with loan officers when seeking construction loans for financing building projects. Borrowers and loan officers are initially faced with the challenge of collecting and organizing complex documents needed for determining eligibility and approval. They not only have to deal with administrative tasks, but must also coordinate efforts to communicate with various parties involved throughout the process. Delayed channels of access and communication make it difficult for borrowers to coordinate and manage draws, manage loan account information, or keep track of building progress and payouts. Often, borrowers have limited contact with involved parties, and must rely on banks to initiate the inspection process by contacting inspectors. Lack of scheduling often results in inspectors being unavailable, thus delaying inspections, and completion of inspection reports. Further, because disbursement of funds are often governed by inspections to ensure proper construction of items, delayed inspections often result in untimely payments made to general contractors, sub-contractors, and for materials and supplies, leaving borrowers to seek better assurances in managing and coordinating inspections.

Dynamic changes in banking practices, training of personnel, and reallocation of resources, have led to lower levels of services for construction loans. More and more financial institutions and loan administrators are finding it difficult to oversee and manage project affiliated parties, organize and disburse payments, coordinate requested draws with completed inspections, and manage construction loans efficiently to better assist borrower needs. Such tasks become more cumbersome to handle when single or multiple borrowers seek multiple construction loans from a financial institution having various branches. Thus, borrowers and lending administrators are continuously faced with the challenge of efficiently managing construction loan portfolios.

Advancement in technology has replaced the manual paper process, and has emerged to provide some relief in lending services. For example, various online companies have provided loan financial services to borrowers in an effort to help streamline the loan application process. However, such companies typically require borrowers to seek third party agents to assist them in the approval process. In an effort to localize lending services, many financial institutions have implemented the use of software programs made available to loan administrators for managing financial loans. However, borrowers often feel left out and lack, or don't have access to, the information needed from various sources to make informed decisions regarding loan services, and building projects, and must rely on administrators to communicate and coordinate borrower needs. In addressing the lack of involvement by borrowers, lenders have adopted product-as-a-service programs (PaaS), that are generally downloaded on resident computers, on-site at lender branches, or separately loaded on home computers, and accessible by users. The PaaS software programs provide some assistance to borrowers in managing loan services but are not without drawbacks. For example, the PaaS software system requires borrowers to educate themselves on how to install and operate the software, limits global accessibility, requires complex hardware and software update management, and makes it difficult to implement functional add-ons that are needed to meet future needs of users and strategic initiatives.

The advent of on-going software development has led to improved loan management practices but fails to accommodate for inter-relationship of parties typically involved in construction lending services. For example, some conventional software programs are structured to provide payment management systems, document management systems, and financial analysis tools. Although such software programs address some aspects of managing construction loans, the programs fall short of meeting the needs of better organizing party involvement and user-specific management of loans as well as the need for accurately recording and reporting information. The prior art attempts to facilitate dealings between lenders and borrowers, but fails to enjoin the coordinated efforts of inspectors. Inspectors play a vital role in the construction lending services process, as they are charged with making on-site inspections, and completing inspection reports for lenders. Further, prior art does not address the importance and need for improving the reliability, credibility, and integrity of inspection reports. Submission of accurate inspection reports by qualified inspectors, helps reduce costs and expenses, promotes efficiency in the inspection process, and provides a vital tool for lenders to rely on to ensure construction is done according to building codes and to assure a secured interest in assets, and confidence in disbursing funds.

What is needed is a construction loan management system for efficiently, and effectively managing lending services, that is centrally hosted to provide global accessibility and ease in software management, that provides user-specific interfaces for allowing individual borrowers, lenders, loan administrators, and inspectors, to coordinate loan management processes, and that reduces unnecessary costs and expenses in managing software, and promotes system integrity by verifying inspection reports relied on by lenders in disbursing funds.

### SUMMARY OF THE INVENTION

The present invention is directed to a real estate construction loan management system and method for managing various aspects of construction loans. User-specific interfaces, defined as a loan administrator interface, a bank administrator interface, a borrower interface, and an inspector interface, are employed for navigating the construction loan management system, and managing various aspects of construction loans including creating user account information, managing draw requests, managing and scheduling inspections and inspection requests, and creating construction item templates. The inspector interface is accessible by field inspectors using an electronic client device over a communication network, for remotely managing scheduled inspections, and related inspection reports. Inspection reports are uploaded onto the construction loan management system, and verified in accordance with geotag information.

In one embodiment, the present invention provides a real estate construction loan management system and method comprising: a construction loan management computer accessible by one or more client devices over a communication network, each client device comprising a display screen, memory, and one or more processors able to receive, send, and display information, the construction loan management computer including one or more computer processors, computer readable memory, and a loan management software application stored in the computer-readable memory and executed by the one or more processors, where the loan management software application comprises: a plurality of loan service modules in operation with user-specific interfaces navigated by users to set-up, operate, and manage construction loans, the user-specific interfaces including a mobile inspector interface comprising a native application stored on, or a mobile web application accessible by, the one or more client devices, the mobile inspector interface providing authenticated access to the loan management computer, to display on the display screen of one or more client devices, a plurality of tasks managed by the construction loan management computer, and associated with a plurality of task-based screens, each of the plurality of tasks, selected by inspectors, to manage scheduled inspections, and where inspectors upload completed inspection reports onto the construction loan management computer where the loan management computer verifies the completed inspection reports based on geotag information.

In one aspect, the plurality of tasks includes: a schedule task associated with a schedule screen including one or more scheduled inspection properties, each selectable for accessing an inspection screen and viewing inspection items; a calendar task, enabling inspectors to access a calendar screen to view scheduled inspections corresponding to particular calendar dates, and further enabling inspectors to change previously scheduled inspection dates; a map task, enabling inspectors to access a geographical map screen showing mapped scheduled inspection properties mapped according to either, latitude/longitude coordinates, or location approximation data, where each mapped property may be accessed by inspectors to acquire driving directions, or view detailed information of selected properties; and a submit error task, and a comment task, each enabling inspectors to access a submit error screen, and a comment screen, respectively, to generate and send comments pertaining to, errors, inspection processes, scheduled inspection properties, or any of the inspection items.

Advantageously, each inspection item is assigned a project value, for representing a part of a completely constructed building, and an item progress value, for representing a value of completed construction of the inspection item, each inspection item includes a corresponding progress value tab enabling inspectors to change assigned item progress values of each of the inspection items, and also includes visual indicator corresponding to the item progress value.

In one aspect, the inspection screen includes: an information tab, selectable by inspectors, to access a property details screen showing details of selected scheduled inspection properties; a map-it tab, selectable by inspectors, to access the geographical map screen to view mapped properties; a camera tab, selectively enabling inspectors to utilize one of the client devices, such as a smartphone that includes a built-in camera, and a built-in global positioning system receiver, to capture images of inspection items associated with scheduled inspection properties, where each of the captured images are geotagged with geotag information including at least, geographic coordinates defined by latitude and longitude coordinates, and date and time; and a review inspection tab, enabling inspectors to access a review screen including a list of finalized inspection items, and building progress values including, a previous progress value representing a construction value of a completely constructed building before completion of one or more inspections, an inspection progress value representing a change in the construction value of a completely constructed building after completion of the one or more inspections, and a total progress value representing an added sum of the previous progress value, and the inspection progress value.

Advantageously, the review screen includes a complete inspection tab, enabling inspectors to access a finalize inspection screen and enter inspection summaries using a virtual keyboard provided on the client devices, where the finalize inspection screen includes a finalize inspection tab enabling inspectors to access an upload screen and submit inspection reports including captured images. A confirmation screen is provided for soliciting inspector signatures, and for uploading completed inspection reports onto the construction loan management computer.

In another aspect, the real estate construction loan management system and method of the present invention, includes, a geotag module for extracting geotag information from each captured image, and a verification module, for determining geographic coordinates from canonical address of scheduled inspection properties, and comparing the geographic coordinates of the scheduled inspection properties with the extracted geotag information, to verify attributes of completed inspection reports, where such attributes include any of, location of inspectors, location of captured images, identity of construction items, identity of inspectors, or dates and times.

In one embodiment of the present invention, the real estate construction loan management system and method further includes a loan administrator interface, and a bank administrator interface, each interface displaying, on each display screen of each client device, a plurality of loan admin management screens including a loan task bar, and a loan account bar, for setting-up, managing, and reviewing, construction loans and loan-related information, where such loan-related information includes, but is not limited to, borrower and inspector profile information, loan financials, property information, construction items templates, inspection settings, inspection requests, general and itemized draw requests, loan-related transactions, loan-related files, people contact information, and inspection images.

In one embodiment of the present invention, the real estate construction loan management system and method further includes a borrower interface displaying, on each display screen of each client device, a plurality of borrower loan screens, one of the plurality of borrower loan screens including a list of selectable borrower tasks, a borrower task bar, and a borrower account bar, for managing construction loans and loan-related information, where the list of selectable borrower tasks includes, but is not limited to, a request draws task, a request inspections task, a search for loans task, a construction portfolio summary task, a manage account settings task, and a support center task.

In yet another embodiment of the present invention, there is provided, a method of managing real estate construction loans, said method comprising the steps of: storing a loan management software application in a computer-readably memory executed by one or more processors of a construction loan management computer, where the construction loan management computer is accessible by one more client devices over a communication network, each client device includes a display, a processor, and is capable of receiving and sending information, the loan management software application including a plurality of loan service modules operating with user-specific interfaces including, a loan administrator interface, a bank administrator interface, a borrower interface, and a mobile inspection interface, where each interface is viewable in the display of each client device;

downloading the mobile inspector interface onto one or more client devices, or accessing the mobile inspector interface that is stored on the loan management computer with one or more client devices, where the mobile inspector interface includes a plurality of tasks, each task managed by the construction loan management computer and associated with a plurality of task-based screens;

presenting a log-on screen to users accessing the construction loan management computer with one or more client devices over the communication network, where the presented log-in screen solicits entry of user authentication credentials;

granting authenticated access to users, and presenting users with user-specific loan management screens tailored for each user-specific interface, and navigated by users to perform user-defined roles and functionalities for administrating and managing construction loans, and presenting one or more of the plurality of tasks to field inspectors, where the plurality of tasks are selected, by inspectors, for accessing one or more of the plurality of task-based screens for managing scheduled inspections; and

receiving completed inspection reports that are each uploaded by inspectors using one or more client devices, and verifying the completed inspection reports based on geotag information.

These and other advantages of the present invention will be further understood and appreciated by those skilled in the art by reference to the following written specifications, claims and appended drawings.

### DETAILED DESCRIPTION OF THE DRAWINGS

The invention will now be described, by way of example, with reference to the accompanying drawings, in which:

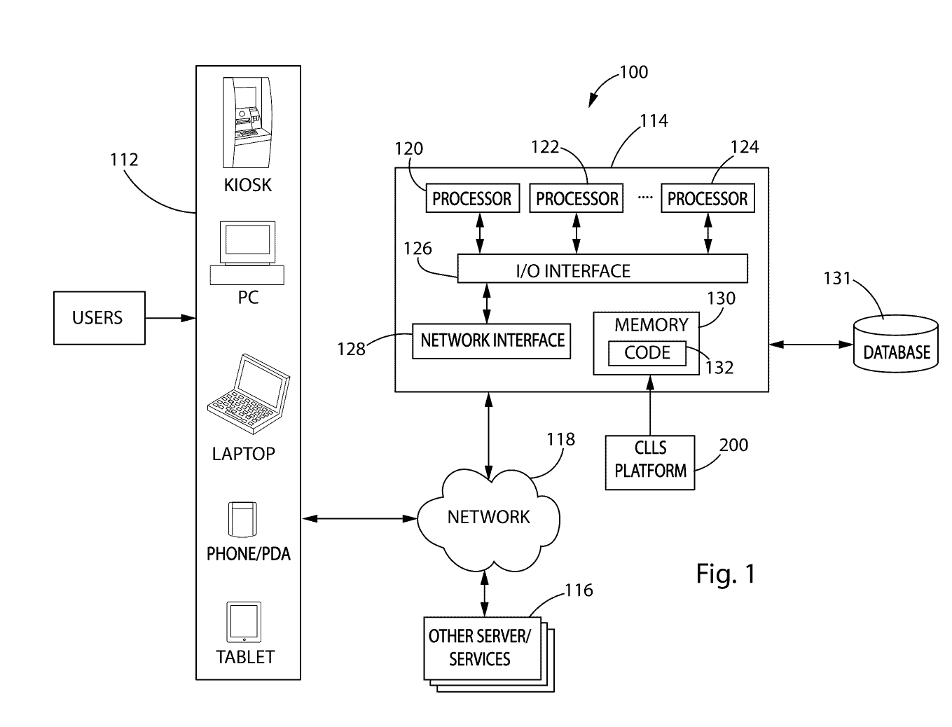

FIG. 1 is a graphical representation of a construction loan management system and method, in accordance with one embodiment of the present invention;

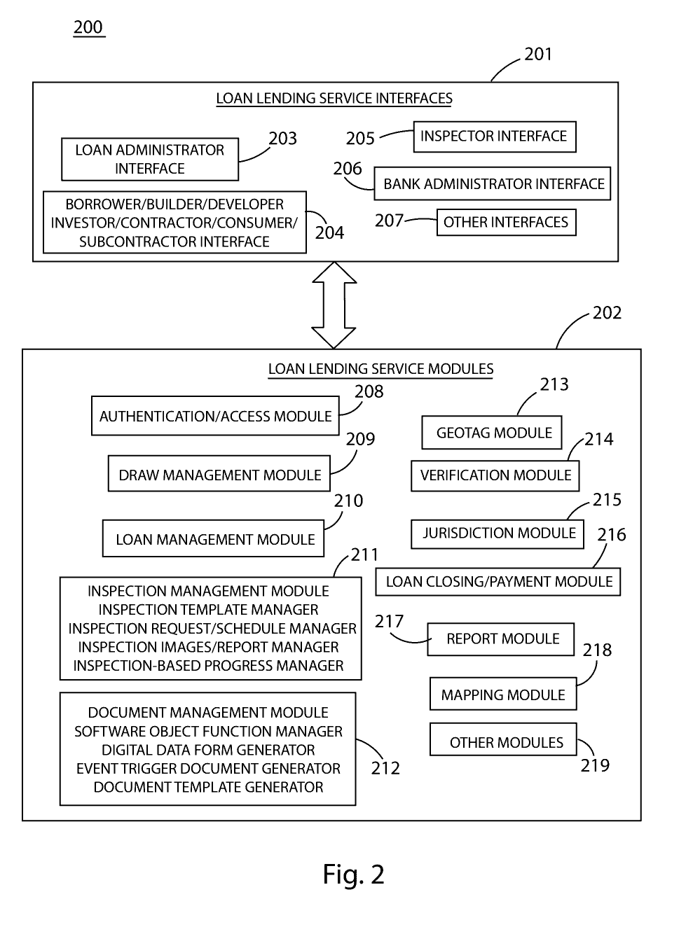

FIG. 2 is a block diagram illustrating a construction loan management system platform, showing functionality of service interfaces and modules, in accordance with one embodiment of the present invention;

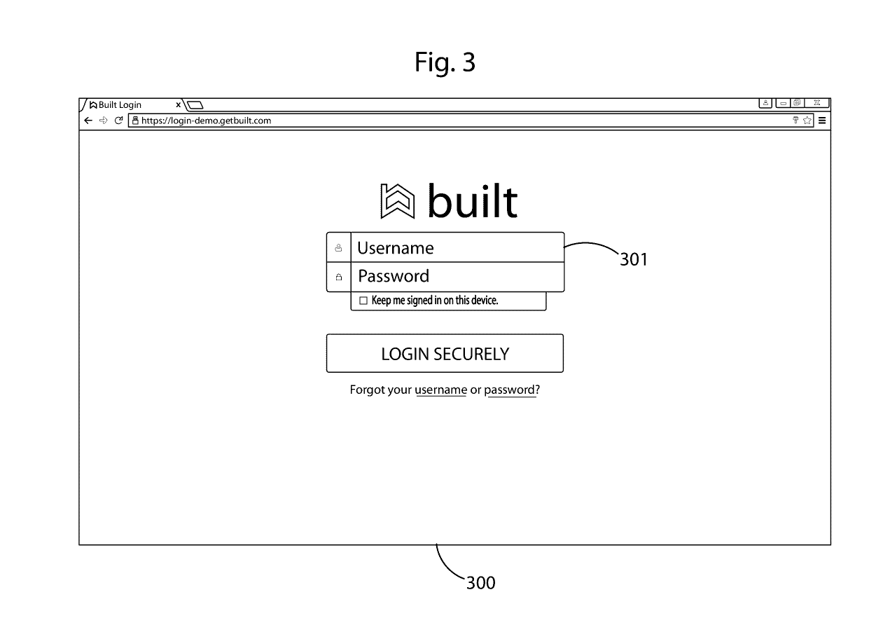

FIG. 3 is an illustration of a user log-in screen for accessing the construction loan management system platform, in accordance with one embodiment of the invention;

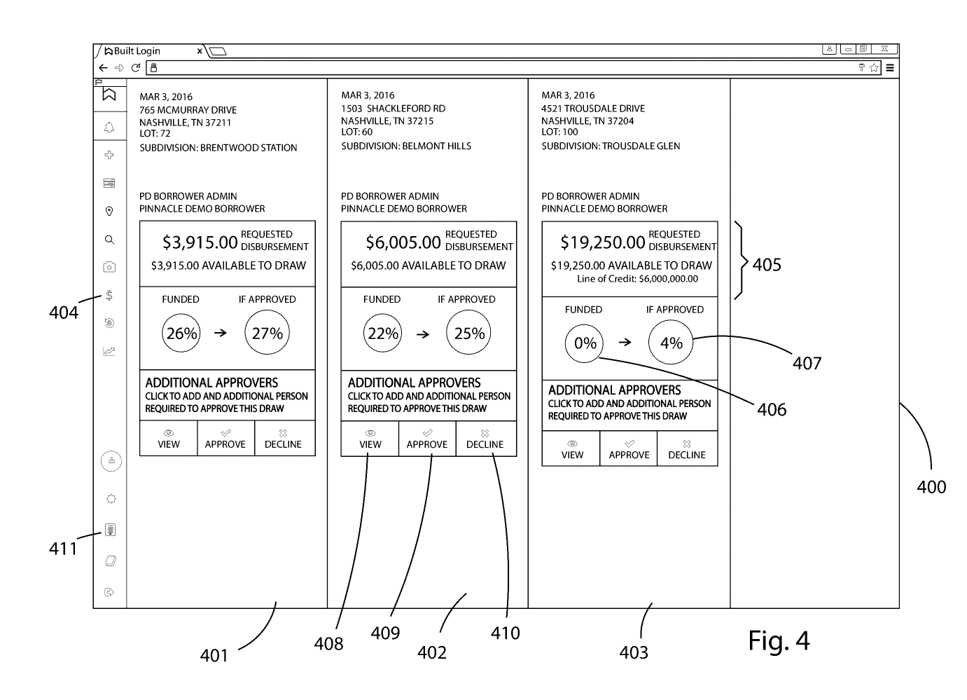

FIG. 4 is an administrator interface illustrating a construction loan management and draw approval screen, including an exemplary list of construction loans, a loan task bar, and a collapsible loan account bar, in accordance with one embodiment of the present invention;

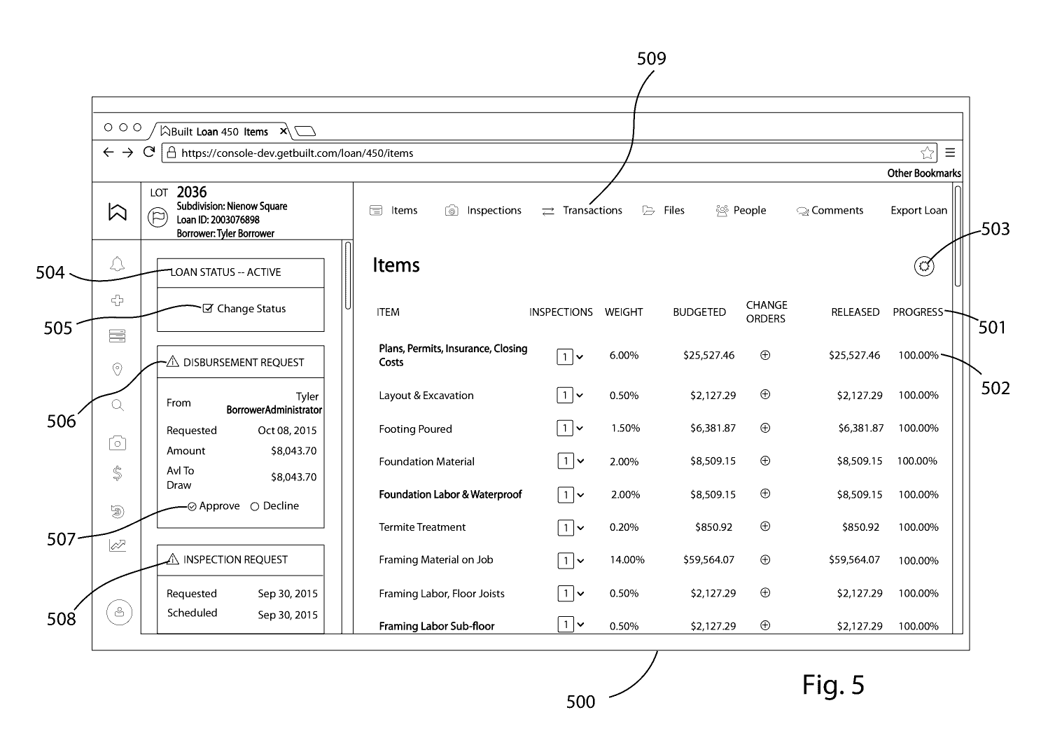

FIG. 5 is an administrator interface illustrating a construction items screen, showing an exemplary list of construction items regarding hard costs such as a loan, a loan activity menu, and a dashboard, in accordance with one embodiment of the present invention;

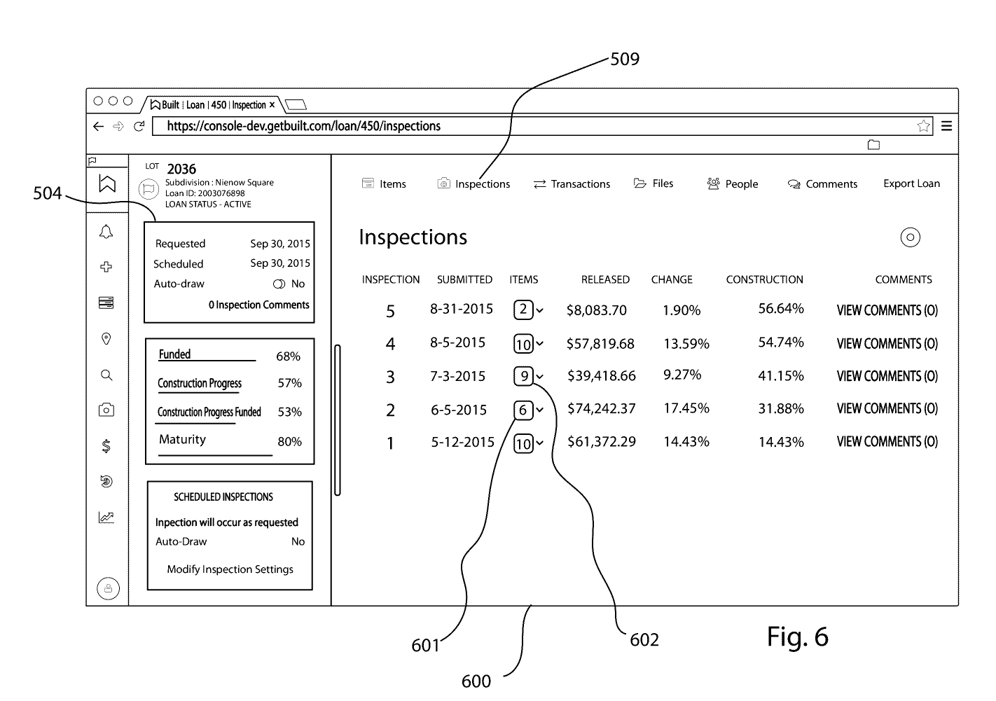

FIG. 6 is an administrator interface illustrating an inspections items screen, showing an exemplary list of inspections regarding a loan, pending budget change orders, and the loan activity menu, in accordance with one embodiment of the present invention;

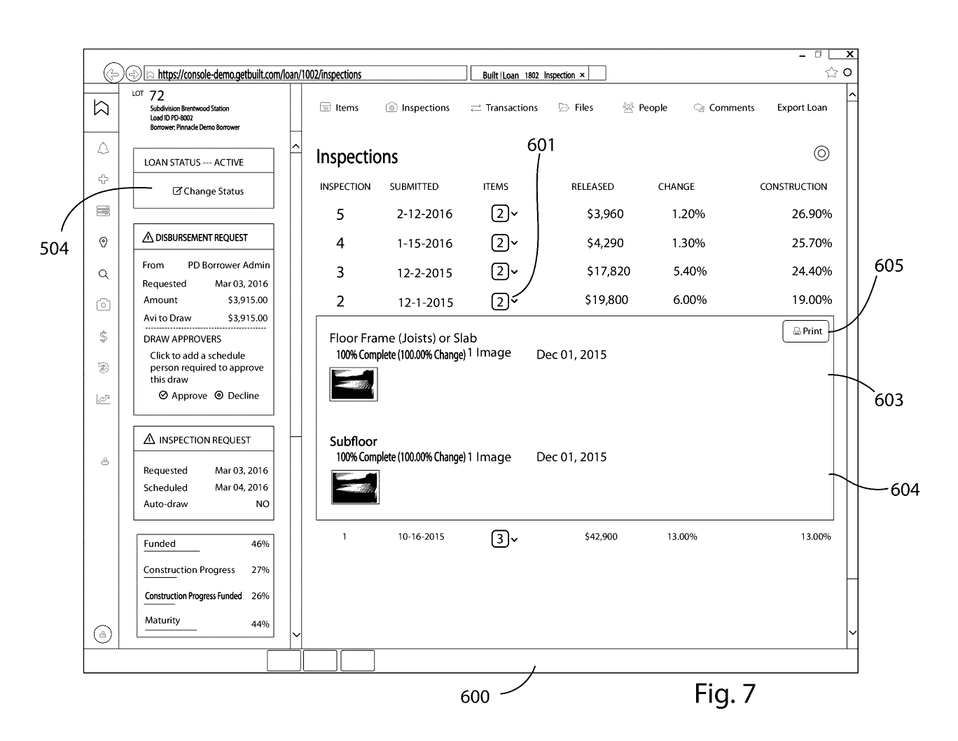

FIG. 7 is an administrator interface illustrating the inspections items screen of FIG. 6, showing exemplary thumbnail images of construction items, and the loan activity menu, in accordance with one embodiment of the present invention;

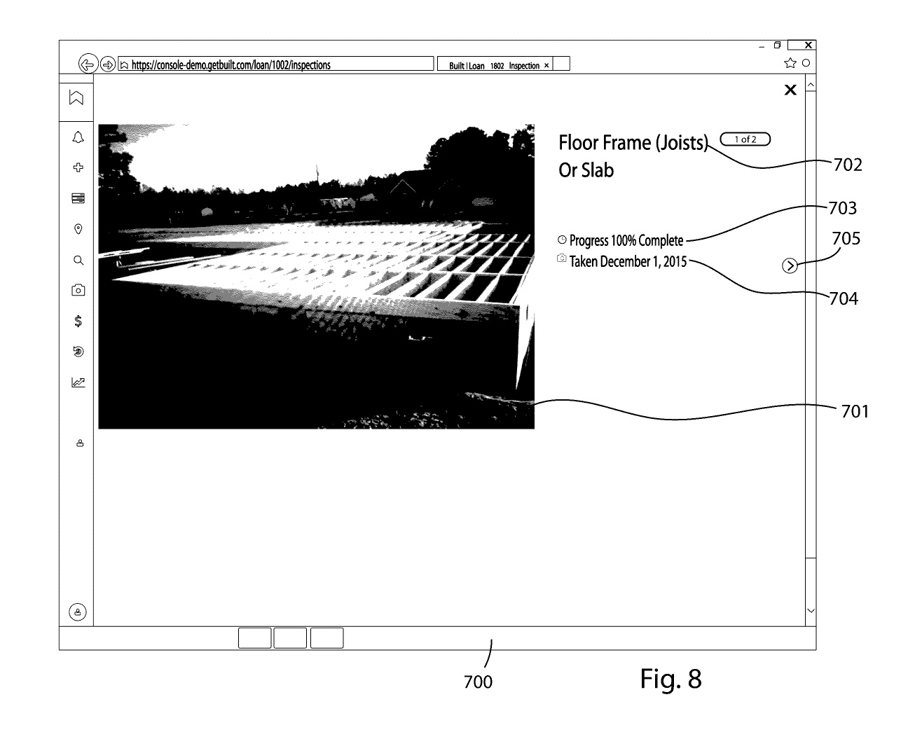

FIG. 8 is an administrator interface illustrating a thumbnail image of FIG. 7, shown enlarged, in accordance with one embodiment of the present invention;

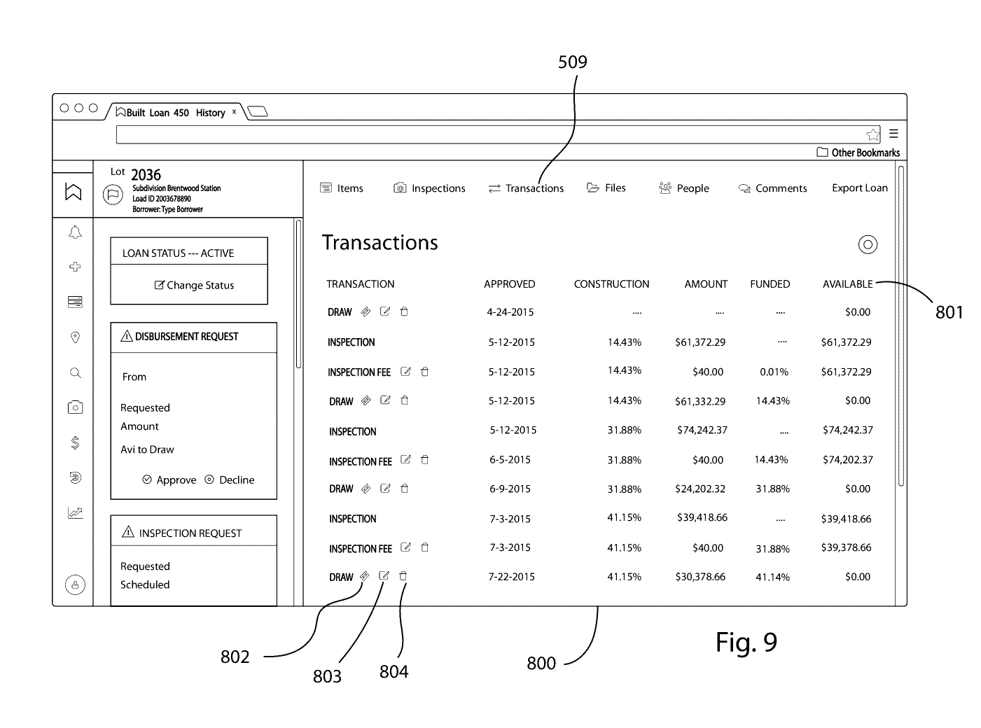

FIG. 9 is an administrator interface illustrating a loan transactions screen, showing an exemplary list of loan-related transactions, and the loan activity menu, in accordance with one embodiment of the present invention;

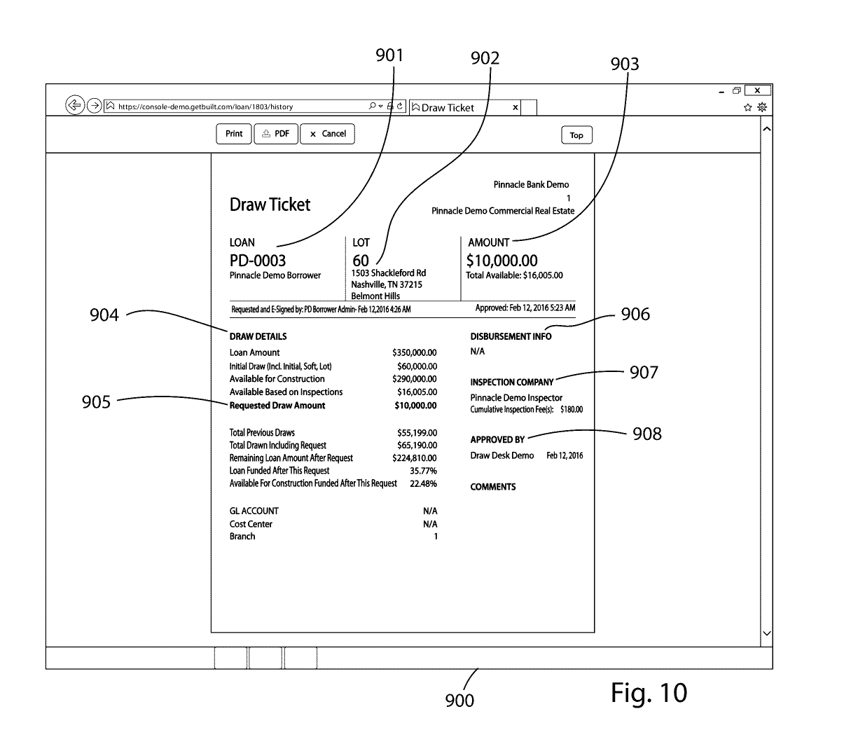

FIG. 10 is an illustration of a draw ticket screen, showing details of a draw for an exemplary loan, in accordance with one embodiment of the present invention;

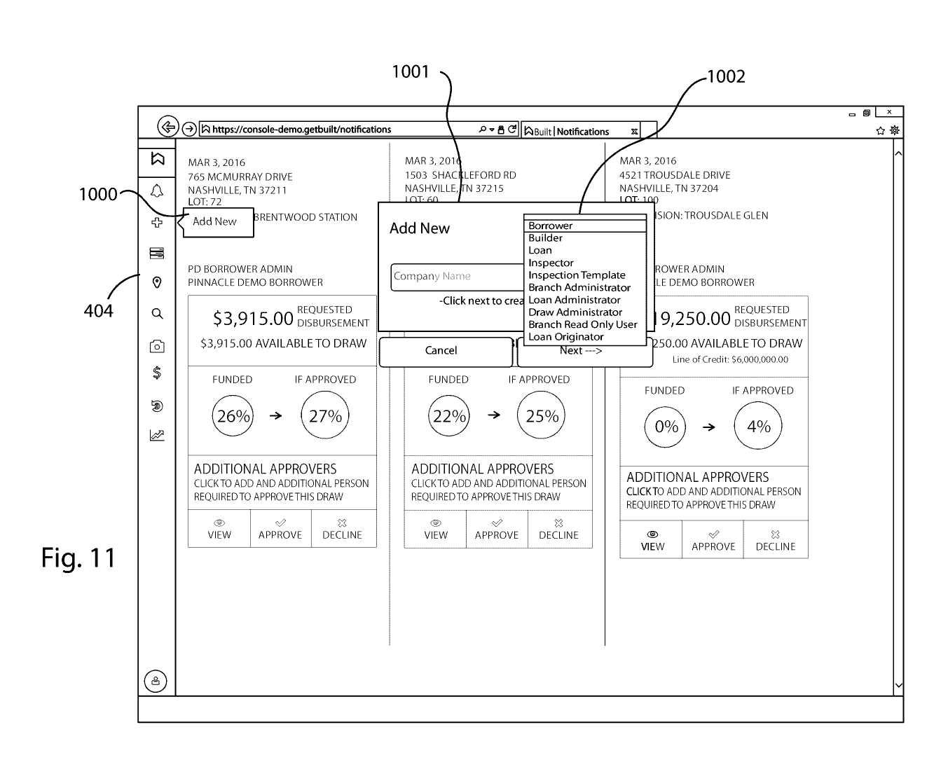

FIG. 11 is an administrator interface illustrating an add new screen, showing a drop down menu for creating and managing user profiles, and loan accounts, in accordance with one embodiment of the present invention;

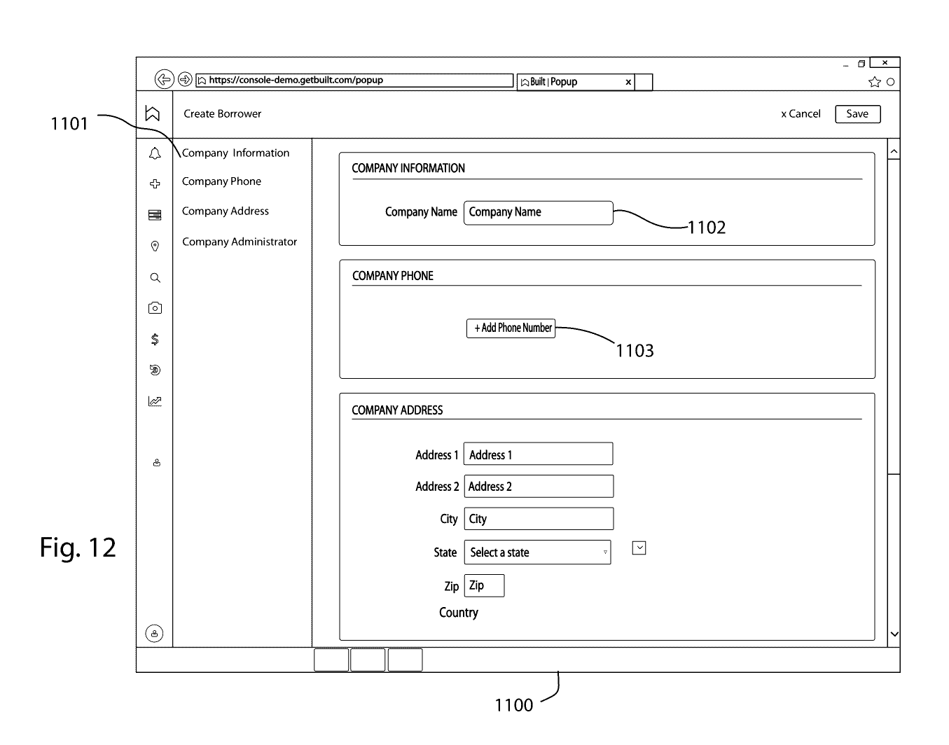

FIG. 12 is an administrator interface illustrating a create borrower screen, for creating and managing borrower profile information, including a borrower task menu, in accordance with one embodiment of the present invention;

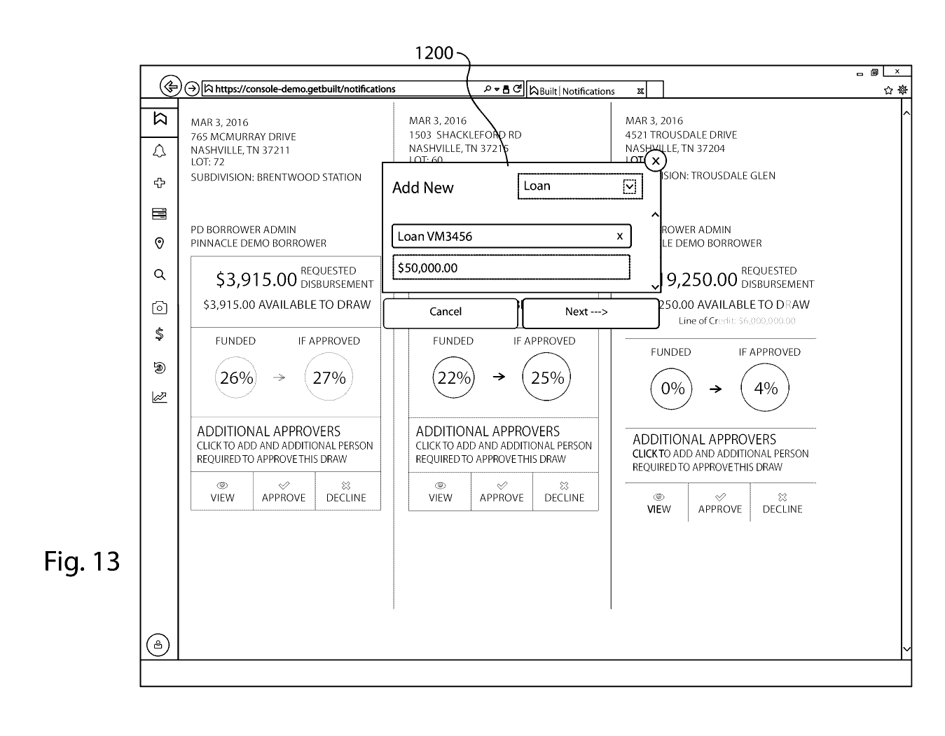

FIG. 13 is an administrator interface illustrating the add new screen of FIG. 11, for creating information relating to a new construction loan selected from the drop down menu, in accordance with one embodiment of the present invention;

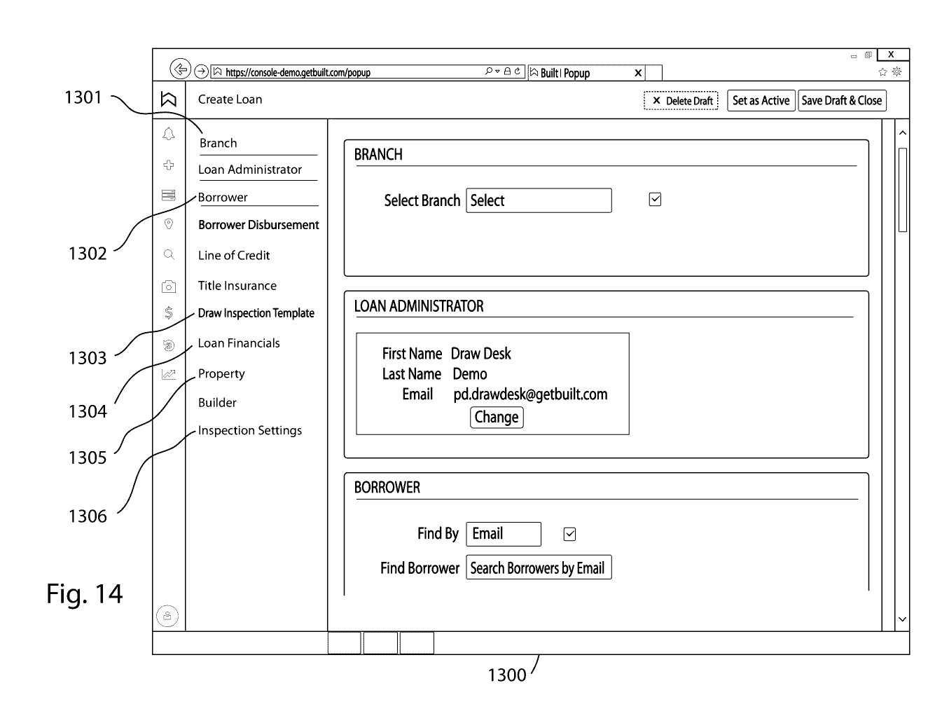

FIG. 14 is an administrator interface illustrating a create loan screen, for setting-up, and managing construction loan information, including a loan task menu, in accordance with one embodiment of the present invention;

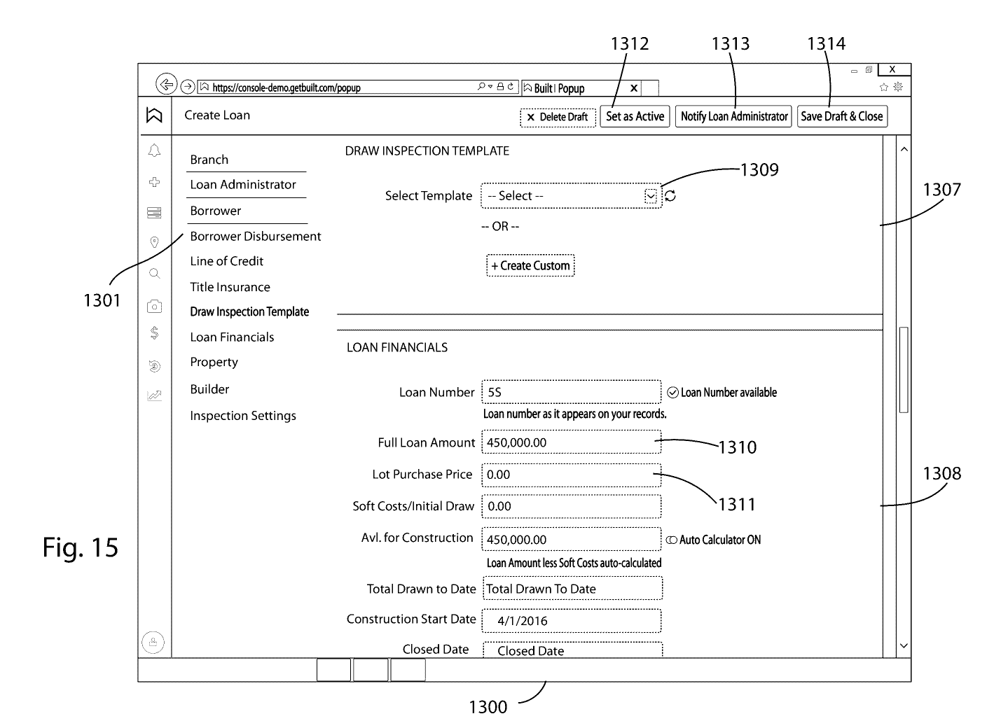

FIG. 15 is an administrator interface illustrating the create loan screen of FIG. 14, showing a draw inspection template section, and a loan financials section, in accordance with one embodiment of the present invention;

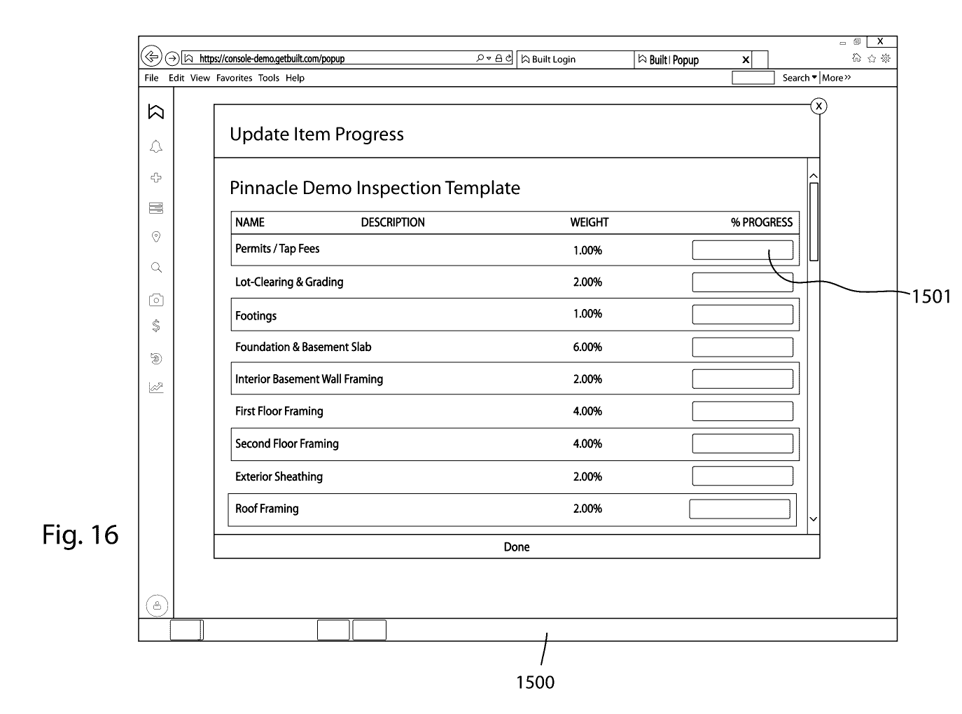

FIG. 16 is an administrator interface illustrating an item progress screen, showing a list of construction items and corresponding text-entry boxes for entering assigned progress values, in accordance with one embodiment of the present invention;

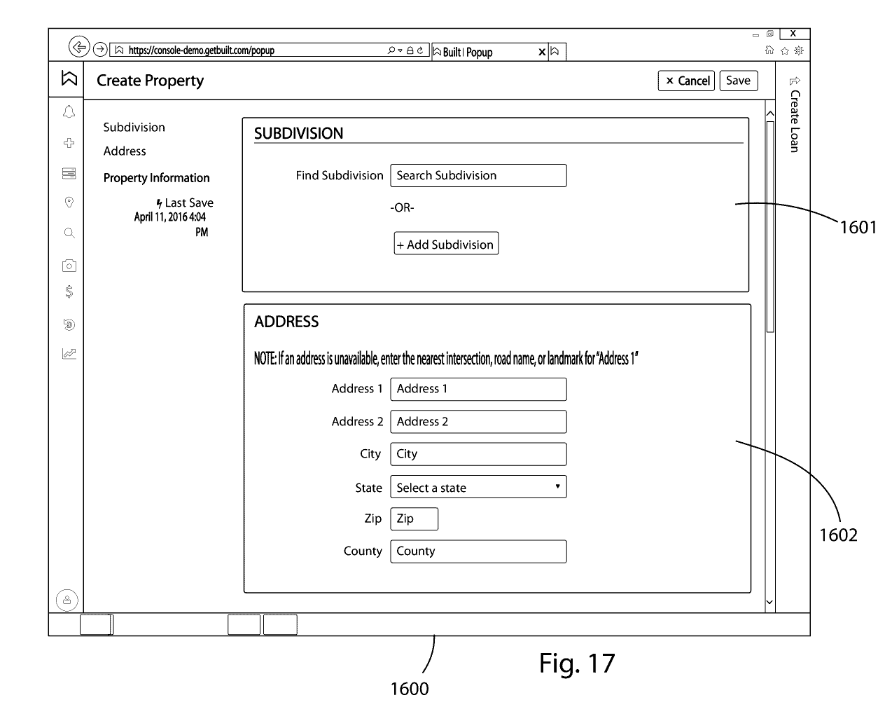

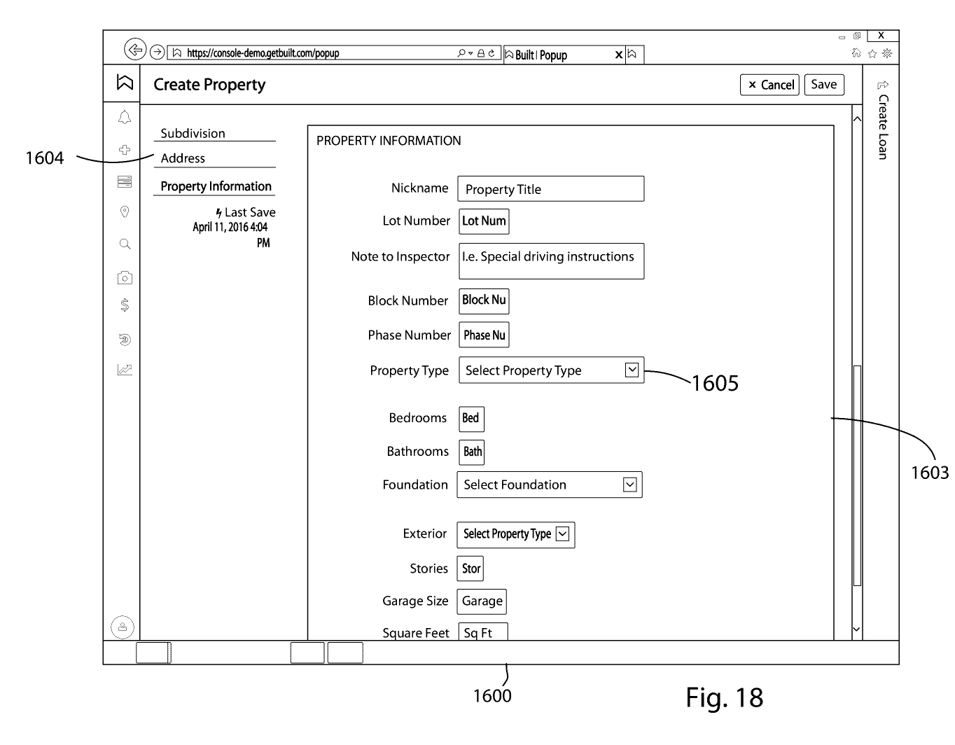

FIGS. 17 and 18 are administrator interfaces each illustrating a create property screen for setting-up, and managing property information, showing a property task menu, in accordance with one embodiment of the present invention;

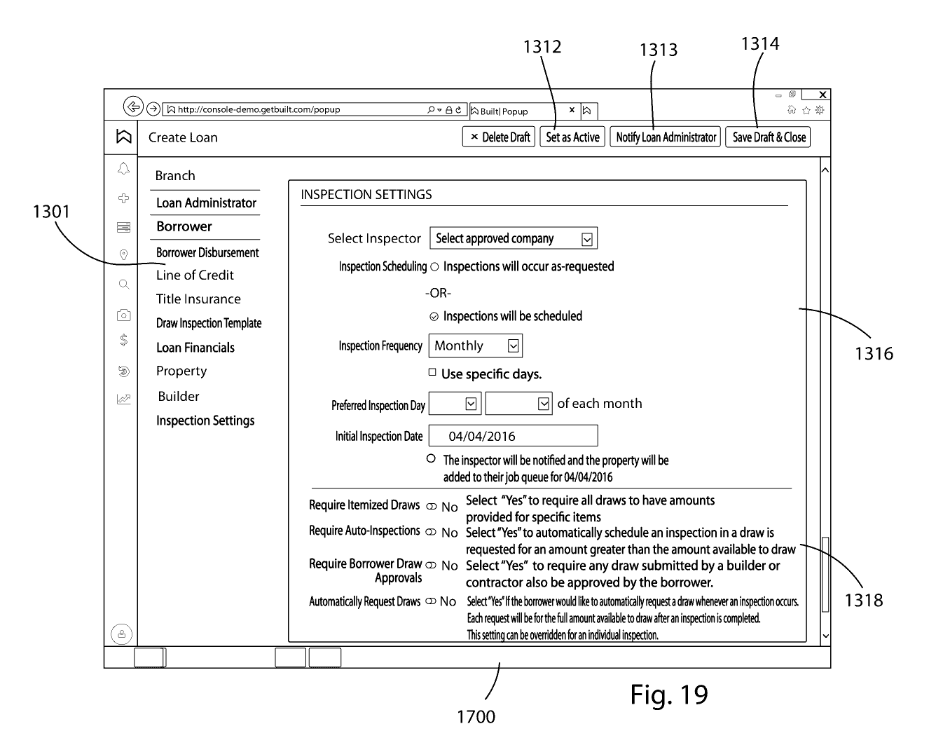

FIG. 19 is an administrator interface illustrating the create loan screen of FIG. 14, showing an inspection settings section for creating and managing inspection schedules, and draw settings, in accordance with one embodiment of the present invention;

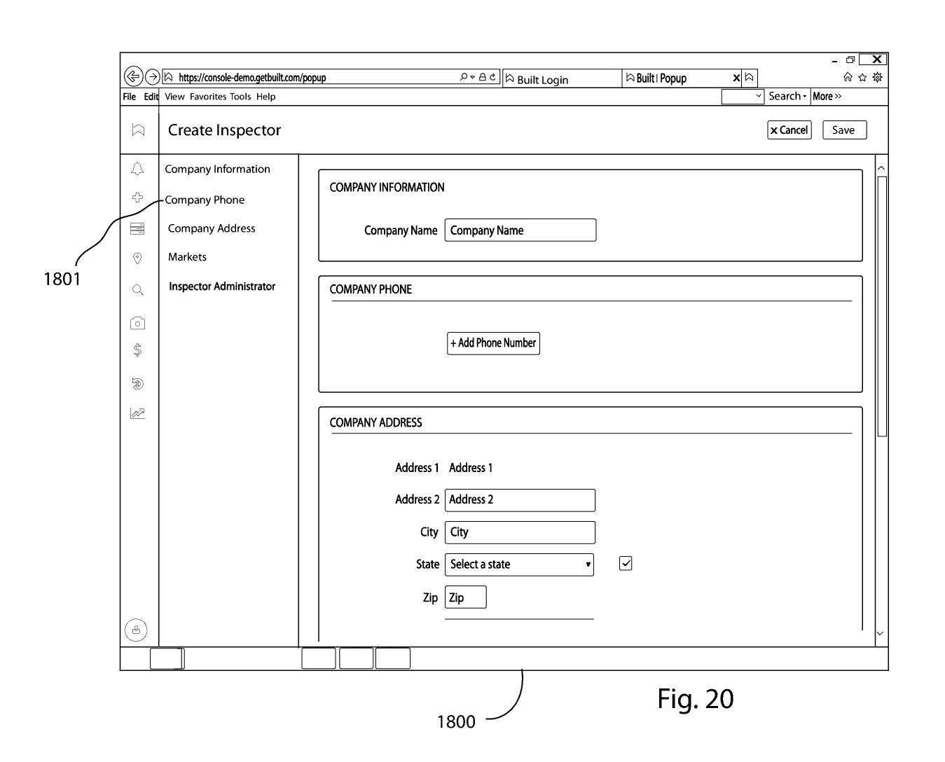

FIG. 20 is an administrator interface illustrating a create inspector screen, for setting-up, and managing inspector profile information, including an inspector task menu, in accordance with one embodiment of the present invention;

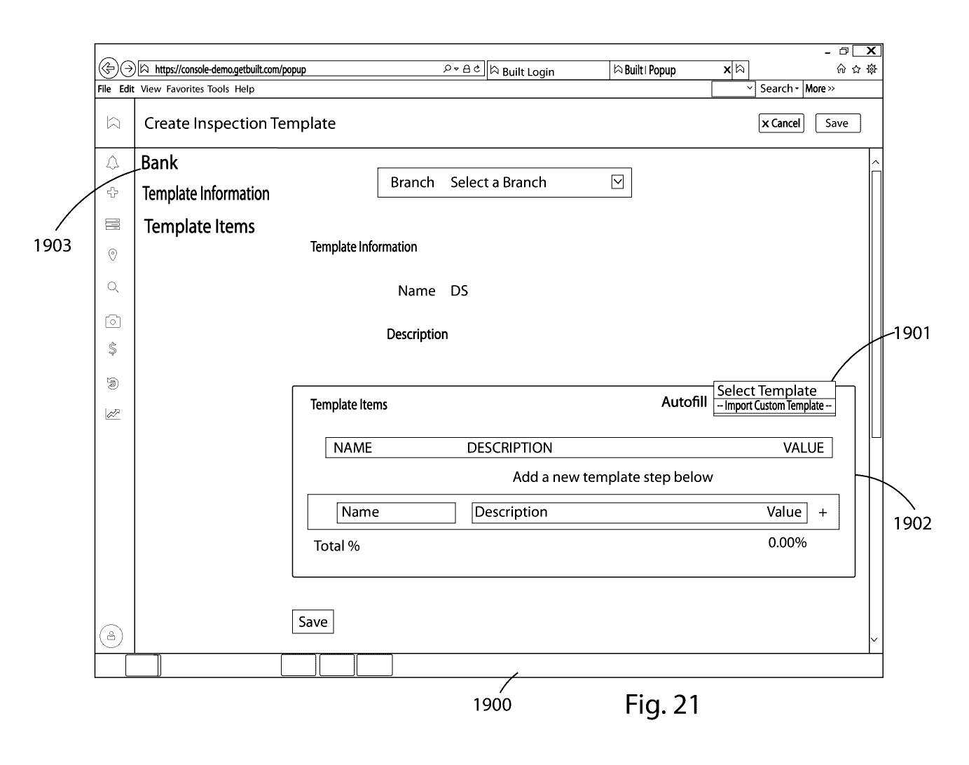

FIG. 21 is an administrator interface illustrating a create inspection template screen, for setting-up, and managing construction items, including an inspection template menu, in accordance with one embodiment of the present invention;

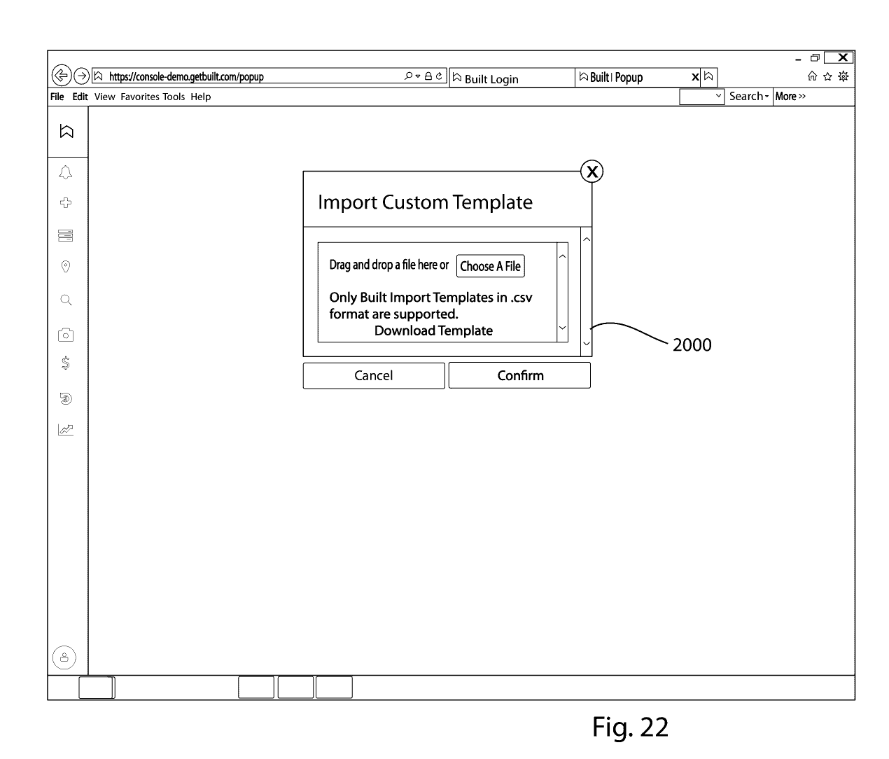

FIG. 22 is an administrator interface illustrating an import custom template screen, for importing inspection templates, in accordance with one embodiment of the present invention;

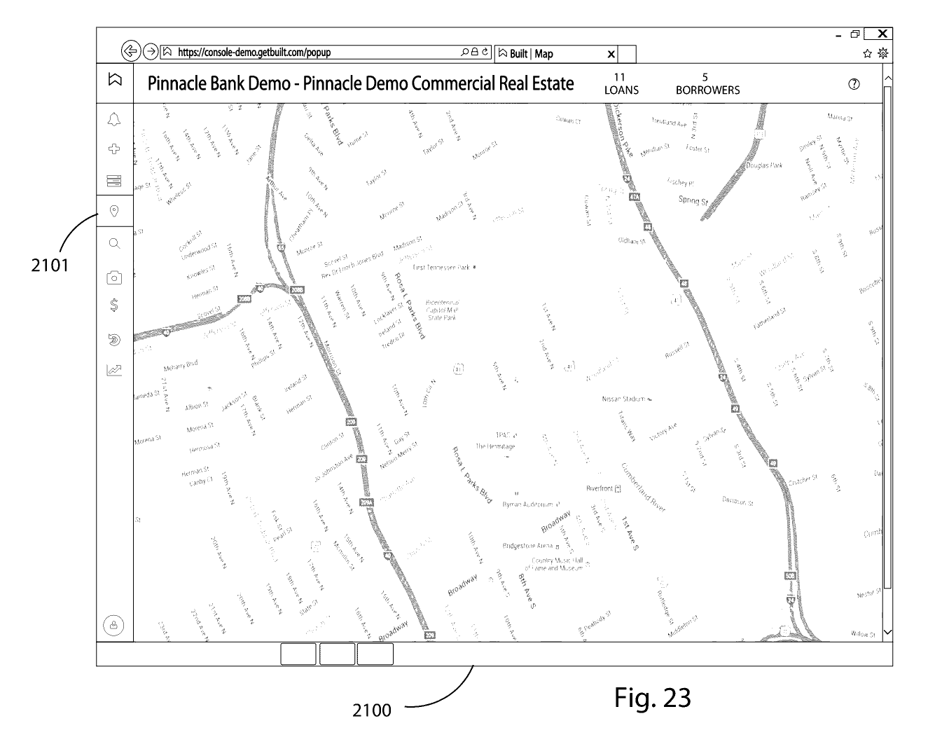

FIG. 23 is an administrator interface illustrating a map screen, showing an exemplary mapping of construction loan property locations, in accordance with one embodiment of the present invention;

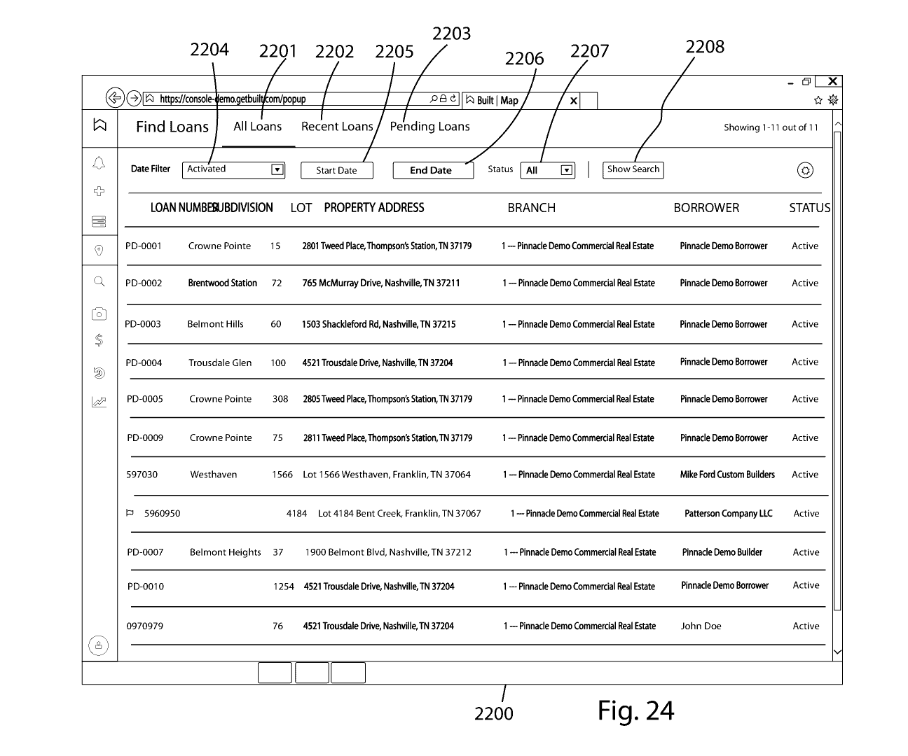

FIG. 24 is an administrator interface illustrating a find loan screen, showing an exemplary list of construction loans to search using various search filters, in accordance with one embodiment of the present invention;

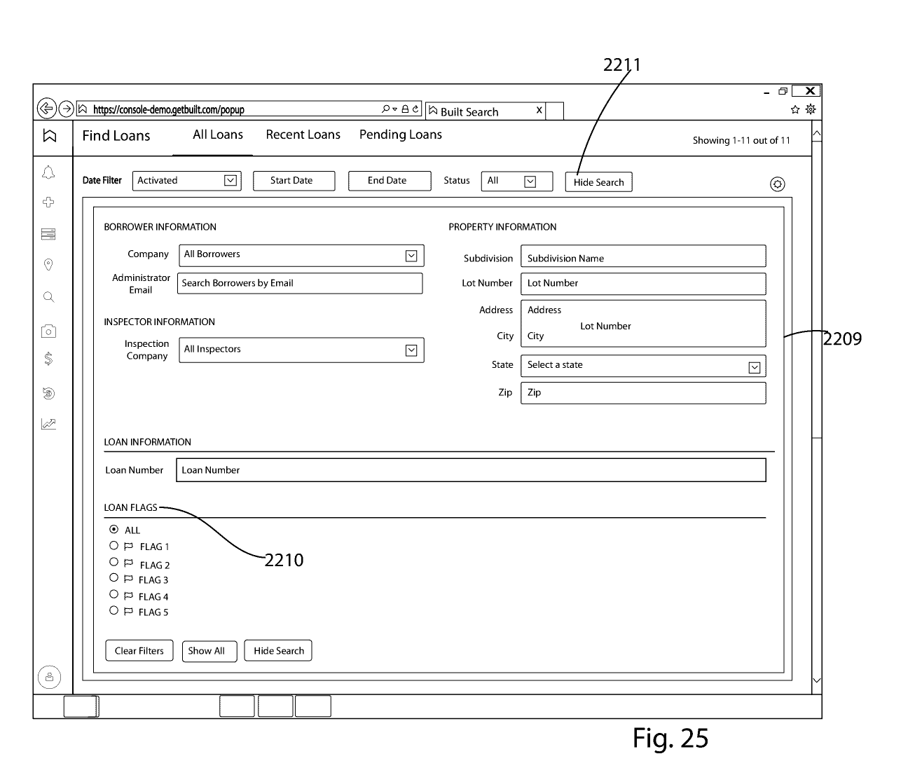

FIG. 25 is an administrator interface illustrating a find loan template screen, for selectively searching loans from the list of construction loans of FIG. 24 according to borrower, property, or loan information, in accordance with one embodiment of the present invention;

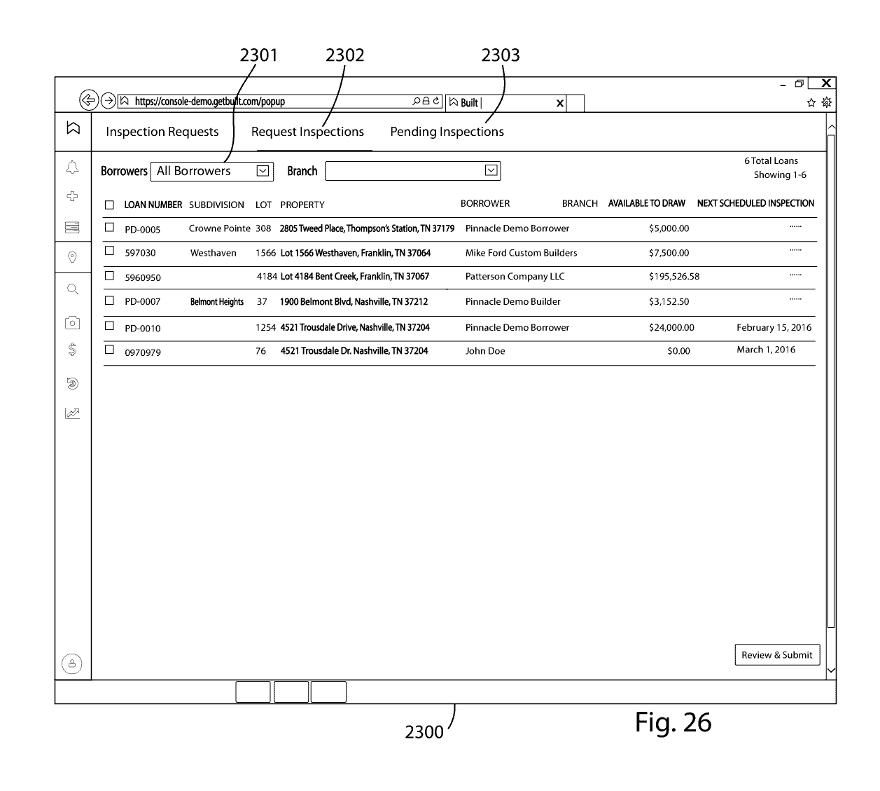

FIG. 26 is an administrator interface illustrating an inspection requests screen, showing an exemplary list of construction loans available for inspection requests, in accordance with one embodiment of the present invention;

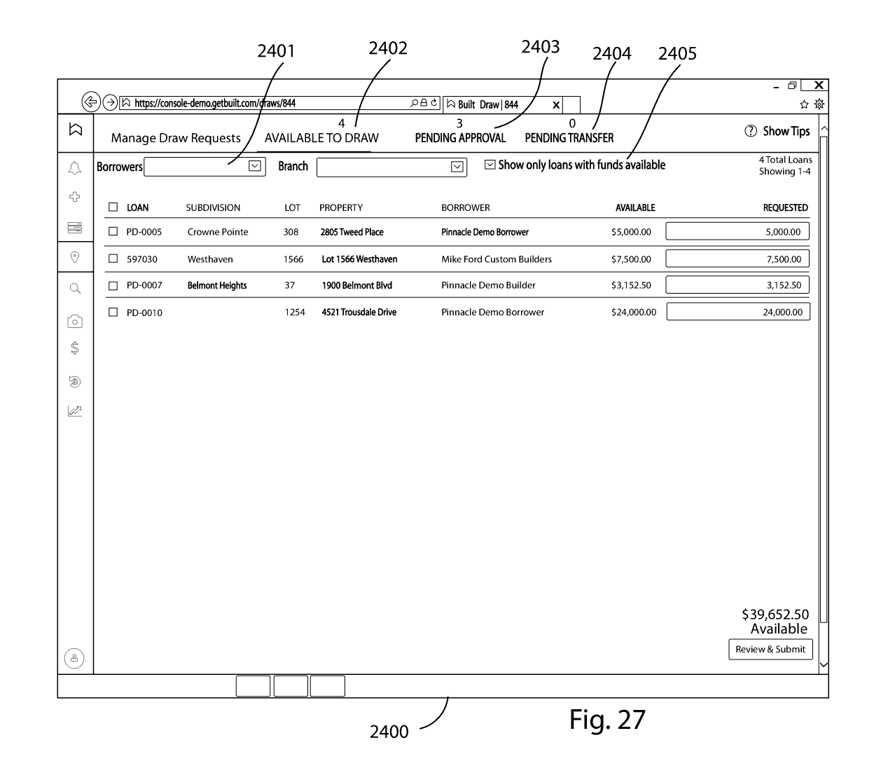

FIG. 27 is an administrator interface illustrating a manage draw requests screen, showing an exemplary list of construction loans available for draw requests, in accordance with one embodiment of the present invention;

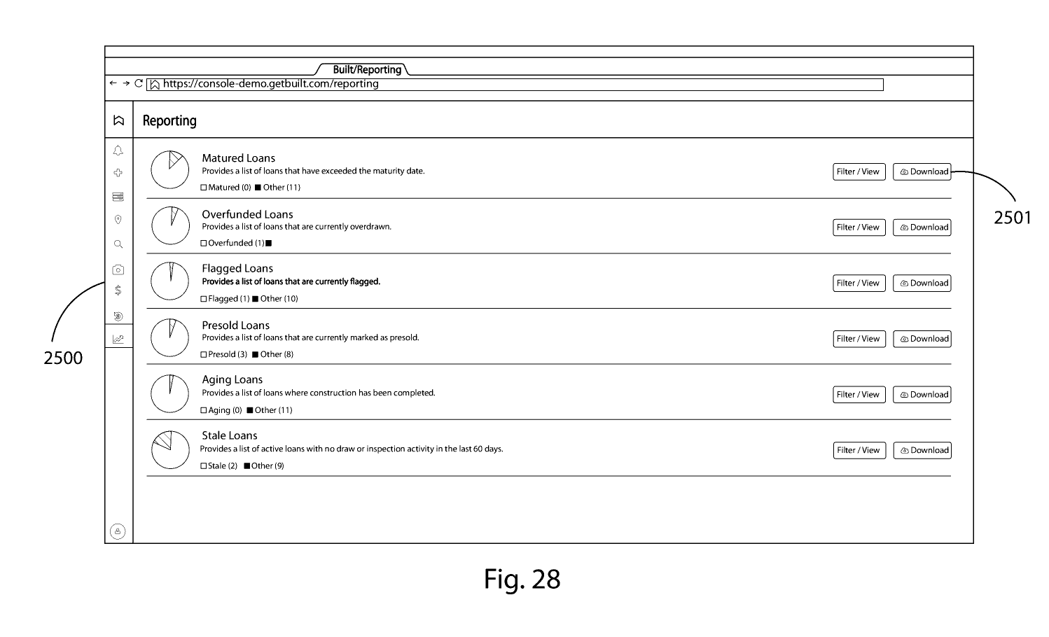

FIG. 28 is an administrator interface illustrating a construction loan reporting screen, showing status categories of construction loans, in accordance with one embodiment of the present invention;

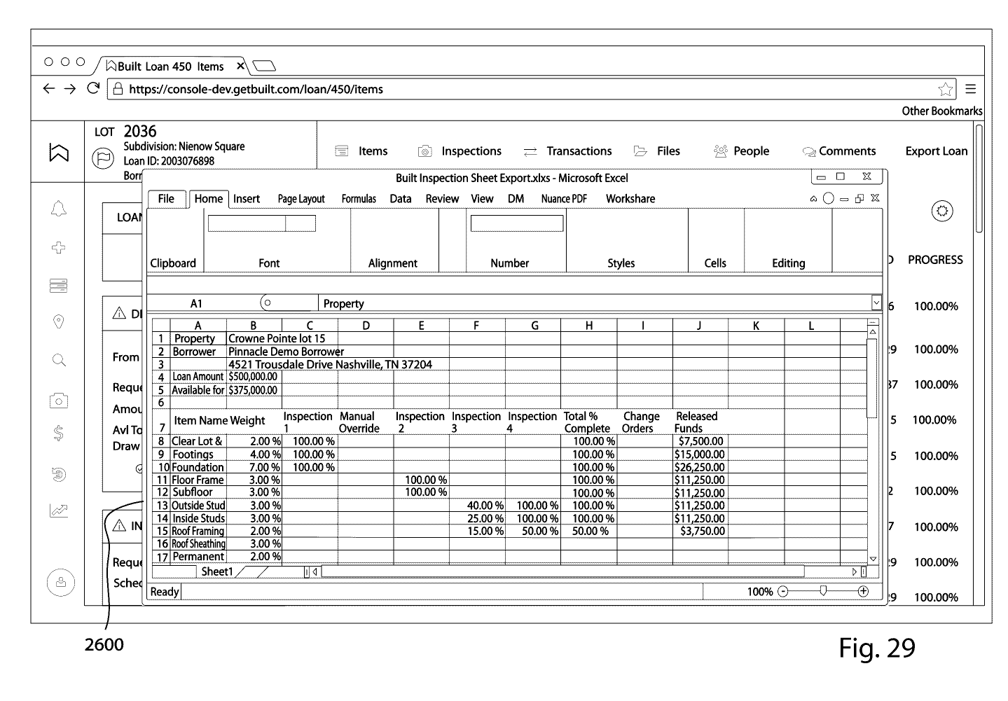

FIG. 29 is an administrator interface illustrating a spreadsheet report screen, selectively downloaded from one status category of FIG. 28, in accordance with one embodiment of the present invention;

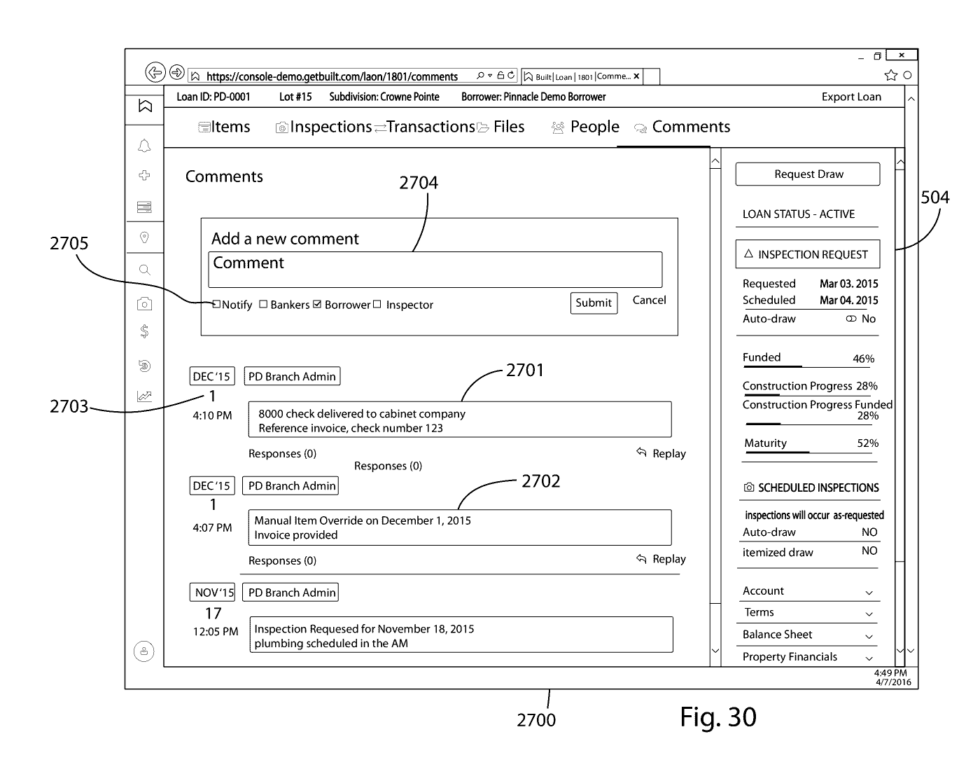

FIG. 30 is an administrator interface illustrating a comment screen, for creating and viewing loan-related messages, and the loan activity menu, in accordance with one embodiment of the present invention;

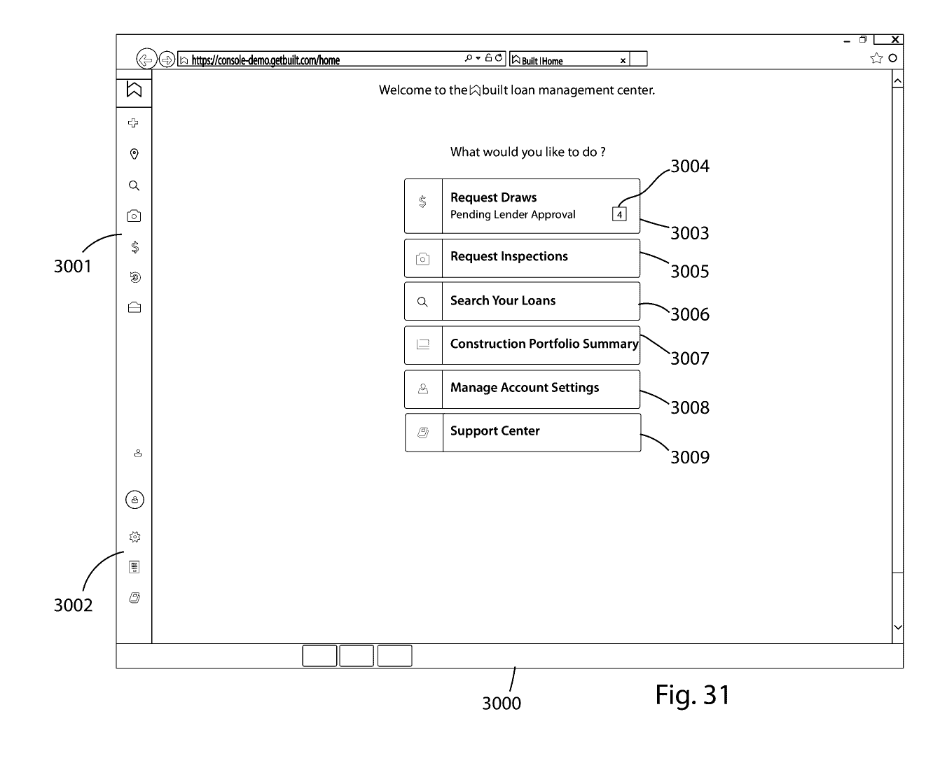

FIG. 31 is a borrower interface illustrating a borrower task screen, showing a plurality of task-based tabs, a borrower task bar, and a collapsible borrower account bar, for managing loan portfolios, in accordance with one embodiment of the present invention;

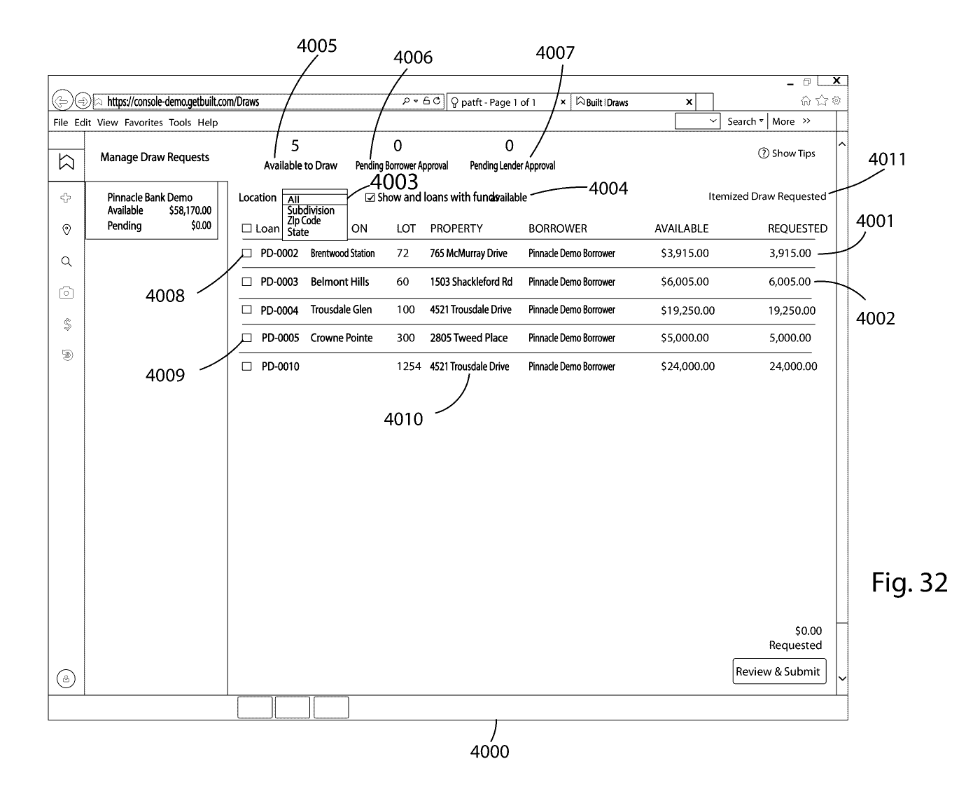

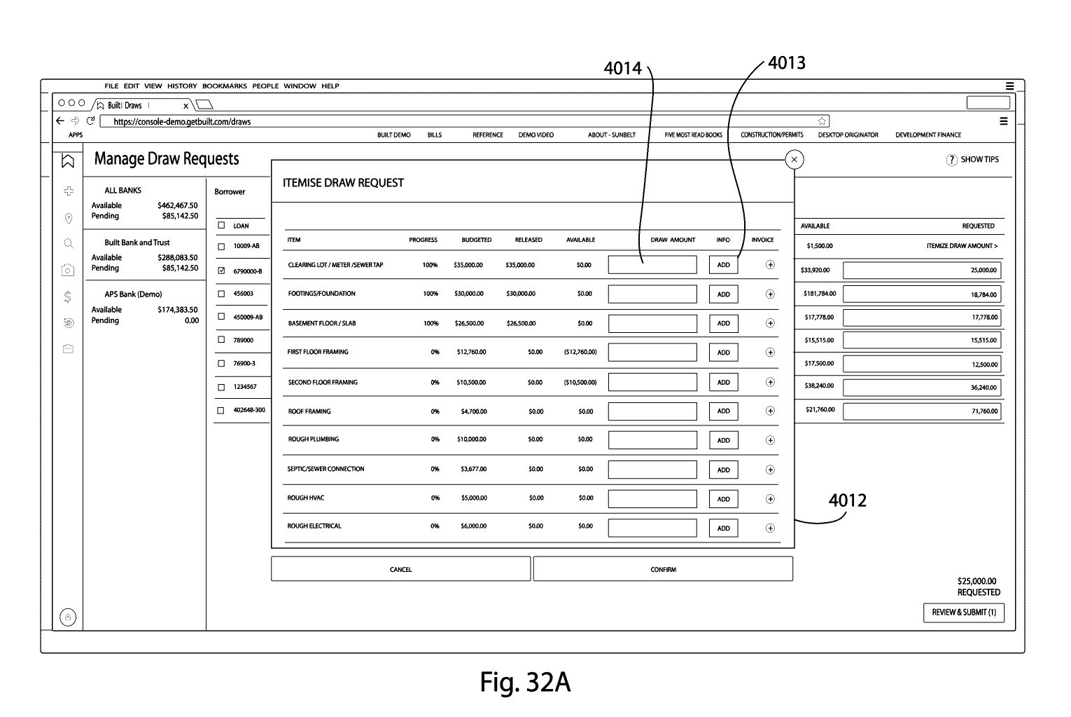

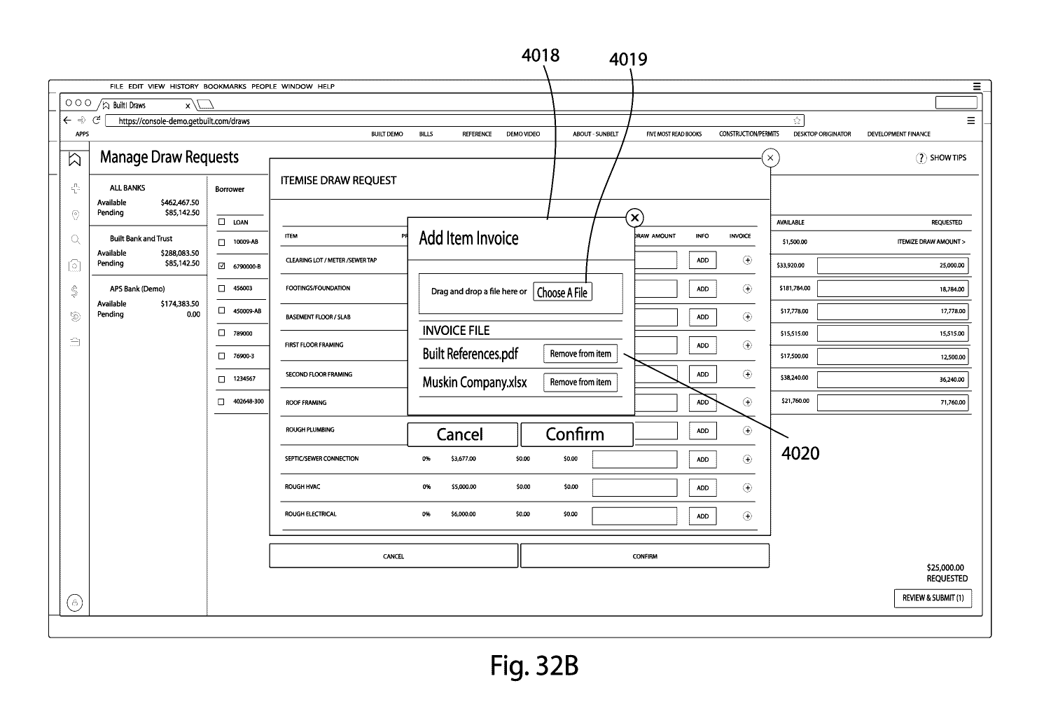

FIG. 32 is a borrower interface illustrating a manage draw requests screen, showing an exemplary list of construction loans available for selectable draw requests, in accordance with one embodiment of the present invention;

FIG. 32A is a borrower interface illustrating an itemized draw requests screen, showing an exemplary list of construction items available for selectable itemized draw requests, in accordance with one embodiment of the present invention;

FIG. 32B is a borrower interface illustrating an add items invoice screen, for adding or removing invoices of construction items, in accordance with one embodiment of the present invention;

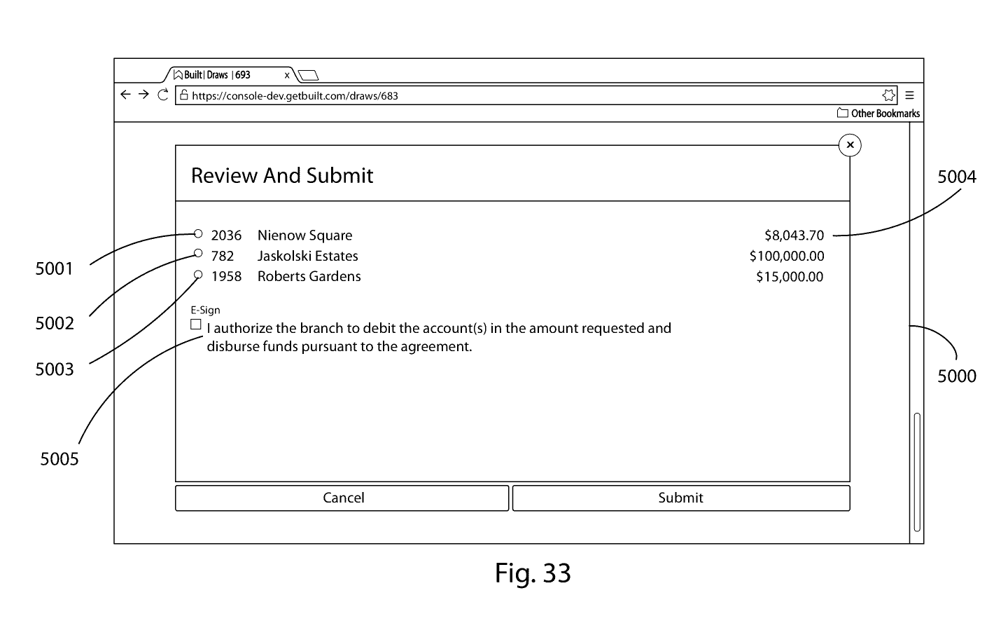

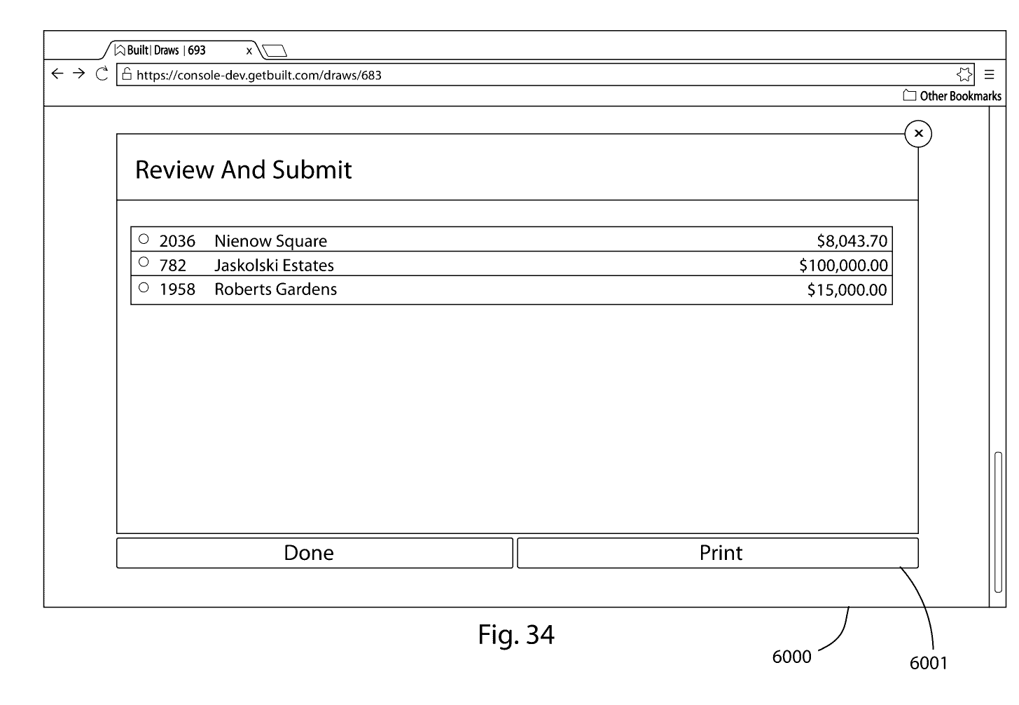

FIGS. 33 and 34 are borrower interfaces each illustrating a review and submit screen, for reviewing, authorizing, and printing, loan-related draw requests, in accordance with one embodiment of the present invention;

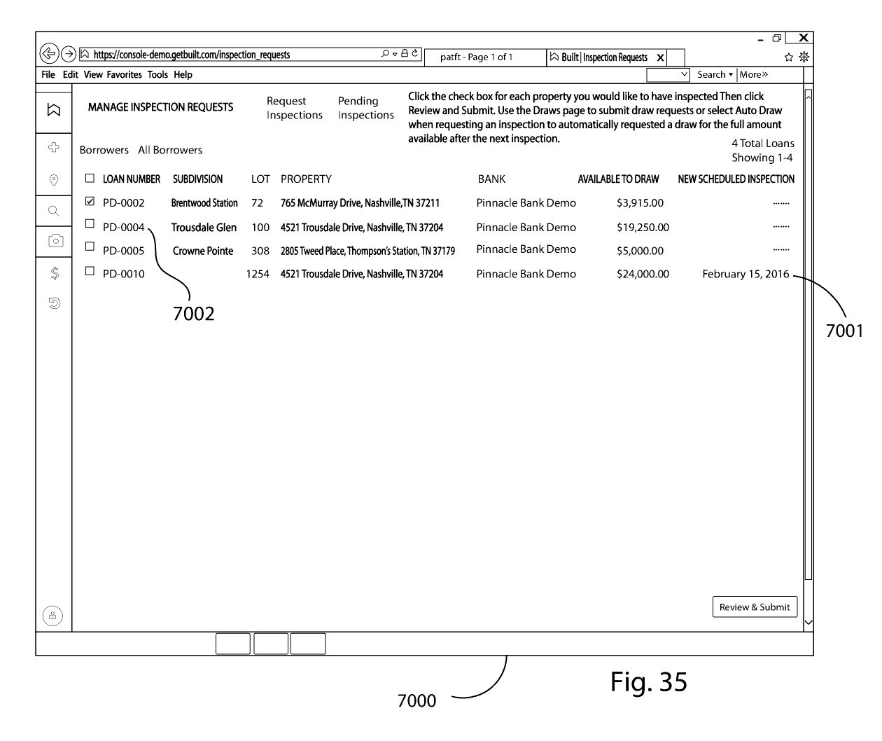

FIG. 35 is a borrower interface illustrating a manage inspection requests screen, showing an exemplary list of construction loans available for selectable inspection requests, in accordance with one embodiment of the present invention;

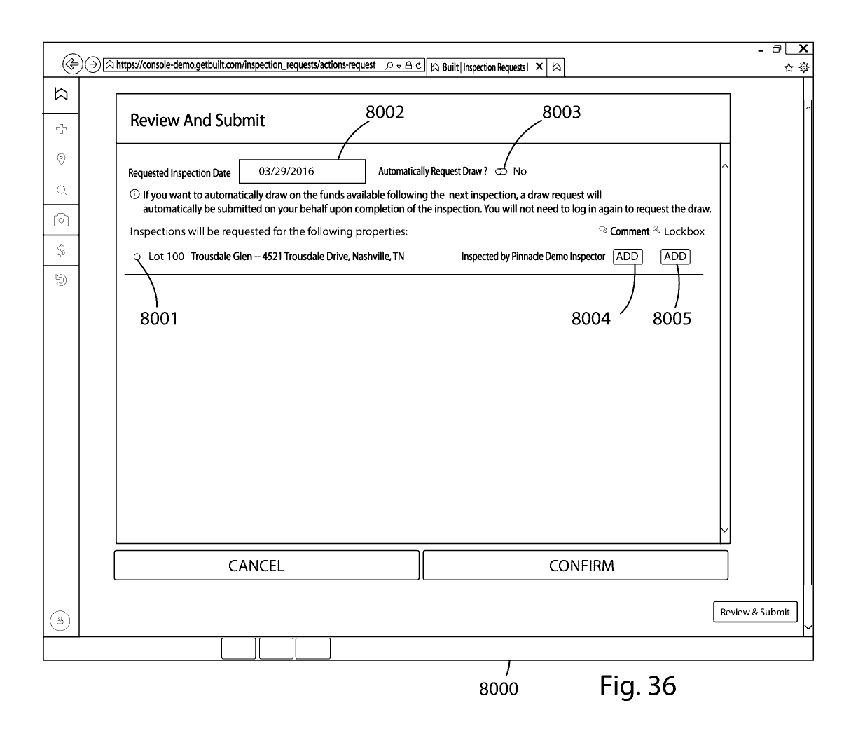

FIG. 36 is a borrower interface illustrating a review and submit screen, for reviewing, scheduling, and submitting, loan-related inspection requests, in accordance with one embodiment of the present invention;

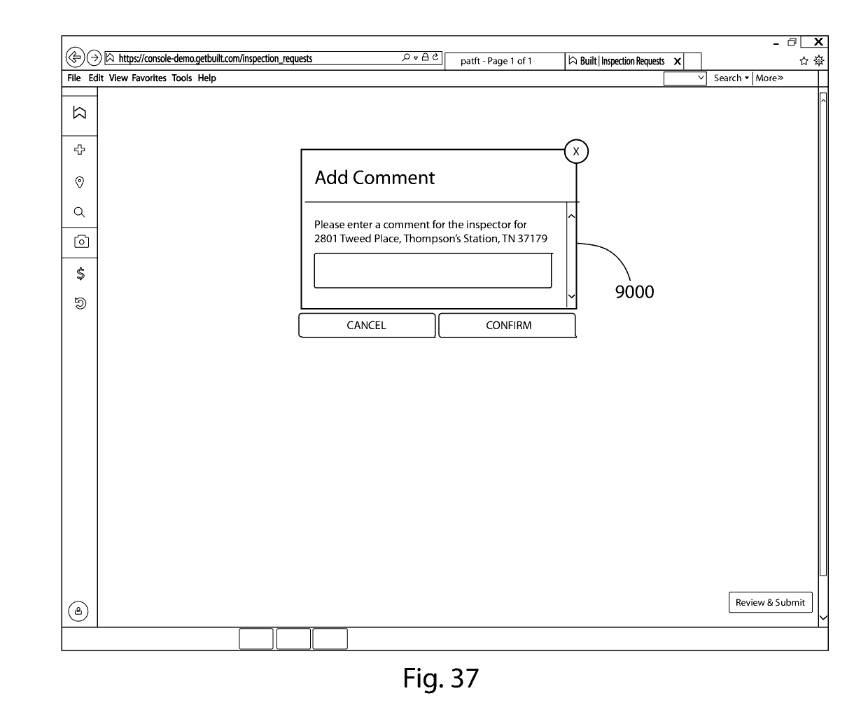

FIG. 37 is a borrower interface illustrating an add comment screen, selectable from the review and submit screen of FIG. 36, for creating and sending messages to inspectors, in accordance with one embodiment of the present invention;

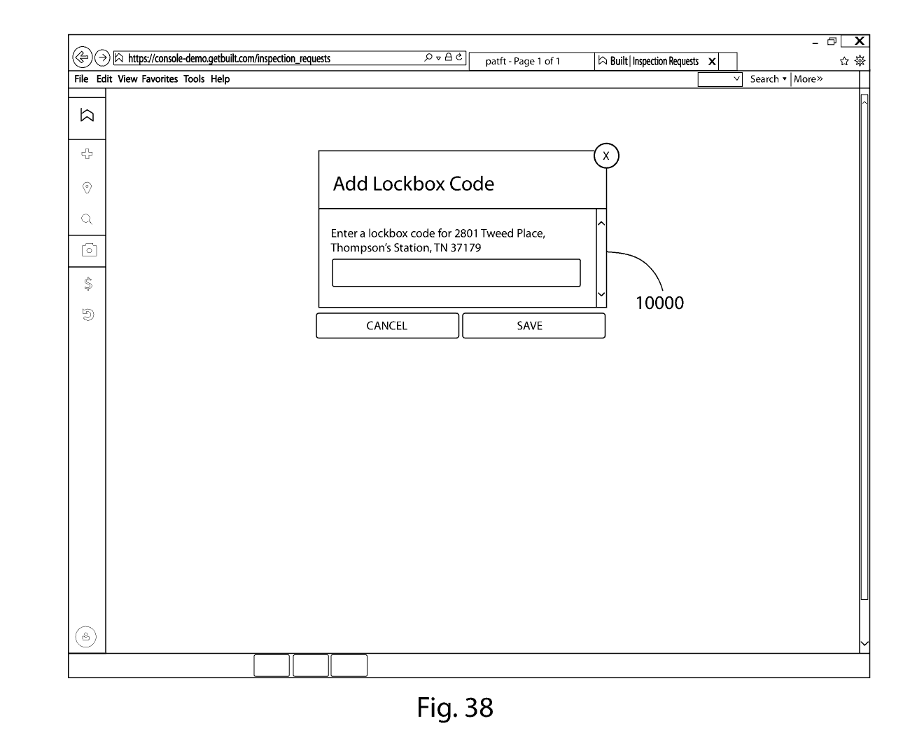

FIG. 38 is a borrower interface illustrating an add lockbox code screen, selectable from the review and submit screen of FIG. 36, for entering and sending building or property access codes to inspectors, in accordance with one embodiment of the present invention;

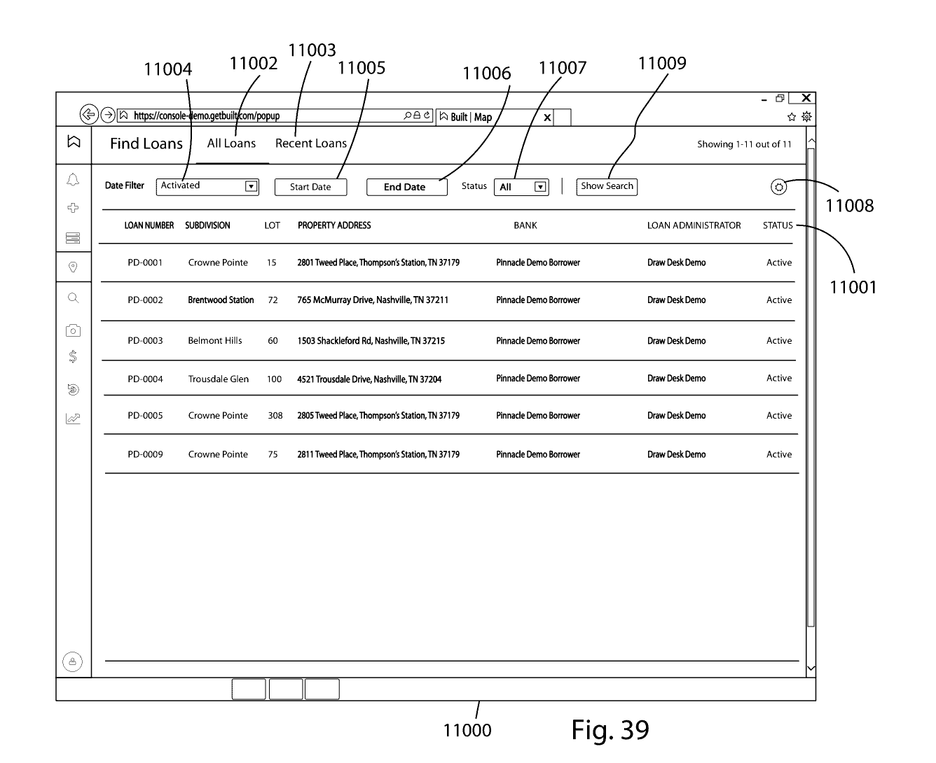

FIG. 39 is a borrower interface illustrating a find loan screen, showing an exemplary list of construction loans to search, in accordance with one embodiment of the present invention;

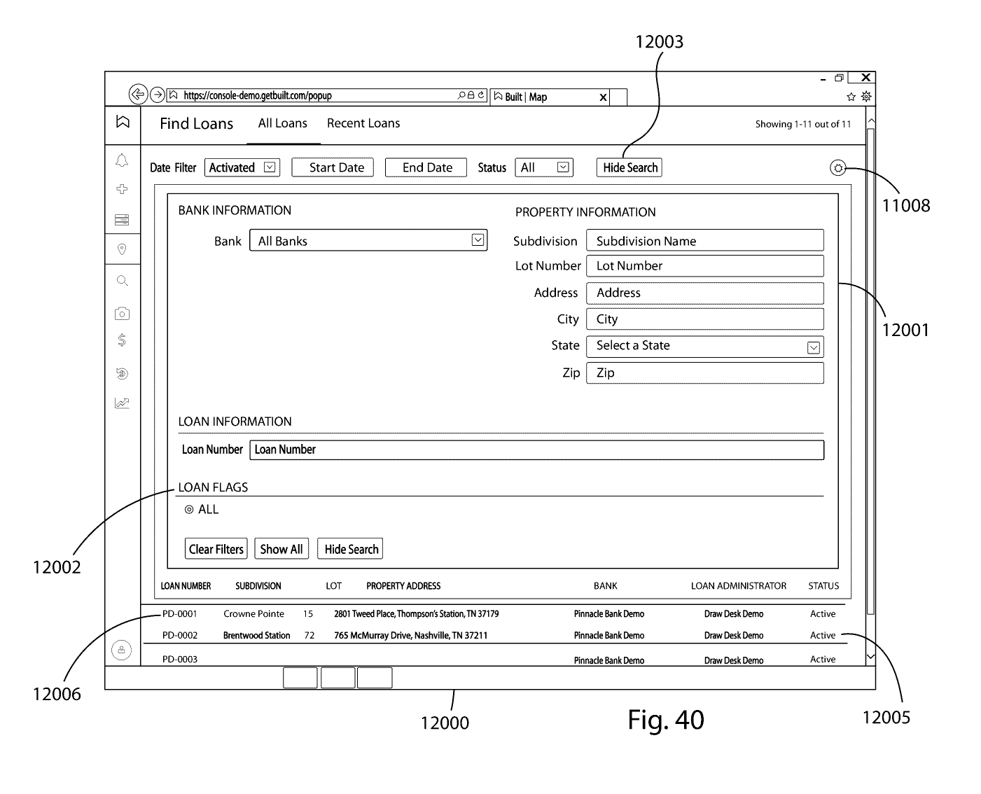

FIG. 40 is a borrower interface illustrating a loan search template screen, for searching loans from the list of construction loans of FIG. 39 using various search filters, in accordance with one embodiment of the present invention;

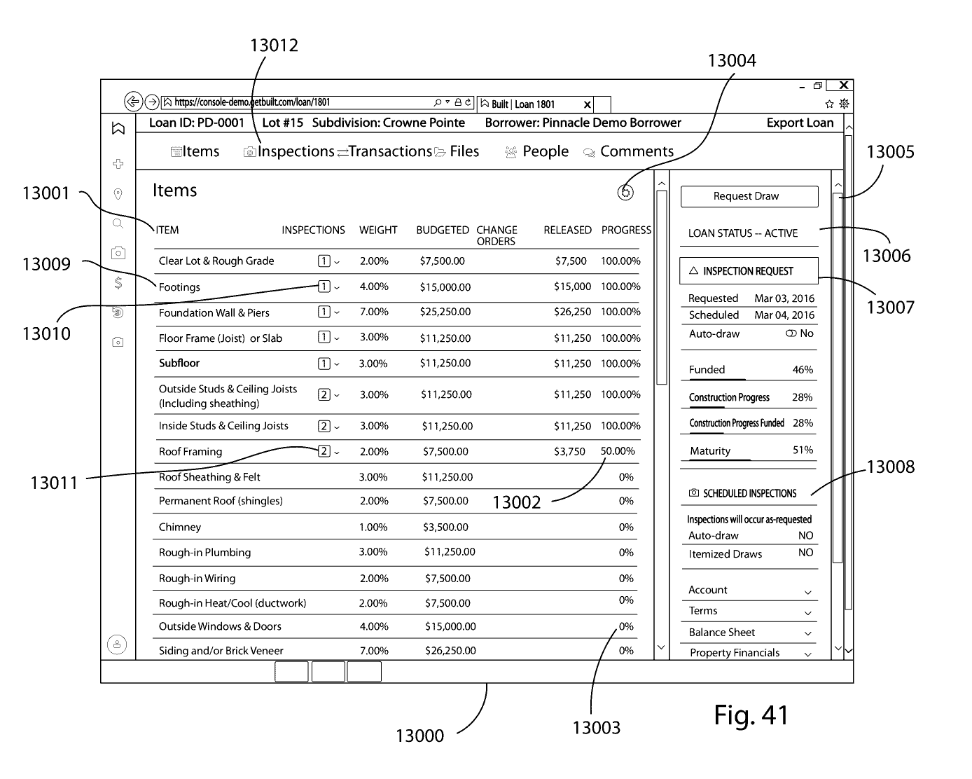

FIG. 41 is a borrower interface illustrating a construction items screen, showing an exemplary list of construction items regarding a loan, a loan activity menu, and a dashboard, in accordance with one embodiment of the present invention;

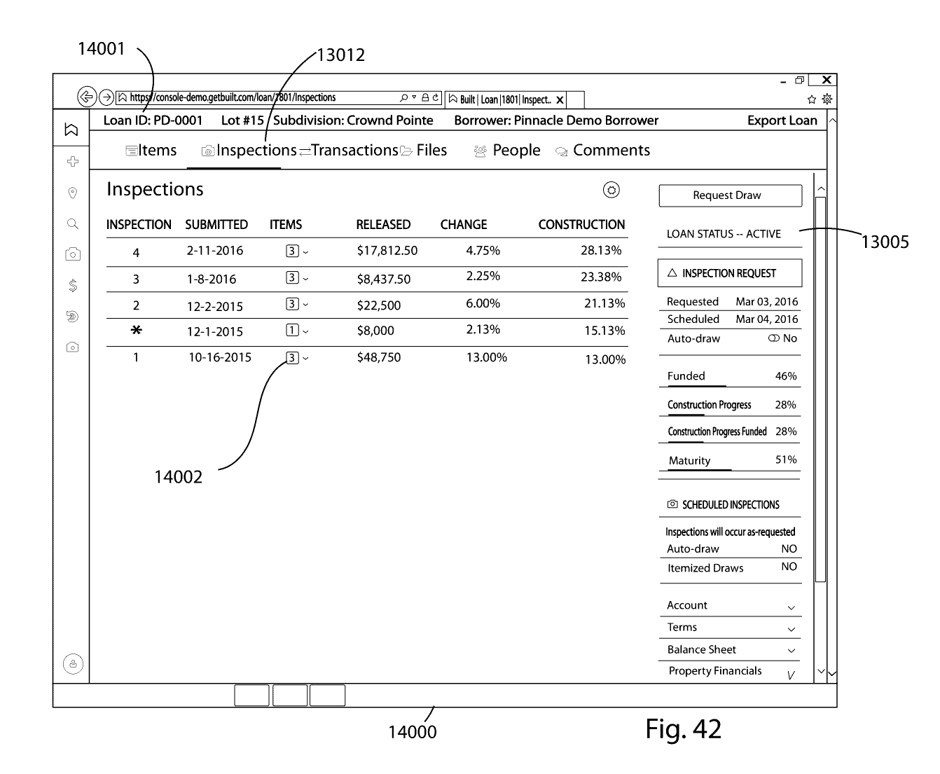

FIG. 42 is a borrower interface illustrating an inspections items screen, showing an exemplary list of inspections regarding a loan, and the loan activity menu, in accordance with one embodiment of the present invention;

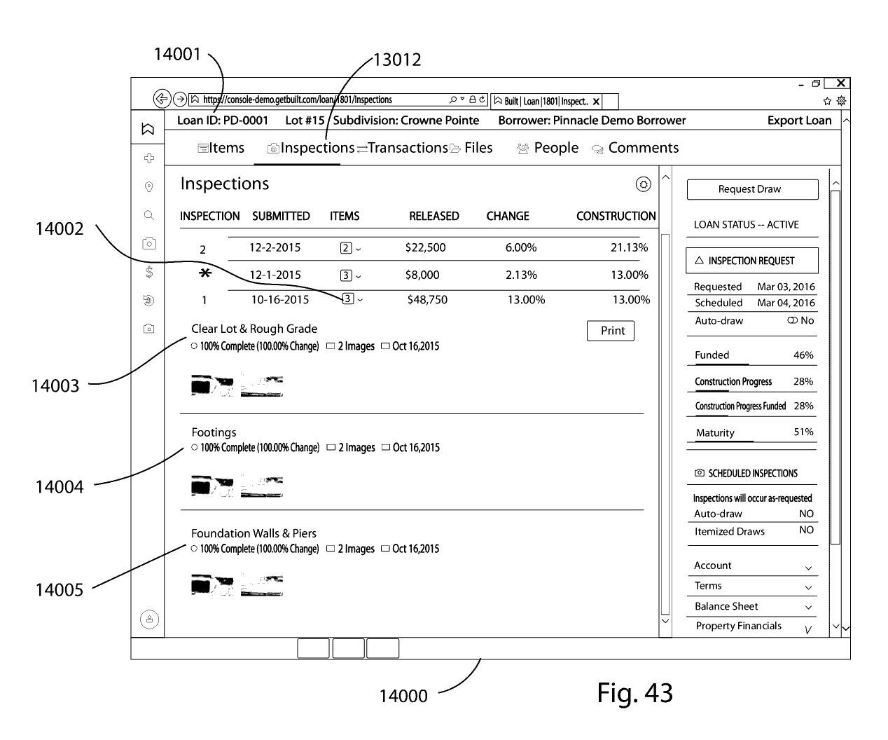

FIG. 43 is a borrower interface illustrating the inspections items screen of FIG. 42, showing exemplary thumbnail images of construction items, in accordance with one embodiment of the present invention;

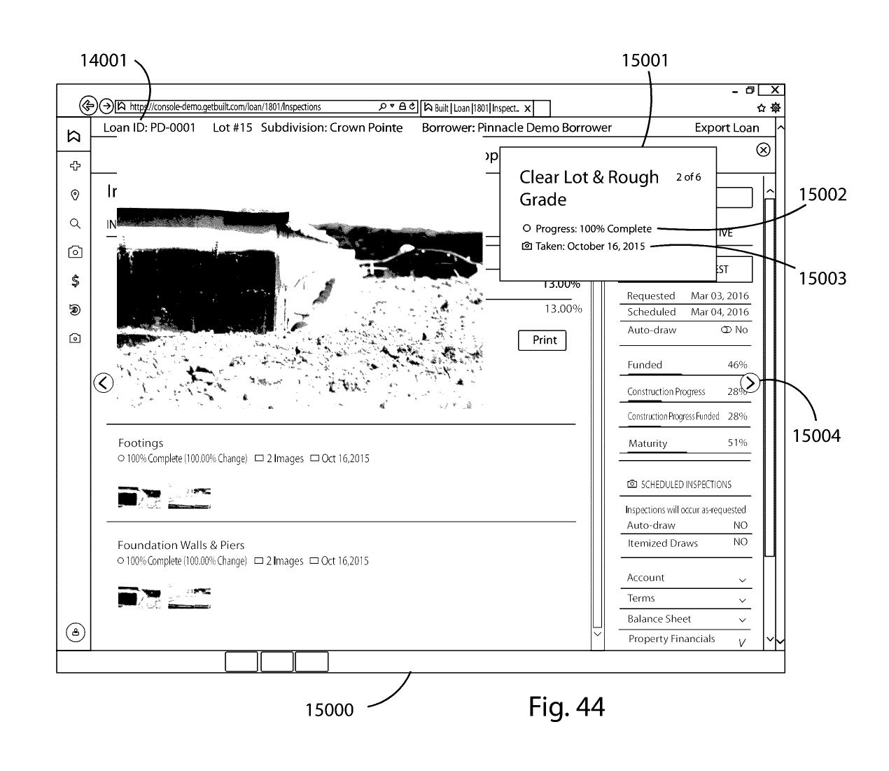

FIG. 44 is a borrower interface illustrating an exemplary thumbnail image of FIG. 43, shown enlarged, in accordance with one embodiment of the present invention;

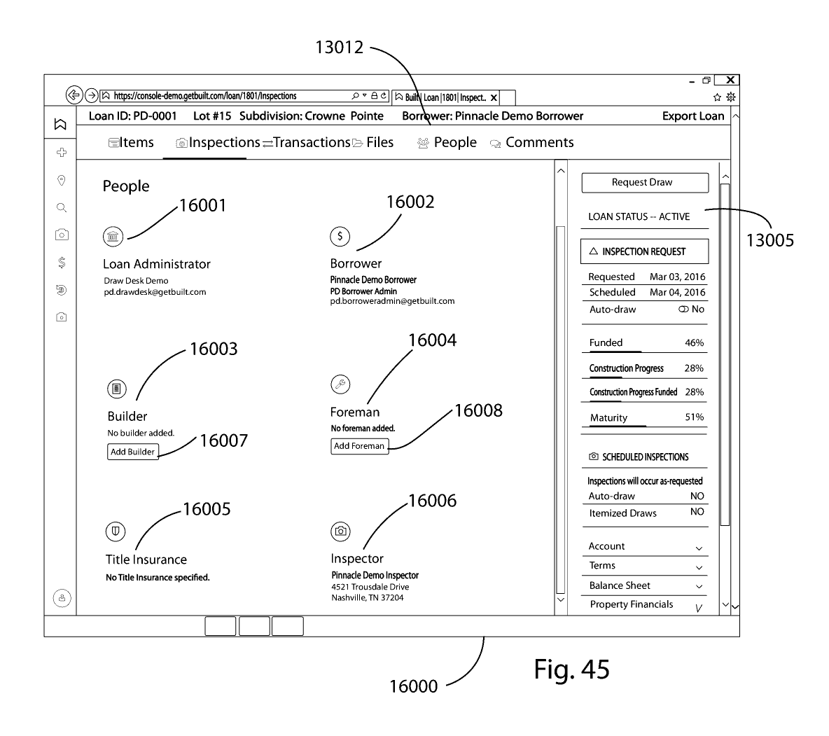

FIG. 45 is a borrower interface illustrating a people contact screen, showing individuals, groups, or companies affiliated with a borrower construction loan portfolio, and the loan activity menu, in accordance with one embodiment of the present invention;

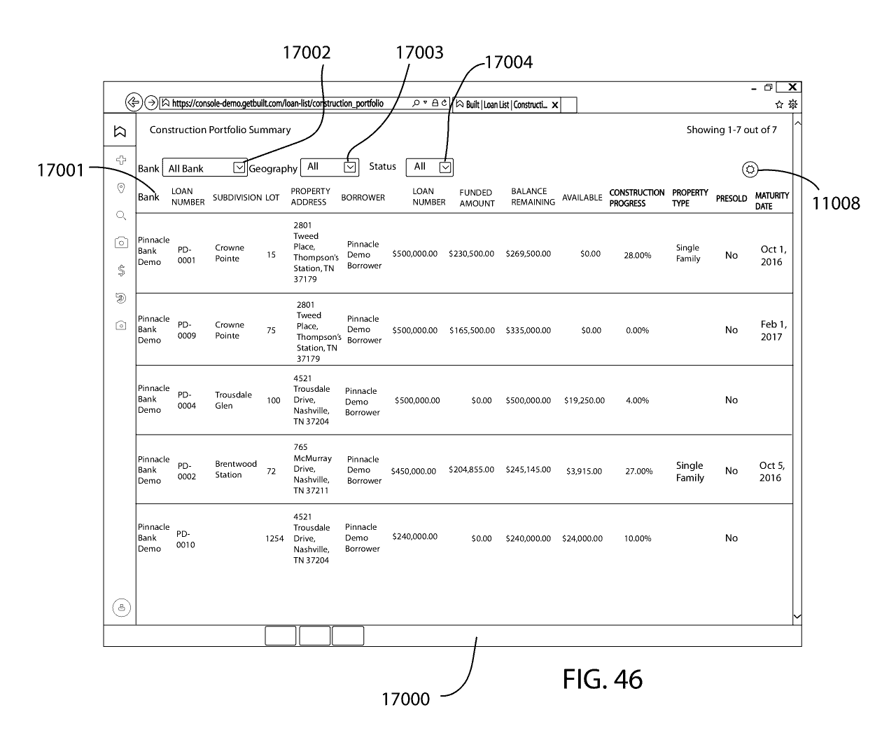

FIG. 46 is a borrower interface illustrating a loan portfolio summary screen, showing an exemplary list of construction loans and related information of a borrower's loan portfolio, in accordance with one embodiment of the present invention;

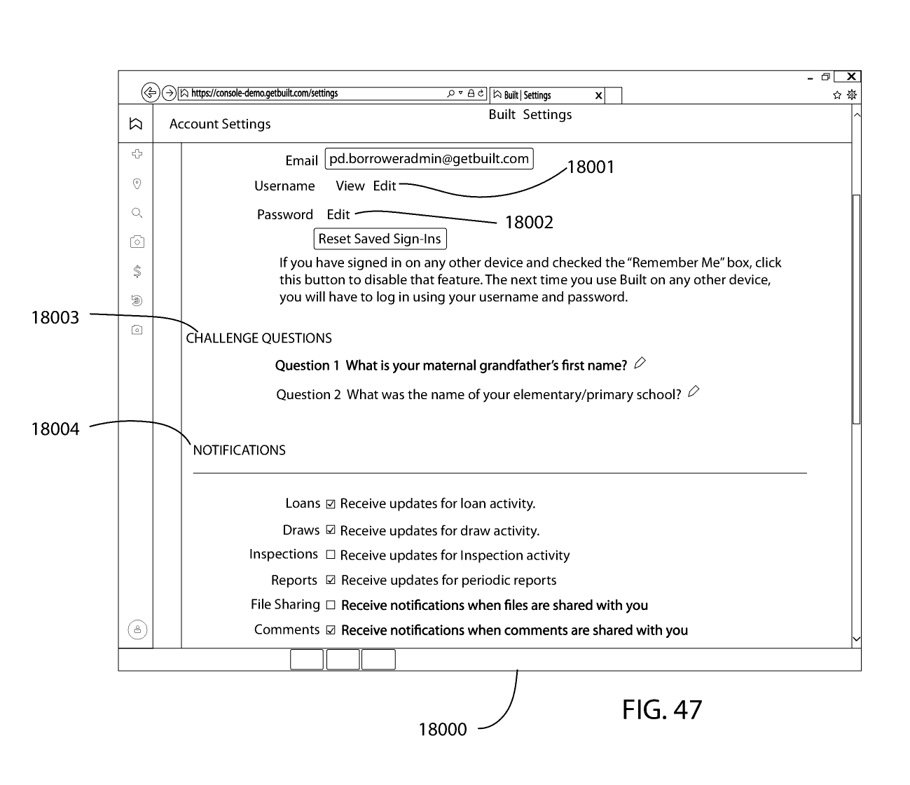

FIG. 47 is a borrower interface illustrating an account settings screen, selected from the collapsible borrower account bar of FIG. 31, for managing borrower account settings, in accordance with one embodiment of the present invention;

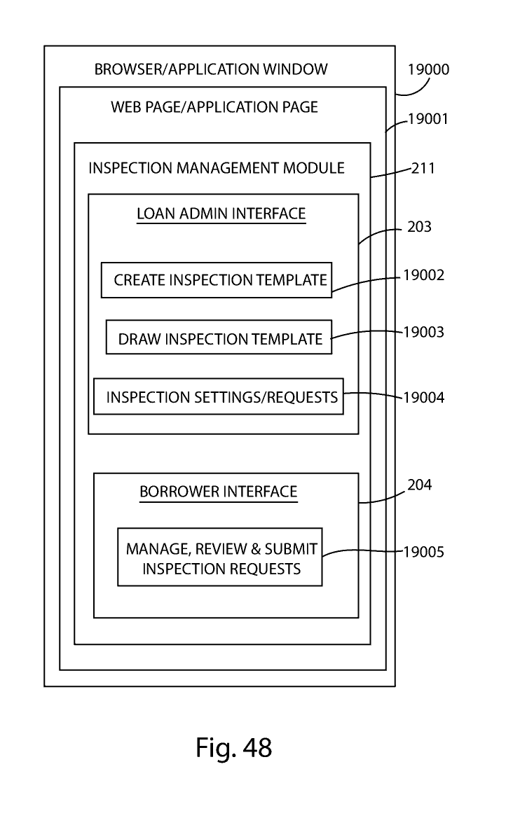

FIG. 48 is a block diagram illustrating one embodiment of the administrator and borrower interfaces functionally operating in conjunction with an inspection management module for creating and managing construction items templates, inspection settings and requests, and scheduling inspections, in accordance with one embodiment of the present invention;

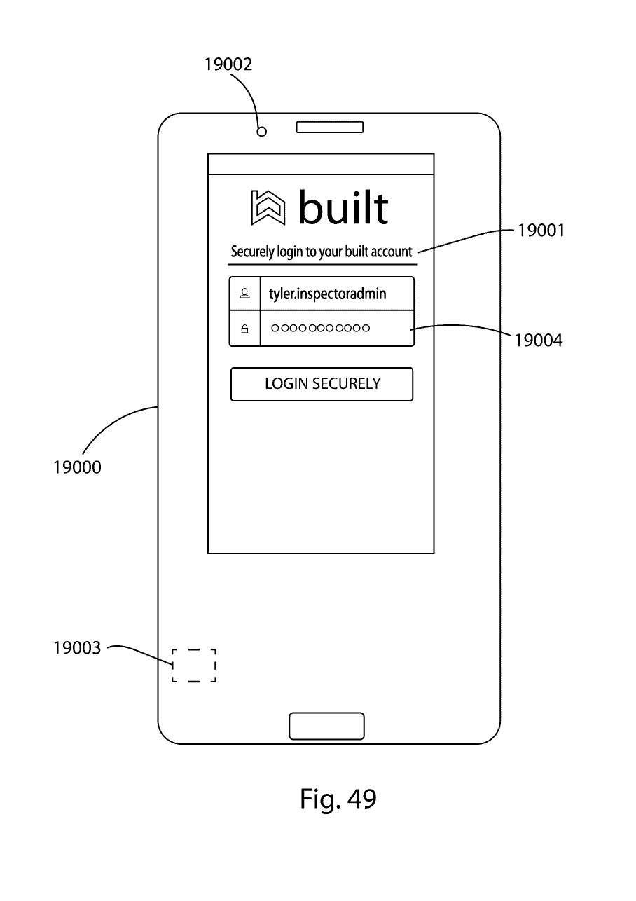

FIG. 49 is an inspector interface illustrating a field inspection app loaded on, or accessed from, a client device, such as a smartphone, showing a user-login display screen, in accordance with one embodiment of the present invention;

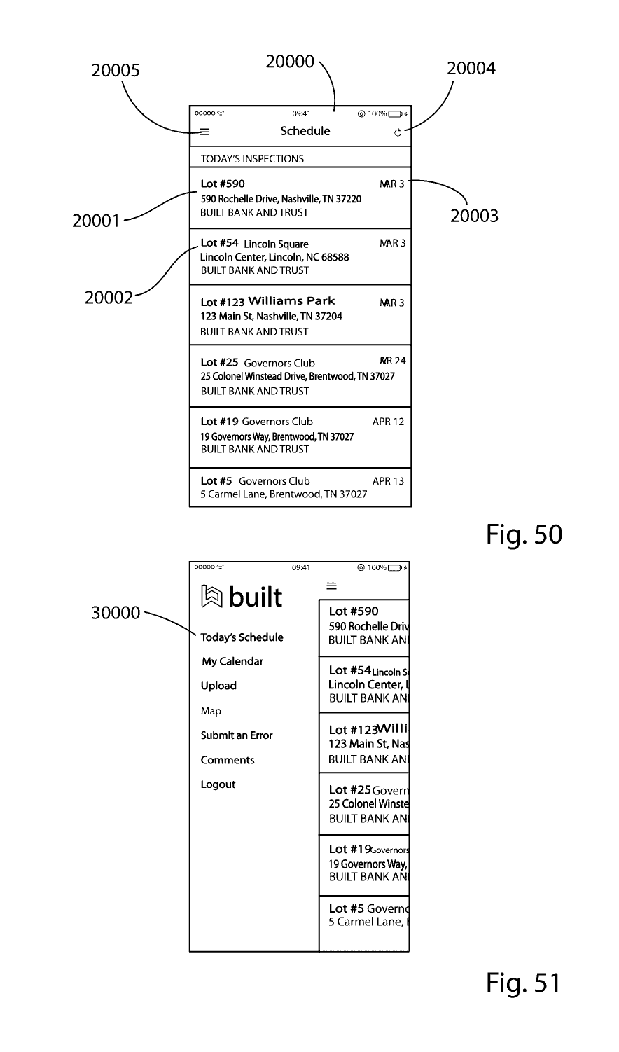

FIG. 50 is an inspector interface illustrating an inspection schedule screen, showing an exemplary list of scheduled inspections represented by property lot number, in accordance with one embodiment of the present invention;

FIG. 51 is an inspector interface illustrating an inspector task menu screen, showing various tasks for selectively managing various aspects of scheduled inspections, in accordance with one embodiment of the present invention;

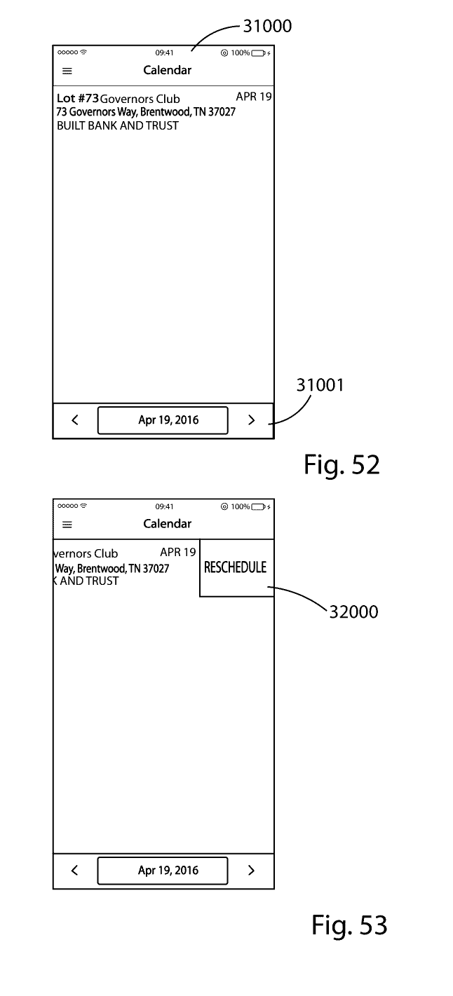

FIG. 52 is an inspector interface illustrating an inspection calendar screen, showing an exemplary inspection assigned on a scheduled date, in accordance with one embodiment of the present invention;

FIG. 53 is an inspector interface illustrating the inspection calendar screen of FIG. 52, showing a rescheduling tab for rescheduling previously scheduled inspections, in accordance with one embodiment of the present invention;

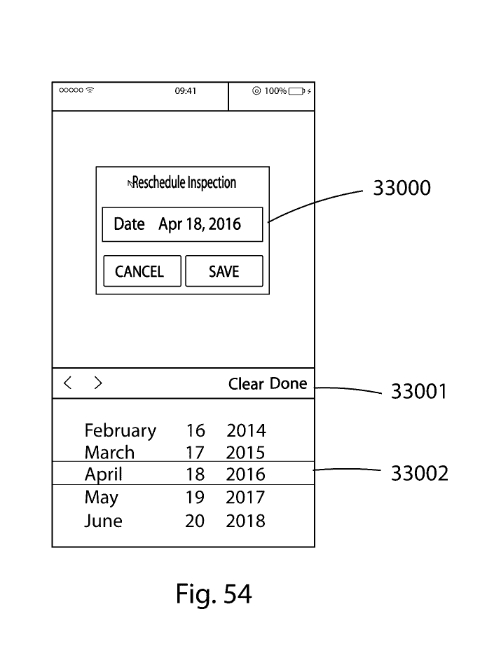

FIG. 54 is an inspector interface illustrating a rescheduling inspection screen, showing a date selector for assisting inspectors in submitting rescheduled dates, in accordance with one embodiment of the present invention;

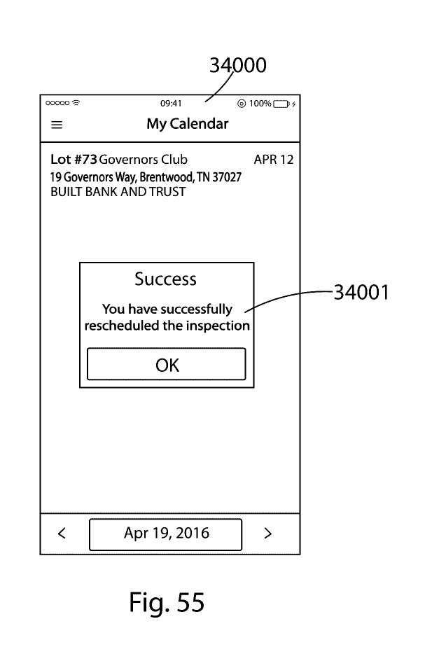

FIG. 55 is an inspector interface illustrating a rescheduling success screen, showing confirmation of rescheduled inspection dates, in accordance with one embodiment of the present invention;

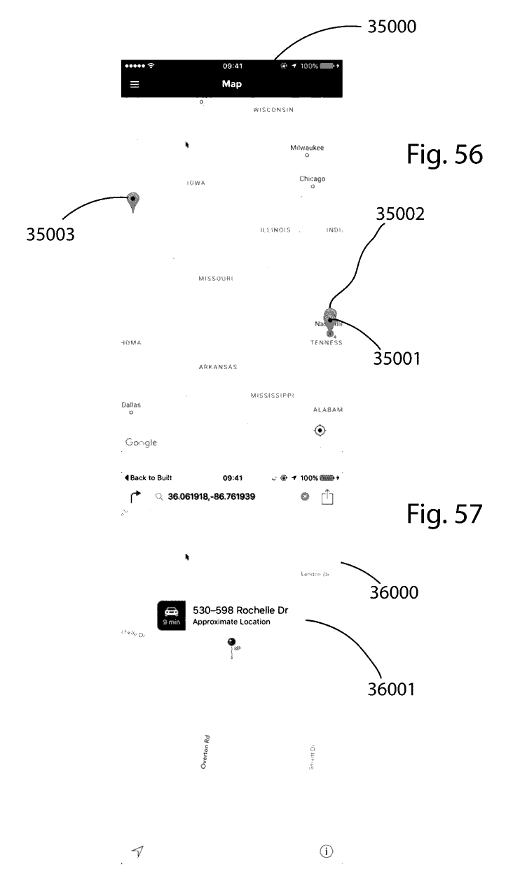

FIG. 56 is an inspector interface illustrating a geographical map screen, showing mapped locations of inspection properties based on latitude/longitude coordinates, in accordance with one embodiment of the present invention;

FIG. 57 is an inspector interface illustrating a geographical map screen, showing mapped locations of inspection properties based on location approximation information, in accordance with one embodiment of the present invention;

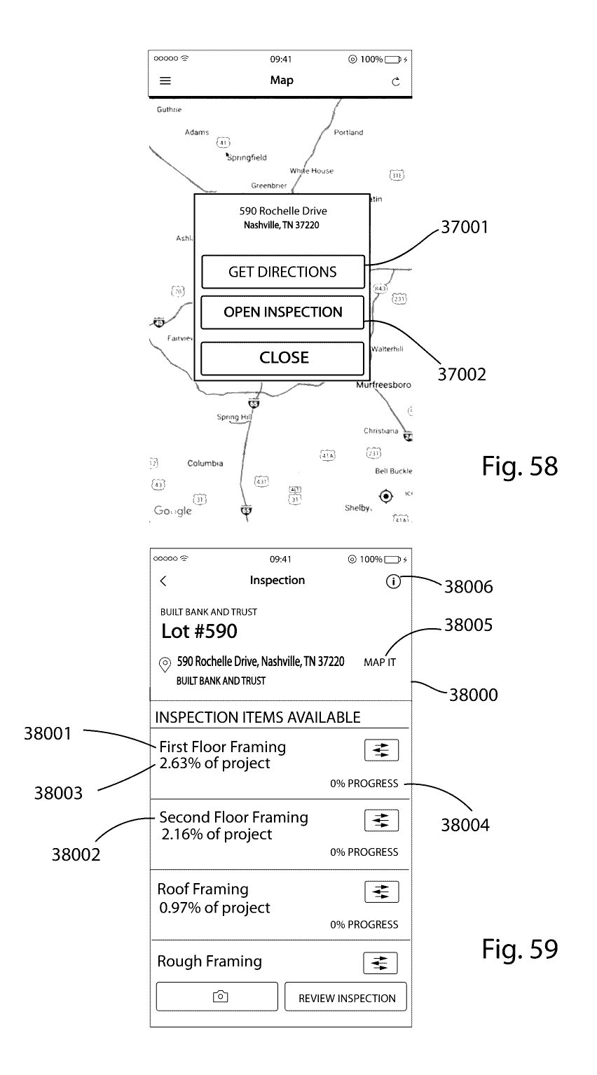

FIG. 58 is an inspector interface illustrating a property locator screen, accessible from any one of the mapped inspection properties of FIGS. 56 and 57 respectively, including a driving directions tab, and open inspection tab, in accordance with one embodiment of the present invention;

FIG. 59 is an inspector interface illustrating an inspection items screen, showing construction items scheduled for inspection on a property, including assigned project indicators, assignable progress values, and function tabs, in accordance with one embodiment of the present invention;

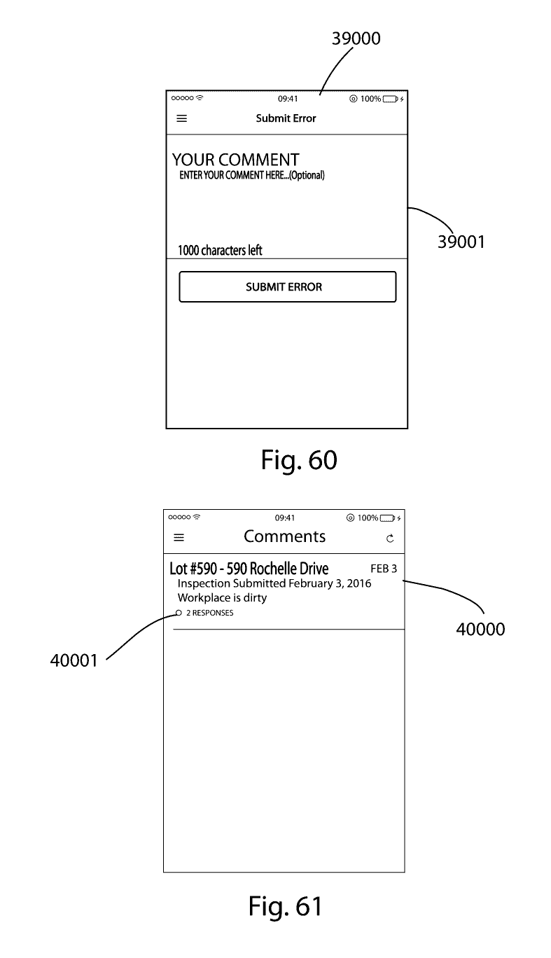

FIG. 60 is an inspector interface illustrating a submit error screen, for generating comments regarding errors found during the inspection process, in accordance with one embodiment of the present invention;

FIG. 61 is an inspector interface illustrating an inspector comment screen, for generating comments regarding inspections, showing viewable responses, in accordance with one embodiment of the present invention;

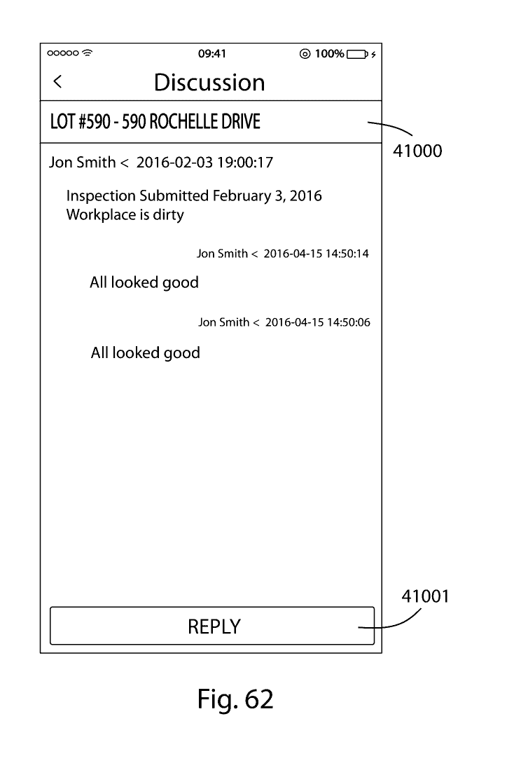

FIG. 62 is an inspector interface illustrating an inspector discussion screen, showing the viewing of responses of FIG. 61, in accordance with one embodiment of the present invention;

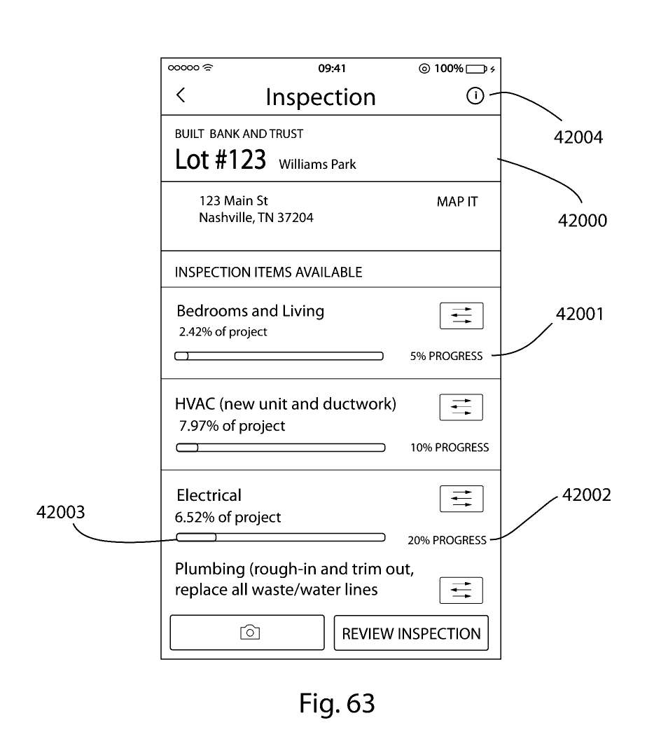

FIG. 63 is an inspector interface illustrating an inspection items screen, showing construction items, each item including a project value, and an assignable progress value with a visual progress indicator to show inspection progress, in accordance with one embodiment of the present invention;

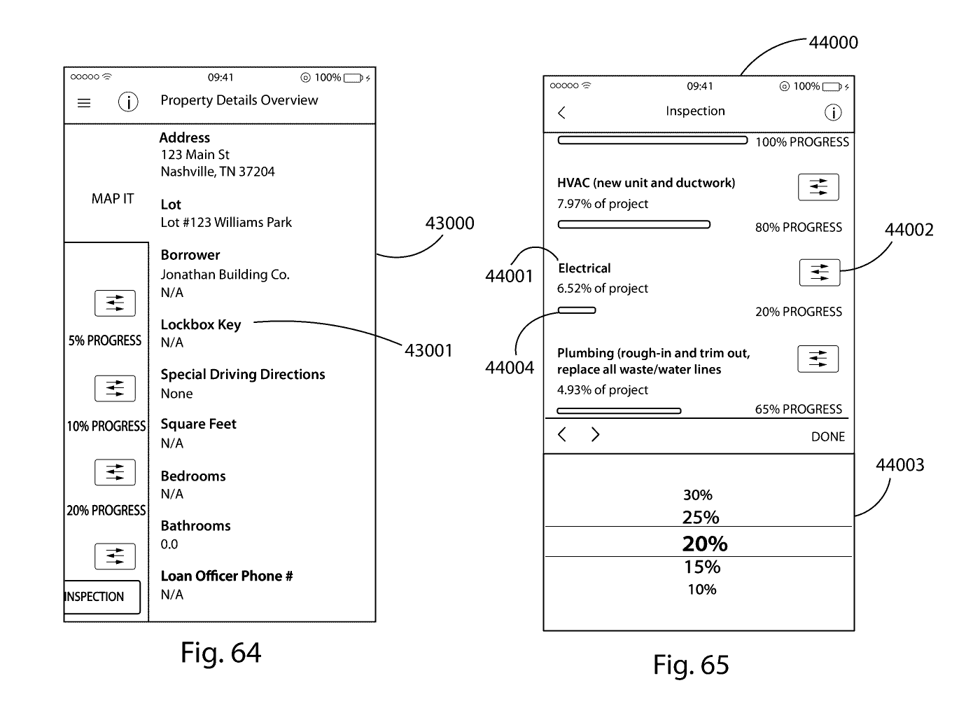

FIG. 64 is an inspector interface illustrating an property details overview screen, showing property details accessible, via selection of a function tab of FIG. 59, in accordance with one embodiment of the present invention;

FIG. 65 is an inspector interface illustrating the inspection items screen of FIG. 63, showing construction items, each including corresponding project values, construction progress values associated with visual progress indicators, progress tabs for changing progress values, and a progress value selector, in accordance with one embodiment of the present invention;

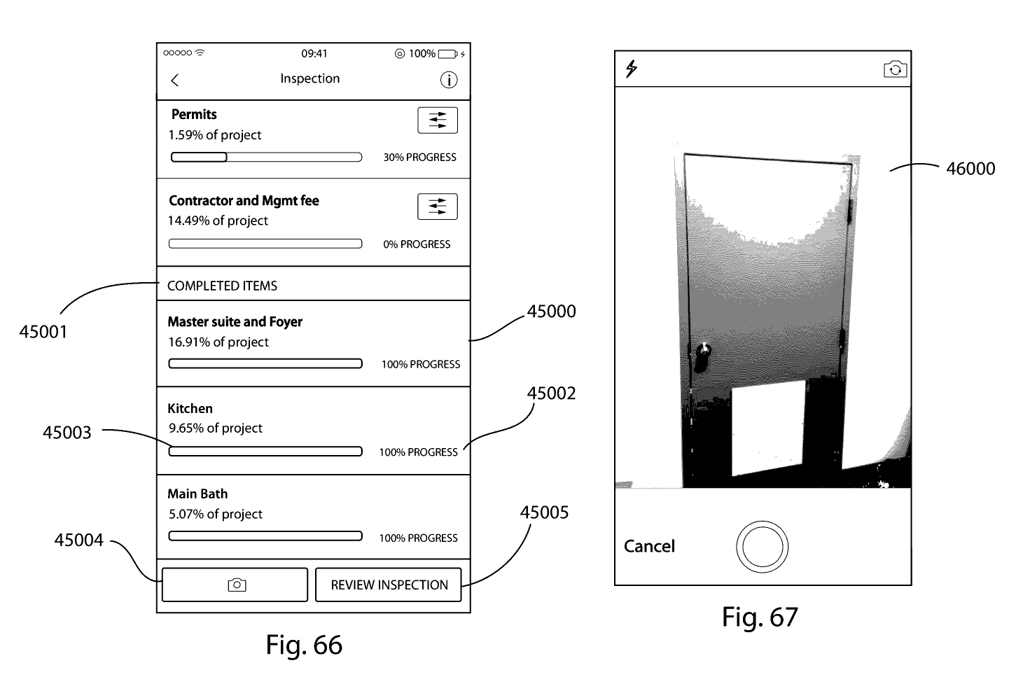

FIG. 66 is an inspector interface illustrating the inspection items screen of FIG. 63, showing a designated hierarchy of non-completed and completed construction items, a camera tab, and a review inspection tab, in accordance with one embodiment of the present invention;

FIG. 67 is an inspector interface illustrating inspector positioning of a camera for capturing an image of a construction item, shown as a door, in accordance with one embodiment of the present invention;

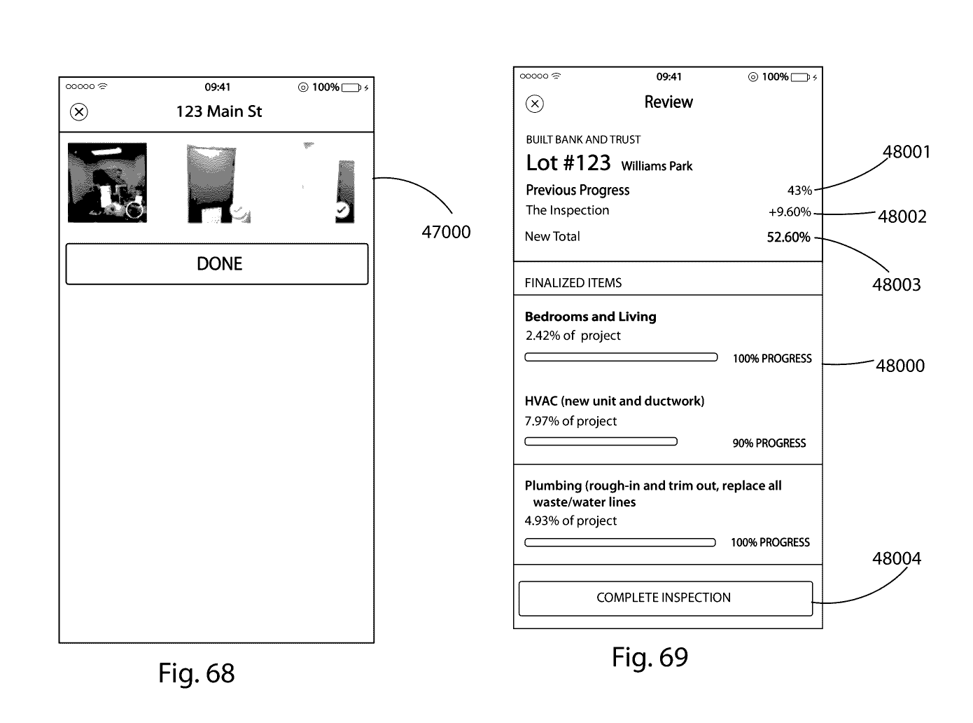

FIG. 68 is an inspector interface illustrating an items image screen, showing thumbnail images of construction items taken during an inspection, and selection of images, in accordance with one embodiment of the present invention;

FIG. 69 is an inspector interface illustrating an inspection review screen, showing progression of construction progress values attributed to inspection of items for one exemplary property, in accordance with one embodiment of the present invention;

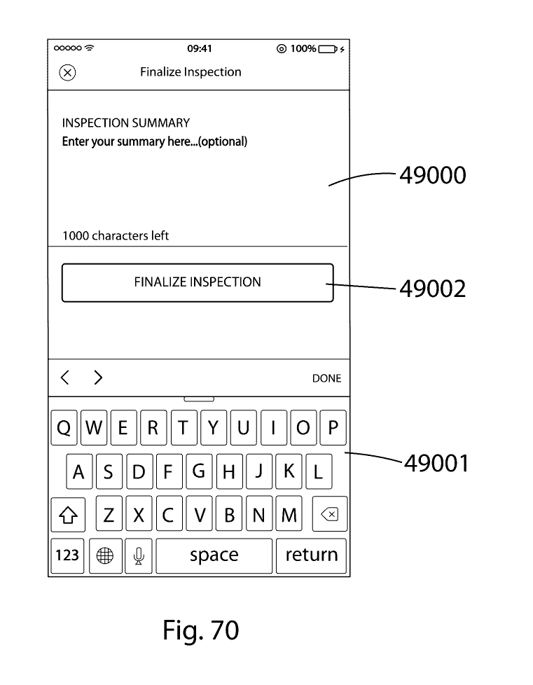

FIG. 70 is an inspector interface illustrating a finalized inspection summary screen, showing a pop-up keyboard on the client device of FIG. 49, for creating inspection summary comments, in accordance with one embodiment of the present invention;

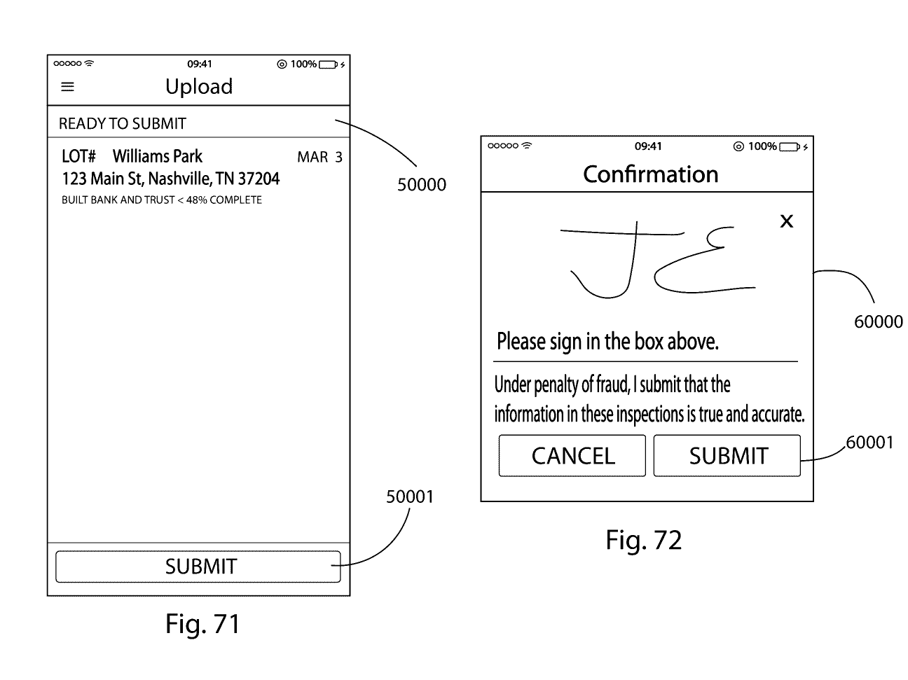

FIG. 71 is an inspector interface illustrating an upload inspection screen, showing a completed inspection report of a property ready for uploading onto the construction loan management system, in accordance with one embodiment of the present invention;

FIG. 72 is an inspector interface illustrating an inspection confirmation screen, showing a digital or electronic signature of an inspector applied to an inspection report, and a submit tab for uploading the signed inspection report, in accordance with one embodiment of the present invention; and

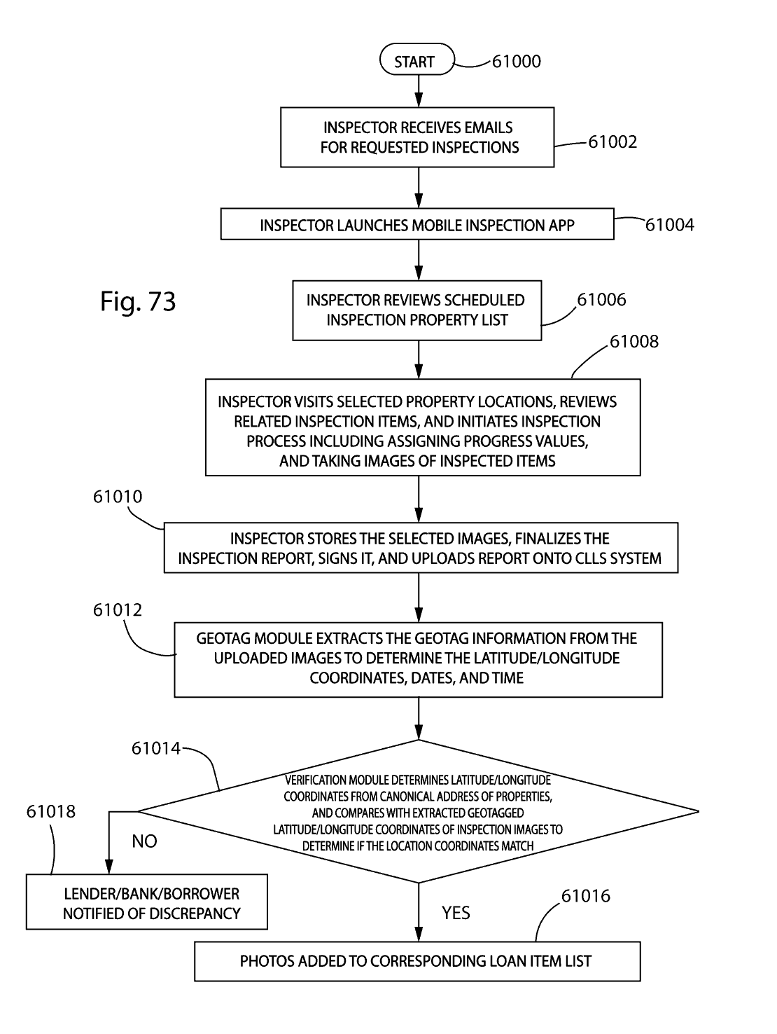

FIG. 73 is a flow diagram illustrating one embodiment of an inspection and geotag verification process, in accordance with one embodiment of the present invention.

### DETAILED DESCRIPTION OF THE INVENTION

The following detailed description, taken in conjunction with the accompanying drawings, is merely exemplary in nature and is not intended to limit the described embodiments or the application and uses of the described embodiments. Any implementation described herein as “exemplary” or “illustrative” is not necessarily to be construed as preferred or advantageous over other implementations.

Furthermore, there is no intention to be bound by any expressed or implied theory presented in the preceding technical field, background, brief summary or the following detailed description. It is also understood that the specific devices, systems, methods, and processes illustrated in the attached drawings, and described in the following specification, are simply exemplary embodiments of the inventive concepts defined in the appended claims that there may be variations to the drawings, steps, methods, or processes, depicted therein without departing from the spirit of the invention. All of these variations are considered to be within the scope of the present invention. Hence, specific structural and functional details disclosed in relation to the exemplary embodiments described herein are not to be interpreted as limiting, but merely as a representative basis for teaching one skilled in the art to variously employ the present invention in virtually any appropriate form, and it will be apparent to those skilled in the art that the present invention may be practiced without these specific details.

Various terms used in the following detailed description are provided and included for giving a perspective understanding of the function, operation, and use of the present invention, and such terms are not intended to limit the embodiments, scope, claims, or use of the present invention.

The term, “borrower”, as used herein, means one or more individuals, groups of individuals, associations, or companies, engaged in borrowing money from a lending institution or bank for financing building projects. The term “borrower” may include any of the following: borrower, builder, owner, investor, licensed broker, licensed general contractor, sub-contractor, building developer, consumer, officer, director, shareholder, real estate agent, land manager, or condominium or apartment complex developer, or any other individual seeking to acquire a construction loan or loans for building a structure, or for developing land or landscapes.

The term “construction loan”, as used herein, means one or more set-term loans that are used to pay for the costs of constructing a building project, or landscaping property in preparation of constructing a building project. The term, “draw”, or “draw request”, as used herein, means receiving or requesting, designated intervals of money or funds, from a bank or lending institution, where such payment intervals may be conditioned on, but are not limited to, partial or complete inspections of predefined building construction items.

The terms “loan administrator”, “loan officer”, “loan originator”, or “loan processor”, as used herein, mean one or more individuals, or one or more groups of individuals, that work with, or for, a money lending institution, lender, or bank, and perform administrative duties, including but not limited to, collecting, managing and processing all necessary information regarding borrowers, inspectors, real estate property and buildings and building inspections, accessing borrower financial needs, overseeing the process of construction loan applications, providing necessary information to prospective borrowers about available loans, preparing the necessary documents and paperwork for assisting borrowers in obtaining real estate construction loans, reviewing financial data and needs of perspective borrowers, making recommendations to lenders about borrowers, assisting in refinancing existing loans, identifying and assisting borrowers who may be looking to expand businesses or increase the amount of funds borrowed, initiating inspections, managing construction loan portfolios, and approving or denying loan applications and/or draw requests.

The term, “bank administrator”, “lender”, or “bank officer”, “branch admin”, as used herein, means one or more individuals, or one or more groups of individuals, that oversees, manages, and/or administers the daily functions and operations of a financial institution, such as a bank and bank processes, including overseeing operational hardware and software systems, system maintenance and repairs, bank assets, assists banking staff in handling and meeting customer needs, oversees and works with loan administrators in managing construction loans, engages in the approval or denial process of loans, and organizes and manages databases relating to banking clients and their needs. The term, “branch” as used herein, means one or more associated parts of a bank, one or more child branches of a bank, geographic locations of a bank, or individuals such as a lender.

As used herein, the term, “inspector”, means one or more individuals, one or more groups of individuals, or an inspection company, that is certified or licensed to inspect residential or commercial real estate buildings, pursuant to, and in accordance with, town, city, state, and federal building codes, specifications, laws, and regulations, manages inspection documents, forms, reports and images, throughout the inspection process, and provides a completed inspection report for designated parties.

The term, “property', “real estate property”, “building”, “building project”, “construction property”, or the like, means any of, buildings, garages, condominiums, townhouses, houses, apartment complexes, malls, residences or dwellings, cabins or cottages, sheds, storage facilities, warehouses, plants, retail or commerce buildings, restaurants, gas stations, rental units, or any other functional structure used in providing some form of shelter, storage, or dwelling, and may include residential or commercial property, properties, building, or buildings.

The terms, “modules”, “program modules”, “components”, “systems”, “utilities”, and the like include routines, computer programs, objects, components, data, computer code, data structures, program applications, and instructions that perform particular tasks or implement particular abstract data types. Modules or sub-modules, refer to computer-related entities that can be implemented as software, hardware, firmware, and/or other suitable components that provide the described system functionality and which may be stored or loaded into memory of a machine embodying an exemplary embodiment of the present invention. Aspects of the modules may be written in a variety of programming languages, including but not limited to, compiled languages such as, C, C++, Java, or Pascal. The functionality of modules, used for aspects of exemplary embodiments described herein, can be combined and/or further partitioned.

As used herein, the terms “data storage unit,” “data store”, “storage unit”, “hard drive”, “memory stick”, “external memory”, “database”, and the like, can refer to any suitable memory system(s), or device(s) that may be used for storing data or information, electronic files, machine readable files, and other databases. Interfaces, modules, and/or storage units, can be implemented and run on the same computing system, or they can be implemented and run on different computing systems. For example, one or more modules can be implemented on a personal computer operated by a user while other modules can be implemented on a remote server and accessed via a network.

Client applications utilized in exemplary embodiments of the present invention, can be configured for incorporation within any suitable network computing environment such as a plug-in, add-on, or extension. As used herein, the term “plug-in” can refer to one or more software applications, module programs, programs, code, or computer instructions, which may or may not be in communication with other software applications or modules, that interacts with a host application to provide specified functionality, and which may include any file, image, graphic, icon, audio, video, or any other attachment. In other exemplary embodiments, the client application can be implemented as a standalone program that is run as a separate computer process, a portable application, a native app, a web app, as part of a software bundle, or any other suitable implementation. The construction loan management system and method, of the present invention, can be designed to support a plug-in architecture including add-ons, extensions, or various software components to add user-specific functionalities, and to address dynamic changes in loan management services.

Exemplary embodiments of the present invention can include one or more interfaces for managing real estate construction loans. The term, “interface”, or “interfaces”, refers to, or means one or more devices, systems, or programs, that enable a user to communicate and exchange information with one or more computers, and/or servers, and enables users to view, edit or amend, add, create, manipulate, save or store, input, print, submit, transfer, manage, navigate, and import/export, any and all data, information, bits, values, elements, figures, symbols, characters, terms, numbers, graphs, or the like, relating to software program applications, web applications, or web pages. The term “interface”, or “interfaces”, may include software interfaces, hardware interfaces, or a combination of both software and hardware interfaces. The system and method of the present invention is implemented to provide distinct user-specific interfaces where a user may include, but is not limited to, a borrower, inspector, loan administrator, or bank administrator.

Unless specifically stated otherwise, as apparent from the description, terms such as “executing” or “processing” or “computing” or “calculating” or “determining” or the like, may refer to the action and processes of a processor-based system, or similar electronic computing device, that manipulates and transforms data represented as physical quantities within the processor-based system's storage into other data similarly represented or other such information storage, transmission or display devices.

Exemplary embodiments of the present invention can be realized in hardware, software, or a combination of hardware and software. Exemplary embodiments can be realized in one central computer system, or in a distributed fashion where different elements are spread across several interconnected computer systems. Any kind of computer system or other apparatus adapted for carrying out the methods described herein is suitable. A typical combination of hardware and software could be a general-purpose computer system including a computer program that, when loaded and executed, controls and instructs the computer system to perform the tasks, steps, and methods described herein.

Exemplary embodiments of the present invention can also be embedded in a computer program product, which comprises all the features enabling the implementation of the methods described herein, and which when loaded in a computer system is able to carry out these methods. The term, “computer program”, as referred to herein, means a collection of instructions or code, intended to cause a system having an information processing capability or central processing unit(s), to perform a particular function either directly or after either or both of the following: (a) conversion to another language, code or, notation; and (b) reproduction in a different material form. A computer system in which exemplary embodiments can be implemented may include, inter alia, one or more computers and at least a computer program product on a computer readable medium, allowing a computer system, to read data, code, instructions, messages or message packets, and other computer readable information from the computer readable medium. The computer readable medium may include non-volatile memory, such as ROM, flash memory, disk drive memory, CD-ROM, and other permanent storage, and can be used, for example, to transport information, such as data and computer instructions, between computer systems. Additionally, a computer readable medium may include, for example, nonvolatile or volatile storage such as RAM, buffers, cache memory, and network circuits. Furthermore, the computer readable medium may comprise computer readable information in a transitory state medium such as a network link and/or a network interface, including a wired network or a wireless network that allows one or more computer systems to read such computer readable information.

Referring now to the drawings wherein like elements are represented by like numerals throughout, there is shown in FIG. 1, a graphical representation of a construction loan management system and method (CLMS) 100, in accordance with one embodiment of the present invention. The CLMS 100 system includes a plurality of client devices 112 that communicate with a computer system 114, and one or more servers 116, via a network 118. In one embodiment, the CLMS system 100 comprises a construction loan management system that provides centralized hosting of web-based or software-as-a-service construction loan management services software that is accessible, via client devices 112, over a network 118. The CLMS system provides ease in administrating construction loan management services by alleviating the need of having to install and maintain software applications on numerous computer systems, and the need of having to manage software updates, and complex hardware configurations, as often seen in a software-as-a-product system. Further, the CLMS system provides central management of loan management services, and supports global accessibility.

With continued reference to FIG. 1, there are shown exemplary embodiments of client devices 112 accessible by users including a kiosk, a desktop computer, a notebook or laptop computer, a mobile phone, a PDA, and a tablet. Client devices 112 generally include the necessary components for communicating with computer system 114, some of which include a keyboard or touchpad, memory, a processor, I/O interface, and display for accessing and navigating through software applications over network 118. In one exemplary embodiment, client devices 112 may be located at a user's place of business, office, or home, and is remotely portable. Alternatively, client devices 112 may be situated and provided on-site at designated banks, branches, or lending institutions. Client devices 112 preferably operate under the command of a control program such as a browser, or a micro-browser allowing users to view images, and read hypertext documents, such as webpages. Well-known browsers include Internet Explorer™, Google Chrome™, Mozilla™, Opera™, and Safari™. Client devices 112 may comprise thin client hardware, well-known for use in service-as-a-system configurations, such as a computer terminal including I/O interfaces and open, serial or parallel ports for a supporting a variety of USB devices, and client software including cloud access agents, a web browser, or graphical user interface.

As illustrated in FIG.1, the construction loan management system 100 includes a web host computer system 114 for hosting a construction loan management services application or applications platform 200. Computer system 114 may include one or more computers or servers for hosting real estate construction loan management services software applications, data processing, file storage, or virtual desktop software. For example, in support of a service-as-a system (SaaS), or infrastructure as a service system (IaaS), CLMS software applications may be hosted by a vendor or third party service provider for managing, software/hardware, access, security, performance and availability of CLMS.

Computer system 114 may include one or more general-purpose computers (e.g., personal computers and/or one or more servers), one or more special-purpose computers (e.g., devices specifically programmed to communicate with each other), or a combination of one or more general-purpose computers and one or more special-purpose computers. Computer system 114 can include a plurality of processors 120, 122, 124 each coupled to system memory 130, via an input/output (I/O) interface 126. As such, the web host services computer system 114 may be a uniprocessor system including a single processor 120, or may comprise a multiprocessor system including several processors 120, 122, 124. Processors 120, 122, 124 may comprise any suitable processor capable of executing instructions, and may comprise a general-purpose or embedded processor implementing any of a variety of instruction set architectures (ISAs), such as the x86, PowerPC, SPARC, or MIPS ISAs, or any other suitable ISA. In multiprocessor systems, each of processor 120, 122, 124 may commonly, but not necessarily, implement the same instruction set architectures. The construction loan management system 100 may be implemented as a unified or distributed system using one or more computer systems 114, with instructions executable by one or more of the processors 120, 122, 124, and may be implemented as part of a single software or software/hardware system, or alternatively, may be partitioned in any suitable fashion into a number of distinct modules, procedures or other functional portions. Further, the computer system 114 may be tailored as a content distribution network (CDN) providing a system of computers or servers 116, containing data or information and placed at various points in a network to maximize bandwidth for access to the information or data from various users. As such, users may access the data or information from servers 116 or computer system 114 that are closer in distance to users. The computer system 114 may also include any well-known operating system, such as, but not limited to, Microsoft Windows™, or Apple's OS X™, software programs for managing computer hardware and providing common services for executing application software. A computer system 114 server-side infrastructure may include cloud-computing software including hosted shared desktop (HSD), or desktop virtualization (VDI).

Computer system 114 further includes an I/O interface 126 electrically coupled to a network interface 128. In one embodiment, I/O interface 126 may be configured to coordinate I/O traffic between processors 120, 122, 124, system memory 130, and any peripheral devices, including network interface 128. In some embodiments, I/O interface 126 may perform necessary protocol, timing, or other data transformations to convert data signals from one component (e.g., system memory 130) into a format suitable for use by another component (e.g., processors 120, 122, 124). In some embodiments, I/O interface 126 may include support for devices attached through various types of peripheral buses, such as a variant of the Peripheral Component Interconnect (PCI) bus standard or the Universal Serial Bus (USB) standard. The function of I/O interface 126 may be split into two or more separate components, such as a north bridge and a south bridge, for example. Also, in some embodiments some or all of the functionality of I/O interface 126, such as an interface to system memory 130, may be incorporated directly into processor 120, 122, 124.

Computer system memory 130 is configured to store instructions and data accessible by processors 120, 122, 124. In various embodiments, system memory 130 may be implemented using any suitable memory technology, such as static random access memory (SRAM), synchronous dynamic RAM (SDRAM), nonvolatile/flash-type memory, or any other type of memory. In the illustrated embodiment, program instructions and data implementing desired functions may be stored within system memory 130, as code 132. Further, system memory 130 may be one embodiment of a computer-accessible medium configured to store the construction loan management services application programs 200, as better illustrated in FIG. 2. Alternatively, the construction loan management services application programs 200, and/or data files, may be received, sent or stored upon different types of computer-accessible media, servers 116, or one or more databases 131 or any combination thereof. Machine-executable program instructions or computer application programs may be stored on one or more machine readable mediums, including but not limited to, optical disk, magnetic or optical card or tape, flash memory, CD/DVD-ROM, memory dongle, magnetic storage media such as a hard drive or any other external machine-readable medium coupled to computer system 114, via I/O interface 126. Computer-accessible medium may include any volatile or non-volatile media such as RAM (e.g. SDRAM, DDR SDRAM, RDRAM, SRAM, etc.), ROM, EEPROM, or EPROM. Program instructions and data stored via a computer-accessible medium may be transmitted by transmission media or signals such as electrical, electromagnetic, optical, or digital signals, which may be conveyed via a communication medium such as a network 118 and/or a wireless link.

One or more databases 131 may be provided for hosting, storing, and managing information and data in support of the construction loan management system including accessible storage of construction loan management services application platform 200. Also, database 131 may include any suitable type of application or data structure that may be configured as a persistent data repository. For example, database 131 may be configured as a relational database that includes one or more tables of rows and rows and that may be searched or queried according to a query language, such as a version of Structured Query Language (SQL). Alternatively, database 131 may be configured as a structured data store that includes data records formatted according to a markup language, such as a version of extensible Markup Language (XML). In other embodiments, database 131 may be implemented using one or more arbitrarily or minimally structured data files managed and accessible through any suitable type of application. Thus, both memory 130, and/or database 131, separately, or in combination, may be configured to store programs, applications, data, information, files, and data related to users, or operative system components and/or requests for services in various stages of processing.

Network interface 128 is configured to allow communication between computer system 114 and client devices 112, and/or servers 116, via network 118. However, network interface 128 also supports communication between computer system 114, and other electronic devices or systems attached to network 118, such as, but not limited to, printers, card readers, web cams, processors, video systems, or other devices. In one non-limiting example, network interface 128 may include one or more interface cards, and/or software interface, and may support wired Ethernet connections, or wireless connections. Network interface 128 may commonly support one or more wireless networking protocols, and may support communications, via telecommunications or telephony networks such as analog voice networks or digital fiber communications networks, via storage area networks such as Fibre Channel SANs, or via any other suitable type of network and/or protocol.

Communication network 118, may comprise a wired or wireless communication network including any of, a WLAN (wireless local area network, such as WiFi (IEEE 802.11)), WPANS (wireless personal area networks, such as Bluetooth (IEEE 802.15), Infrared, Zigbee), WMAN (wireless metropolitan area network, such as WiMax (IEEE 802.16)), WWAN (wireless wide area networks, internet), and GAN (global area network), a telephone network, (e.g., analog, digital, wired, wireless, PSTN, ISDN, or XDSL, a mobile wireless communication system, such as 3G, 4G, an internet-protocol based communication system, or other radio network (RF), cable network, satellite network, optical network, an internet or intranet system, or wired or wireless communications network(s) configured to carry and exchange data between client devices 112, computer system 114, and servers 116. Network 118 may include a variety of communication or information exchange components or peripherals, including, but not limited to, one or more base stations, proxy servers, routers, switches, repeaters, Ethernet hubs, wired or wireless data pathways, or modems, to name a few, that are configured to direct and/or deliver data.

The present invention may advantageously make use of various communication protocols including, Hyper Text Transport Protocol (HTTP), Simple Mail Transfer Protocol (SMTP), File Transfer Protocol (FTP), and newer protocols such as Blocks Extensible Exchange Protocol (BEEP). HTTP is a known application protocol used for accessing web content and provides users access to files (which can be in different formats such as text, graphics, images, sound, video, etc.) using a standard page description language known as Hypertext Markup Language (HTML). HTML web browsers allow for graphical user interface based access to HTML documents (web pages) accessible on servers. Other protocols may include TCP, UDP, IP, ICMP, SSH, TLS/SSL, FTP, and mobile communication protocols such as SMS, MMS, WAP, and IMS.

Various web service architectures can used to provide web host services such as the construction loan management services application or programs of the present invention. Exemplary forms of web service architectures may include SOAP (simple object access protocol), and REST (representation state transfer) that both use XML file format for interchange. Another web service architecture may include JSON (java script object notation) that uses java script. It will also be understood that browser-wrap agreements may also be incorporated for defining terms and conditions for access and use of the loan management services website.

One or more servers 116, comprising computers, and/or computer programs, are implemented to provide various functionalities such as data sharing, performing computations, running computer processes, hosting web pages and/or web applications, maintaining databases, storing and sharing files, providing email communications, sharing digital video or audio, and sharing printers, to name a few. Thus, one or more servers 116 may include any one or a combination of, an application server, web server, computing server, communications server, database/file server, mail server, print server, proxy server, or additional servers. Severs 116 can be managed, controlled and operated by a designated entity, business, company, bank, or internet service provider. The term “service provider” as used herein, refers to a commercial entity that provides services to a user or a subscriber and may include any of, an application service provider (ASP) offering on-demand software or software as a service, a network service provider (NSP), an internet service provider (ISP), a managed service provider (MSP), or a telecommunication service provider (TSP).

Turning now to FIG. 2, there is illustrated a real estate, construction loan management services platform 200, in accordance with one embodiment of the present invention. CLMS platform 200 is defined by a services interface block 201 that functionally interacts with a services module block 202 to present, process and manage information, and data regarding construction loan management services. Services interface block 201 includes a number of user-specific interfaces that are specifically engineered for use by loan administrators, borrowers/builders, bank administrators, and inspectors. Services module block 202 includes various service modules designed to support various functionalities in managing construction loan portfolios. Blocks 201, 202 comprise computer software instructions, and/or application programs written in computer code 132 and functionally stored in system memory 130 and/or database 131.

Services blocks 201, 202, respectively, provide functional interfaces and modules through which users interact with the CLMS system 100, via a host of web pages, and their associated links. Such web page applications may include fillable forms, drop-down menus, task-based menus, loan activity menus, text-entry boxes, collapsible bars, dashboards, executable applications (e.g., applications coded in Java™, Javascript or another language suitable for web-based execution) or other web-based interfacing or software elements. In another embodiment, blocks 201, 202, may be configured to present proprietary or non-web-based interfaces to users. For example, interfaces may be accessible through a dialup or non-web-based Internet connection, such as via a terminal emulation program such as telnet, or via another type of standard or proprietary application suitable for transmitting information between users and CLMS System.

In one embodiment, interface block 210 includes a user-specific interface defined as a loan administrator (loan admin) interface 203. The loan admin software interface 203 comprises a host of web pages and applications that are accessibly navigated by loan administrators for creating, setting up and managing construction loans, and for inviting borrowers and inspectors onto the construction loan management services platform. The loan administrator interface 203 is used by loan admins to perform a number of tasks associated with construction loan management services including, but not limited to, creating borrower and inspector profile information, setting-up loan account information including loan financials, identifying and generating building property information, creating and managing construction item inspection templates, scheduling property inspections, managing draw requests, and overseeing draw approval processes.

Services interface block 201 also includes a borrower interface 204 comprising a host of web pages and applications that are accessible by borrowers and navigated for functionally managing construction loan portfolios. Borrowers may visit the CLMS platform to make single or batch loan draw requests, or itemized draw requests, manage inspection requests, search through loan portfolios, view in-depth loan related items, inspection images, transactions, files, leave comments, and manage account settings.

Services interface block 201 includes a user-specific interface defined by an inspector software interface 205 comprising a host of web pages and applications that are accessible by inspectors and navigated for functionally managing inspections of building construction items in accordance with building codes, specifications, and practices. The inspector interface 205 is governed by a field or mobile inspection application that is operable, via a client device 112, for remotely managing field inspections, organizing images of construction items, and generating inspection reports.

Services interface block 201 also includes a user-specific interface defined as a bank administrator (bank admin) interface 206 comprising a host of web pages and applications that are accessible by banks or lenders, and navigated for functionally managing construction loans such as overseeing draw requests, and inspection requests, viewing in-depth loan related items, inspections and inspection images, transactions, and files, managing user-account settings, and managing and setting hierarchy access levels and functional parameters for CLMS system users.

It will be noted that additional user-specific software interfaces 207 may be included in the construction loan management services platform 200. For example, other user-specific software interfaces 207 may be designed and engineered for specific use by, builders, land developers, investors, contractors, sub-contractors, consumers, or other entities, and include various functional features, elements or components that are specifically implemented to provide same or different, functional lending services. For example, the construction loan management system may include a borrower interface, a builder interface, a general contractor interface, a sub-contractor interface, a developer interface, where each user-specific interface includes the same or different functions to accommodate user needs.

As illustrated in FIG. 2, services module block 202 includes an authentication/access module, denoted at 208, for granting secured access to the construction loan management system. Authentication/access module 208 is implemented to ensure user-authorized access, and to provide secured confidence in using the system 100. Various forms of authentication protocols may include software-based, and/or hardware-based authentication device, systems, or methods. Authentication may comprise a single-tier, two-tier, or multi-tier authentication protocol process. Some examples of authentication protocols may include, but is not limited to, smart card technology, browser certificates, hardware OTP tokens, software tokens, hardware security modules (HSM), or biometric authentication using one or more sensors for sensing fingerprints, hand geometry, iris or retinal patterns, or voice sampling or recognition. Other authentication protocols may include, IP security (IPSec) authentication methods, including the Kerberos protocol, private or public key certificates, or a simple pre-shared secret key, Challenge Handshake Authentication Protocol (CHAP), or the Extensible Authentication Protocol (EAP).

One well-known authentication protocol comprises authentication credentials including username and password. The sign-on credentials are typically created when setting-up construction loan accounts, and may be changed later, via user account settings. In one embodiment, the CLMS system may include a password security indicator to help guide users in creating secured passwords in order to deter hackers in gaining access to, or replicating user-passwords. It will be understood that the CLMS system 100 may also include hierarchy level access authentication where users are granted controlled access to certain levels of system operations or functions. For example, bank admins may be given access to higher levels of system administration and operations, such as setting, changing or managing CLMS system parameters, components, operational commands, or functional attributes. Lenders or banks may prefer to have control over certain uses, functions, and/or operations of the CLMS system that are made non-available to loan administrators, borrowers and inspectors. Thus, hierarchy levels of system operations may be controlled by user sign-in credentials as well.

The services module block 202 further includes a draw management module 209 for managing draw requests generally initiated by borrowers, via borrower interface 204. Draw management module 209 correlates loan financials with draw requests, completed item inspection process, and the approval process, to allocate funds to borrowers/builders. Draw management module 209 also manages the method of making draw requests, for example whether draw requests are made manually or are set automatically by users.

Services module block 202 also includes a loan management module, denoted at 210. Loan management module 210 performs a variety of functions in managing construction loan information and data. For example, loan management module 210 manages and processes loan related information including: setting-up construction item templates; assimilating information and data corresponding to borrowers, builders, inspectors, and loan and bank administrators; managing items, inspections, transactions, files, and comments; managing loan financials and property information; initiating or scheduling inspections; determining and providing status of loans; assigning and managing progress values regarding the construction of items; managing draw requests; correlating historical data and reports; managing files; assigning inspectors; approving or denying draws; and managing inspection images and reports, to name a few.

The loan management services platform 200 also includes an inspection management module, shown at 211, for managing various aspects of the inspection process. Inspection management module 211, includes, an inspection template manager in which construction item templates and draw inspection templates are created and stored; an inspection request and schedule manager in which inspections, that are requested and scheduled by loan administrators and borrowers, via the loan admin and borrower interfaces, respectively, are scheduled and assigned to inspectors; an inspection image and report manager for managing and correlating inspection images and reports; and an inspection based progress manager, for assigning progress values to construction items upon completed inspections.

With continued reference to FIG. 2, services module block 202 also includes a document module 212 for generating and managing a host of documents including legally binding agreements for loans and loan related products and services. Documents may be created from customizable templates and data-collection forms that are stored in a database, and compiled dynamically, in any contemporary digital format such as PDF. Further, document module 212 can manage and create document templates, digital data forms, or other loan related documents, based on one or more triggered events. For example document module 212 can automatically and dynamically update documents in response to changes in circumstances, or the occurrence of a particular event, where such documents may be generated as software objects with a built-in set of accessible functions, where object functions can include functionality that is specific to the construction loan management system or method. In exemplary embodiments, there may be documents that have separate sections in which the formatting for each section is dependent on values specified for a different respective set of variables. Thus, in exemplary embodiments, the documents and information for facilitating a loan and for managing the loan could be created, recorded, and maintained dynamically over time through various operations that are triggered by circumstances or events. Document module 212 can manage and process the uploading and tracking of documents, collect valid e-signatures or initials on documents, and maintain, create and generate documents such as, but not limited to, vendor agreements, contracts, assignments, deeds such as warranty, release and quick claim deeds, affidavits, state and federal real estate tax forms, titles, insurance policies, mortgages, promissory notes, discharges, bill of sales, certificates, surveys, HUD settlement statements, building certificates, releases, appraisals, judgements, specifications, and other any other document.

Another service module includes a geotag module, denoted at 213. Geotag module 213 may host or have access to, private or public software programs or tools for determining location information of properties, or images that were taken by inspectors on-site at property locations. Location information may include, but is not limited to, latitude/longitude coordinates, altitude, bearing, distance, direction and angle camera is pointing, date, time, or elevation. In one embodiment, the software provides extraction software for extracting geotagged information from images that were taken by inspectors on-site at property locations. Inspectors can use various devices that automatically geotag images, such as smartphones having built-in cameras, and built-in GPS receiver, digital cameras including a built-in GPS receiver, or a digital camera capable of supporting and external GPS receivers, via a cable or memory slot. Various geotag extraction programs can be used to extract the geotagged information that is embedded in metadata and stored in exchangeable image file format (Exif), or extensible metadata platform (XMP) format.

In situations where inspectors do not have imaging devices that automatically tag images, for example where inspectors use a camera, and a separate, standalone GPS receiver, the geotag module 213 may also host or have access to, private or public software programs or tools to determine location information of such images. For example, in such cases, digital images, and a GPS track log may be uploaded to the CLMS platform 200 where software tools are used to synchronize locations and images and store such information in Exif format. Exif data reader software can be used to provide a readout of image location coordinates. Software programs may be used to download GPS track data, to synchronize locations and images, and include data reader software to generate a readout of image coordinates. In one embodiment, the geotag module 213 may send reminders to field inspectors to synchronize the clocks when using a camera and separate standalone GPS receiver.

Geotag module 213 may also host, or have access to, private or public software for geotagging images where inspectors do not have access to a global positioning satellite receiver device. For example, inspectors may upload inspection images, where the geotag module 213 may provide geographic location data of where the images were taken by selecting the geographic location data from maps, or by providing the city, street address, or zip code. Software tools can map properties, images, or inspection reports, based on location approximation data. Geotag module 213 may provide a textual readout of location coordinates, or alternatively, may map images on maps to correlate the location of the images using private or public software tools. Further, geotag module 213 functions to forward resulting location coordinates of inspection reports to a verification module 214 to verify inspection reports.

With continued reference to FIG. 2, services module block 202 supports a verification module 214 for securely verifying various processes and functions of the CLMS system. For example, verification module 214 is implemented to verify system operations or parameters in determining component failure, system performance, and software updates. Verification module 214 can also process canonical addresses of properties, and determine latitude/longitude coordinates for each property location, and compare the determined location data to geotagged information of uploaded inspection reports, to verify the inspection reports. Verification module 214 can include or support digital or electronic signature verification protocols, including digital signature or electronic signature software and/or hardware tools. For example, verification module 214 may include software encryption or cryptographic protocols, such as public-key cryptography, which uses a signature scheme including public and private key generation algorithms, signing algorithms, and signature verifying algorithms. Verification module 214 may also verify and support communication interactions with mobile client devices, such as smartphones, where the device includes digital signature for mobile devices based on RSA public key algorithms.

Services module block 202 also includes a jurisdiction module, shown at 215. Jurisdiction module 215 may provide packages, modules, sub-modules, applications and programs, per jurisdiction, that can easily be customized and managed through user-specific interfaces. Jurisdiction module 215 may utilize location coordinates of properties, users, or of loan origination, to define jurisdiction-specific modules, documents, packages, programs or applications. Jurisdictions entered in the system can be used for branches of government as they apply to construction loan origination and servicing. Each jurisdiction may have jurisdiction-related modules that comply with state and federal laws. Jurisdiction-related packages or modules, may be implemented for each lender or borrower and provide user-specific interfaces that are tailored for location of users, such as borrowers, lenders, or banks, or for loan originating areas. Jurisdiction module 215 may include one or more jurisdiction document module(s) that process jurisdiction assessment information to generate loan services related documents on a per jurisdiction basis. For example once jurisdiction is determined, via location coordinates, the CLMS 100 can load jurisdiction-relevant modules and/or module processes for users. In correlation with document module 212, a document module, pertaining to a particular jurisdiction, may be presented to a user, for completing jurisdiction-related documents pertaining to construction loan management services.

Loan closing and payment module 216 monitors loan activity to provide loan status, manages disbursement of funds, in set intervals, upon inspection of construction items, and determines availability of funds by monitoring progress values of construction items for construction loans throughout origination of loans. Loan payment module 216 may include a financial transaction component for accessing and providing payments and fee collection, calculate inspection fees, loan origination and operation fees, schedule loan disbursements, determine available funds for draws, manage and collect loan payments, and access and manage loan financials. Loan payment module 216 may also include a loan closing/application component for managing loan closings and applications by gathering, recording, preparing, and processing various documents attributed to the origination and servicing of loans. Loan payment module 216 may function in conjunction with the document generator/manager module 212 and jurisdiction module 215 to customize and create jurisdiction-specific documents. Representative examples of such documents include, but are not limited to, borrower income documentation, asset information, liability information, builder information, purchase information, and identify information. For example, information may include copy of builder's construction contract, house plans and specifications, contract estimates, permits, deeds and closing documents of subject property if person owns the land, tax bill, builder's risk insurance, property lease agreements, and others. Further, often times, construction loans are converted into mortgages upon completing construction of the building on which the construction loan was founded. As such, various loan closing documents may be provided including discharges, mortgages, promissory notes, affidavits, contracts, deeds, title or property insurances, real estate tax forms, and others.

Services module block 202, includes a report module, shown at 217, in FIG. 2. Report module 217 provides functionality to generate and manage reports relating to construction loans that are categorized based on a certain characteristics, status, ranking, dates, loan origination area, property location, size or use of building, or other attributes. In one exemplary embodiment, loans are categorized according to status defined as, matured, overfunded, and flagged for inquiry, presold, aging, or stale. Each representative category provides a download function tab to selectively view in-depth information for each loan listed, and may include one or more sub-categories to further outline specifics or details of loans. Report module 217 may comprise historical or current loan data, loan analysis or summary information, loan-oriented statistical data, payment history of loan, and whether loans were transferred or assigned, to name a few.

A mapping module 217 may host, or have access to, private or public software programs for mapping location coordinates on maps representing states, cities, towns, subdivisions, streets, or roads. Location coordinates may comprise coordinates of property addresses, geotagged GPS coordinates of images, or locations of users. Mapping module 217 may also host mapping software and rendering, storing, and marking modules, and associated libraries and dependencies for mapping location coordinates. Both the geotag module 213, and the verification module 214 may process and forward geotagged coordinates of inspection images, inspection reports, and/or coordinates of property canonical addresses to the mapping module 217 for plotting determined coordinates on a map. Mapped properties may be represented by visual markers to provide a quick, visual location reference of properties. For example, location coordinates may be represented by visual property markers each having same or different shapes, symbols, or colors. Visual property markers each correspond to a property address or location, and correspond with a database record of canonical property addresses and/or geotagged images, entered into the system by loan administrators, borrowers, inspectors, or other users. In one embodiment, mapping module 217 allow users, such as inspectors, to move a cursor or point to a visual property marker on a map, to acquire driving instructions, and a host of additional information. In one non-limiting example, mapping module 217 may include a route optimization module for providing optimize driving instructions to inspectors in preparation of conducting inspections defined by the daily or monthly inspection schedule. Route optimization may be premised on group inspections by location or subdivision to schedule efficient routes.

It will be understood that other modules 219 may be included for providing various other functions associated with construction loan management services. Some non-limiting examples of additional modules include, but are not limited to, financial and accounting modules, user-specific function modules, server modules, specific template modules, system security modules, identify theft protection modules, tax or loan interest modules, city, state or federal regulations module, building codes and specifications module, licensing and permits module, vendor module, management database module, system support and/or tools module, network module, application programs module, digital or electronic signature module including encryption or cryptographic sub-modules, task module, legal compliance module, resources module, invoice/receipt module, fees module, and any other modules used in providing construction loan management services.

Another exemplary embodiment of an additional module that may be included in the services module block 202, is a policy engine template module. With the addition of the policy engine template module, banks have the power to have multiple predefined policy templates that can be brought together, automatically, at each loan creation based on loan specifications. The policy engine template module may function in conjunction with the document management module 212, in managing predefined policy templates or packages, and loan application templates. As such, appropriate policy templates may be automatically applied to selected application templates in creating new construction loans. Either or both of the policy templates, and the application templates may be selected, assigned, or determined based on one or more events, or jurisdiction determinations. For example, a borrower using the construction loan management system in one jurisdiction will result in the system determining jurisdiction-related policy templates, and jurisdiction-related loan application templates, and automatically assign the selected one or more policy templates to the selected one or more application templates. Loan admins may add additional criteria unique to a loan, and rearrange the order or nature of the policy templates.

Another exemplary module that may be included in the services module block 202, is a checklist module. A checklist module may be included to ensure the banks' or lenders' loan services process is completed in a consistent, accurate, and repeatable manner. In one exemplary embodiment, the checklist module may include a plurality of predetermined checklist templates that can be automatically assigned or added to loan applications, based on certain criteria, policy templates, jurisdiction, event triggers, or loan application templates. Such checklists would be subject to review, market changes, and compliance guidelines. Thus, predefined checklists could be automatically assigned to construction loans, based on, jurisdiction, event circumstances, type of loan, parties involved, and/or loan financials.

The present invention is directed to a real estate, construction loan management system and method (CLMS) 100 including user-specific interfaces for managing construction loan portfolios. One exemplary embodiment of a user-specific interface is directed to a loan administrator (loan admin) interface 203 designed to provide functionality for creating and managing, user profiles, construction loans, inspections and draw requests, and for inviting borrowers and inspectors onto the construction loan management services application platform 200.

Borrowers/builders often seek construction loans to support financial costs and expenses of building projects. In obtaining construction loans, borrowers typically consult with a loan administrator (loan admin) of a bank, to begin the loan application process that involves setting-up account profile information, gathering and completing needed documents and information, and negotiating terms and conditions pertaining to loan financials. The construction loan management system 100, of the present invention, is engineered to better address borrower/builder needs in acquiring construction loans.

In initiating the loan setup and management process, one or more loan administrators access the construction loan management services computer or server system 114, via network 118, using any one of the client devices 112, as illustrated in FIG. 1. Loan admins can initiate a control program (e.g. a browser), and insert a uniform resource locator (URL) for accessing the CLMS application platform 200 to begin the process of managing construction loans for borrowers/builders.

With reference now made to FIG. 3, there is shown a user-login display screen, denoted at 300. Upon entering a correct uniform resource locator, via client device 112 and browser, loan admins are presented with a user-login page which is functionally supported by authentication/access module 208, as shown in FIG. 2. In one embodiment, authentication/access module 208 supports a password/username credential protocol for secured access to the CLMS platform 200. The authentication/access module 208 may provide access support to loan admins that have forgotten their access credentials, representatively shown as, “forgot your username or password?”. Examples of access support include, but are not limited to, presenting a user with one or more challenge questions, or preassigned images, or providing numerical or alphabetical information in a capchia text-entry box.

Proper authenticated access results in the loan administrator interface functionally presenting a construction loan management and draw approval display screen 400, showing an exemplary number of pending property loans 401, 402, 403, a loan taskbar 404, and a collapsible loan account bar 411, as illustrated in FIG. 4. Although the construction loan management and draw approval page 400 generally comprises the homepage for loan admins, it will be noted that the loan admin interface 203 may direct loan admins to a homepage comprising other formats or layouts.

Each pending property loan 401, 402, 403 provides associated loan information including, inter alia, address of properties, lot numbers, names of subdivision, names of borrowers, and amount of funds requested for disbursement, amount of money available to draw, and a line of credit provided for each loan, as shown at 405. The functionality of the construction loan management and draw approval screen 400, also provides the amount of money funded to date on each loan, and the total amount of money that will be funded to date, if a draw request is approved, both represented in percentages and illustrated in circles including numerical percentages, 406 and 407, respectively. Thus, loan admins are provided with a quick visual reference of pending loans, and can quickly see how much money, in percentage, the loan has been funded to date, and how much will be funded, if loan admins approve particular draw requests.

Loan management and draw approval screen 400 shows each pending property loan 401, 402, 403, including three operative tabs, entitled, “view” 408, “approve” 409, and “decline” 410. The operative view tab 408 allows loan admins to access and view detailed information pertaining to the corresponding loan. The approve tab 409, and decline tab 410, allow loan admins to approve or decline draw requests that were initiated by borrowers/builders. Hence, by accessing the construction loan management and draw approval page 400, loan admins can quickly and easily view pending loans and related loan information, see loan-related draw requests, view in-depth loan information by activating the view tab 408, and approve or decline draw requests, via tabs 409, and 410, respectively.

Loan admins may also navigate loan task bar 404 to access and manage various aspects of construction loan accounts. Although loan task bar 404 is presented in vertical orientation, it will be understood that loan task bar 404 may comprise any format including, but not limited to, a drop down menu, a collapsible bar, a horizontal bar, a pop-up window, breadcrumb navigation, or the like. Loan task bar 404 includes a variety of task-based attributes that comprise: a homepage tab, represented as a home symbol, for directing loan admins to the construction loan management and draw approval screen 400; a notifications tab, represented as a bell symbol, for providing notices or alerts regarding particular loan activity, draw request activity, inspection request activity, reporting activity, file sharing, comments, or verification notices; an add new tab, illustrated as a plus symbol in one exemplary embodiment, for creating, and setting-up borrower, builder, and inspector profile information, inspection and draw requests information, inspection templates, property address and information, administrator information, branch or bank information, loan financials, and for inviting borrows and inspectors onto the construction loan management services platform 200; a block tab; a map tab, for mapping and viewing property locations on maps; a search tab, represented by a magnifying glass symbol, for searching particular loans throughout the loan portfolio; an inspection request tab, represented by a camera symbol, for allowing loan admins to manage inspection requests; a draw tab, represented as a dollar symbol, for managing draw requests; a history tab, for viewing historical data and information regarding construction loans such as loan, inspection, and item history, borrowers, inspections, and inspectors; and finally, a reports tab, represented as a graph symbol, for viewing categorized status of construction loans.

It will be appreciated that loan task bar 404 may include various other task-based tabs such as, a tool box tab, for providing various tools including calculators such as standard calculators, or mortgage calculators, or other formula processor, measurement or exchange rate converter, coordinate charts, clock, phonebooks, calendars, and/or a notepad, to name a few. Another task-based tab may include a document tab, for storing certain documents relating to the construction phases of a building. For example such documents may include, but are not limited to, illustrations or charts, electrical and plumbing schematics, building plans including land diagrams, and plan amendments, blueprints, building codes, site specifications, floor plans, materials lists, or surveys. A legal tab, represented by a legal scale, may be included to provide one location for storing a variety of legal documents such as mortgages, deeds, discharges, bank notes, promissory notes, bill of sales, disclaimers, agreements, contracts, affidavits, land titles and title certifications, title insurance policies, leases, and other documents. A checklist tab may be provided to provide smart checklists to loan admins for use during the creating, setting-up, and managing construction loans. Such checklists can assist loan admins in determining the construction loan process is complete, comprehensive, and reliable.

The construction loan management and draw approval screen 400 further includes a collapsible, loan account bar, indicated at 411. Loan account bar 411, includes task-based operatives for managing and setting user account information. Non-limiting examples of task-based operatives are shown as, “my account”, “my company”, “resources”, and “sign-off”. My accounts, allows users to create, add, and manage various account information including, addresses, contact information such as phone numbers and email addresses, allows users to change or update access credentials (e.g. username and password), update authentication access support by updating or changing challenge questions, and to set notification alerts regarding loans, draws and inspections activity, retrieving report updates, and notifying when files or comments are shared with others. My company, allows users to manage company and administrator information, user accounts, and loan associated lines of credit. For example, loan admins may create loan financials including, credit line information such as terms, interests, and amounts. The resources operative, provides access to a number of resources regarding information relating to the loan management system and method, for example, materials on how to use the system, the type of documents needed in support of loans, how to maintain invoices, and videos, audio files, magazines, articles, books, or other resourceful information. A sign-off tab is provided to sign off the system when no longer in use. It will be understood that both, the loan task bar 404, and the loan account bar 411 are generally accessible for use on most web pages of the loan administrator interface.

As noted, loan admins may wish to view in-depth loan-related information regarding pending construction loans. The construction loan management and draw approval screen, 400, allows loan admins to access such information by selecting the desired, “view”, tab 408, as illustrated in FIG. 4. In selecting the view tab 408, loan admins are linked to a construction items screen 500, as better illustrated in FIG. 5.

In one exemplary embodiment, construction items screen 500, includes a line-item list of building construction items for the selected loan of interest. An exemplary embodiment of the line-item list includes construction items categorized under column headings, shown on horizontal line 501, and characterized as: item, showing a brief description of the construction item; inspections, showing a number of inspections completed to date regarding each item; weight, shown exemplary as a percentage, and assigned to construction items to signify the percentage that the item encompasses of a constructed building; budgeted, showing the budgeted dollar amount designated for completely constructing the item; change orders, showing any changes made for the items; released, reflecting the dollar amount that has been disbursed to date on the construction loan; and progress, to show construction progress of item, as shown at 502. In one exemplary embodiment, progress may comprise a progress value represented as a loan budget value, or an item budget value. In one non-limiting example, progress 502 may be represented as a percentage.

Items page 500, further includes tab 503, shown exemplary as a gear and accessible to navigate additional loan management tools. It will be understood that tab 503 may be represented by any one or more symbols, features, elements, or characters, and may include a number of loan management functions. In one exemplary embodiment, tab 503 may include an export function to export loan related information, a print option, to print loan information, and a refresh option, to refresh the web page to reload and update with any new information since the last browsing session. Other functional attributes or objects may be associated with tab 503.

With continued reference to FIG. 5, the construction items display screen 500 further includes a loan activity menu, shown at 504, for providing a synopsis of pertinent loan activity, including inspections and draw requests. It will be noted that loan activity menu 504 may be situated anywhere on the webpage and is not confined to a particular layout. Thus, loan activity menu 504 may be positioned on the left, middle or right side of the webpage 500, may be provided in a pop-up or collapsible format, may include drop-down menus, text-entry boxes, or may be accessible via loan task bar 404, as shown in FIG. 4. Further, it will be appreciated that loan activity menu 504 may be included on any of the CLMS webpages and is not restricted to any content-specific webpages.

Loan activity menu 504 permits loan admins to manage certain aspects of construction loans. In one non-limiting embodiment, the activity menu 504 provides the status of loans defined as, active, pending, defaulted, frozen, paid off, or the like. Loan activity menu 504 permits user-authorized parties to make changes, in real time, regarding the status of loans, via a “change status” tab, denoted at 505. Thus, user-authorized individuals may change the status of the loan directly from items page 500, without having to navigate through a series of webpages.

In one exemplary embodiment, loan activity menu 504 further includes a disbursement request block, shown at 506, for identifying the name of the borrower requesting a loan disbursement, the date the disbursement was requested, the amount of funds available, and the amount of funds available to draw. An important feature of disbursement block 506, is the ability to approve or decline draw requests, as evidenced at 507. If a draw request is declined, loan admins may leave reasons in a designated text-entry box as to why the draw request was declined. Loan activity menu 504 further includes an inspection request block, shown at 508, that provides information including, but is not limited to, the date an inspection request was made and scheduled, whether an automatic draw request was initiated, the percentage funded to date on the construction of the building, the percentage of construction progress made, percentage of progress construction funded, and maturity. An inspection cancelation tab is provided to cancel scheduled inspections.

Further along the loan activity menu 504, there is provided additional loan attribute tabs including loan-related information. Selecting each attribute tab provides detailed information relating to the loan of interest. In one exemplary embodiment, the attribute tabs are characterized as: account; terms; balance sheet; property financials; disbursement details, where loan admins can add disbursement methods; construction; bank branch, where loan admins can change bank branch; property details, permit loan admins to change property address; and utilities, where loan admins can edit loan financials, export loan data, refresh calculations, and flag loans. Thus, loan admins may navigate the loan activity menu 504 to view loan information, change the status of a loan, approve or decline draw requests, cancel scheduled inspections, add disbursement methods, change bank branches, edit property addresses, edit loan financials, export loan data, refresh calculations, and flag loans. It will be noted that the loan activity menu 504 may include additional loan information, attributes, features, and functional tabs, related to managing loans, inspections, or draws.

The construction items screen 500 includes a dashboard 509 hosting a number of loan manageable tabs for accessing loan-related information. In one non-limiting embodiment, dashboard 509 includes: an items tab, for viewing detailed information regarding construction items; inspections tab, for viewing detailed information regarding inspections; files tab, for managing and storing loan-related files; people tab, for managing profile and contact information pertaining to individuals affiliated with the loan; and a comments tab, for viewing or generating comments pertaining to a loan. Dashboard 509 may include other loan-manageable tabs, and may comprise a drop-down menu, pop-up box, and can be oriented using any webpage layout.

Loan or bank admins can setup or manage loan-related inspections, inspection requests, or choose to view completed inspection reports including images taken of construction items. Such inspection information is easily accessible by selecting the inspections tab provided on dashboard 509. In accessing the inspection tab, the loan or bank admin interface functionally presents a loan inspection display screen 600, as better illustrated in FIG. 6.

Loan inspection screen 600 includes an up-to-date line-item list of inspections that have been completed by inspectors. An exemplary embodiment of the line-item list includes a list of inspections categorized under columns headings characterized as: inspection, showing the number of inspections completed to date; submitted, showing the date inspection reports were submitted; items, showing a number of construction items inspected; released, showing the amount of funds that were released as a result of the inspection; change, showing a change in construction progress as a result of the completed inspection; construction, showing the percentage of construction completed for the item, and comments, for viewing comments that were generated by inspectors during the inspection process. It will be noted that although change and progress is shown in percentages, other values assignments may be used, such as for example, change and progress based on, loan or construction item budget values.

A beneficial feature of the loan inspection screen 600, is for loan and bank admins to view images of construction items that have been inspected. Each listed inspection, includes a corresponding items tab, illustrated at 601, 602. Each item tab 601, 602 indicates the number of items that have been inspected to date, shown as a number in a box. Thus, a quick visual reference of item tabs 601, 602 shows how many items have been inspected, and the date the inspection report was submitted, for each listed inspection. Loan or bank admins may access any of the items tabs 601, 602, to view thumbnail images of inspected construction items 603, 604, as shown in FIG. 7. In one exemplary embodiment, inspection tab 601 was activated to show thumbnail inspection images corresponding to a floor frame 603 and a subfloor 604, respectively. Each thumbnail image may include information such as a percentage of completion, and date the image was taken. Users may print the images via the print tab 605, if desired.

Loan or bank admins can also enlarge any of the thumbnail images 603, 604 for closer review by simply selecting the desired image. FIG. 8 illustrates an image screen 700 showing an enlarged image or photo 701 of a selected thumbnail image 603. As shown, the enlarged image 701 includes a title heading 702 defining the construction item, a progress value 703 represented as a percentage of construction in the exemplary embodiment, and the date the image was taken 704. A forwarding tab 705, is also provided to allow loan or bank admins to sequentially view additional enlarged images of construction items, if any, without having to navigate back and forth through webpages. Hence, thumbnail images 603, 604, and the enlarged thumbnail image, 701, provide pictorial images throughout various phases of construction. Such information may be useful in accessing stages of completion, whether there are deviations from building plans, provide guidance in planning schedules or timelines, manage draw requests, verify inspection images and reports, and secure equity, just to name a few. It will be understood that other data or information may be included in each image, including, but not limited to, angle of view, address of property, time of day, geographical coordinates, or weather conditions of the day, to name a few. An error message may be displayed on this screen if the system determines that there are differences between the geotagged information uploaded by a user for a particular item and the information expected based on the address or other information and coordinates stored for that item.

The construction loan management services application platform 200, manages and records all transactions affiliated with construction loans. For example, draw requests are predicated upon completion of inspections where the inspections may be initiated by borrowers, or loan or bank admins. The construction loan management services platform 200 allows for manual draw requests where the borrower or loan admin initiates a draw request upon completion of an inspection, or alternatively, the draw request may be setup automatically upon completion of an inspection. Portions of money from each construction loan are released when inspections are completed and draw requests are approved. Thus, loan transactions directed at draws, inspections, and inspection fees are recorded on transaction screen 800, as better illustrated in FIG. 9.

As seen in FIG. 9, exemplary line-item loan transactions are provided under column headings characterized as: transactions, for identifying type of loan transaction; approved, for showing the date the transaction was approved; construction, for showing the percentage of construction completed to date; amount, showing the amount of inspection fess involved, amount of money generated as a result of the inspection, or amount of funds disbursed for the draw; funded, showing percentage of funds disbursed; and, available, for showing the amount of money available to draw 801. Various line-item transactions are shown in one exemplary embodiment as, draw, inspection, and inspection fee, however, it will be understood that other loan related transactions may be included or implemented. In some embodiments, interest and principal payments made against the loan are displayed.

In one exemplary embodiment, loan related transaction tabs are associated with certain line-item transactions for managing transaction information. Transaction tabs 802, 803, 804 may be associated with a particular line-item transaction, shown as a draw transaction. Examples of transaction tabs include a draw ticket tab 802, edit draw item tab 803, and a draw delete tab 804. Selecting the draw ticket tab 802 directs loan or bank admins to a draw ticket screen 900, as better illustrated in FIG. 10. Draw ticket screen 900 provides exemplary information of a draw request that was approved on a particular date. Draw ticket information includes, but is not limited to, a loan identification number 901, one more property lot numbers 902, an enlarged showing of the requested draw amount 903, draw details 904, requested draw amount 905, disbursement information 906, the inspection company or inspector involved 907, person or persons who approved the draw request 908, and any comments regarding the draw request, if any. As seen, draw ticket screen 900 provides detailed information of a draw request, in a format that is easily accessible through the loan or bank admin interface. The loan or bank admin may access the top left side of the screen to save the draw ticket 900 in PDF, print a copy, or forward a copy to interested parties. As seen in FIG. 9, the edit draw item 803 allows loan or bank admins to make changes to a draw request, or delete a draw request using the draw delete tab 804.

Loan admins are typically charged with the tasks of creating borrower/builder and inspector profile information, creating construction items templates, scheduling inspections, managing draw requests, setting-up construction loan financials, managing property information, and managing and creating a host of other information relevant to real estate construction loans. As such, loan task bar 404, provides an add new tab 1000 for creating and managing loan-related information, as illustrated in FIG. 11. Selecting the add new tab 1000 provides an add information screen 1001 and a drop-down task menu 1002 for managing and setting-up various aspects of construction loans. Drop-down menu 1002, provides a series of task-based objects including borrower, builder, loan, inspector, inspection template, branch, loan, and draw administrator. Other task-based objects may be included for meeting user needs in managing construction loans.

For illustrative purposes only, a loan admin may set-up borrower profile information and can do so by selecting the borrower object listed in drop down menu 1002. In selecting the object borrower, a designated borrower name is provided in the text-entry box, and entered into the system by activating the next icon to begin creating a borrower profile. The same steps would be repeated for creating multiple borrower profiles.

A loan administrator interface illustrating the functionality of a create borrower profile screen 1100, is illustrated in FIG. 12. Loan admins are presented with a borrower profile screen 1100 to set-up, create, and manage borrower profile information and to invite borrowers onto the CLMS platform 200. As seen in FIG. 12, borrower profile screen 1100 includes a borrower task menu 1101 to better assist loan administrators in quickly accessing, creating, and managing borrower profile information. Examples of such tasks include, but are not limited to, setting-up borrower or company information, contact phone numbers and addresses, and company administrator information. For added convenience, borrower profile screen 1100 includes a number of designated text-entry boxes 1102 and 1103 for entering borrower related information, contact phone numbers and addresses. Drop-down menus can also be included to further assist loan admins in select areas. Selecting a task identifier from the borrow task menu 1101, directs loan admins to the corresponding section of interest for immediate access and viewing, thus eliminating the need of having to spend time scrolling to locate the section of interest.

Referring again to FIG. 11, loan admins may also create or manage construction loans. To create or setup up loan-related information, loan or bank admins access the add new tab 1000 from loan task bar 404, and select the object identified as “loan,” which is listed in drop down menu 1002. When selecting “loan,” loan admins are presented with an add loan screen 1200, illustrated in FIG. 13. Loan admins enter a loan identification number, and assign a predetermined credit line value associated with the loan. The sum of the credit line was determined in the loan approval process based on a host of supporting documents provided by borrowers/builders.

Upon entering the loan set-up information and initiating the next tab, loan admins are routed to a create construction loan screen 1300, illustrated in FIG. 14. A loan task menu 1301 provides a series of tasks to better assist administrators in accessing, entering, creating, and managing the necessary loan information. In one non-limiting embodiment, such tasks include, a branch task, a loan administrator task, borrower task shown at 1302, borrower disbursement task, line of credit task, title insurance task, draw inspection template task 1303, loan financials task 1304, property task 1305, builder task, and inspection settings task 1306. Again, selecting a task identifier from the loan task menu 1301, directs loan admins to the corresponding section of interest for immediate access and viewing, thus eliminating the need of having to spend time scrolling to locate the section of interest.

With reference made to FIG. 15, the create construction loan screen 1300, also includes various tab operatives, identified as set as active 1312, notify loan administrator 1313, and save draft and close 1314. When finished entering the requisite information in appropriate text-entry boxes, loan admin may activate the completed information, 1312, or save a draft of it and close the application. Notification feature 1313, allows loan admins or banks to notify selective parties about certain information or data that was provided, changed, or removed. For example, selecting the notify loan admin 1313, presents a notification box where loan or banks admins may leave messages in the text-entry box and sending the notification.

Draws are premised on the inspection of building construction items, and the approval of such draws. For example, funds are released to borrowers, typically in set increments, based on completed inspections of construction items. This process reassures banks that the construction item is being built correctly and according to the proper specifications and building codes. Banks manage and value their security interests in the constructed building by disbursing funds in set increments, from a predetermined credit line loan, and by disbursing funds based on the completion of qualified inspections of construction items. Thus, the disbursement and requisite inspection process confirms and reassures the bank's investment in the constructed building, as a mortgagee. Requiring inspections of construction items before satisfying draw requests reassures banks or lenders that the building is constructed according to proper site specifications and building codes without land or structural defects, thereby providing a strong security interest in exchange for the construction loan. Hence, it is important that construction items be well defined, inclusive, and properly managed, a beneficial feature provided by the construction loan management system and method of the present invention.

Loan and bank administrators are charged with the task of creating and managing construction item inspection templates for borrowers and inspectors as well. The construction loan management services platform 200 provides the tools needed to adequately structure and identify loan-related construction items. Loan admins and banks can download, import, or customize construction item inspection templates of interest by initiating a menu task identified as draw inspection template 1303, found on loan task menu 1301, as shown in FIG. 14. A draw inspection template section 1307, as illustrated in FIG. 15, provides a means of downloading item inspection templates from an existing database of previously stored and created inspection templates, as illustrated from drop-down menu 1309. Alternatively, loan admins can drag and drop a template or import items inspection templates. For example, CLMS may provide a drag and drop option for adding item inspection templates, or it may provide a file browser locator for browsing the system to locate stored item inspection templates.

Alternatively, loan admins may create customized item inspection templates, via a create custom tab, as seen on page 1300 in FIG. 15. Information needed to create customized item inspection templates may include assigned name of the construction item, a brief description of the item, amount of funds needed to complete the construction of the item, the current progress of constructing the item, for example, expressed as a percentage, and the amount of funds that have been disbursed to date for the item. The customized inspection template is stored in the system and is accessible via a list of templates, as provided in drop-down menu 1309.

When selecting an item inspection template from drop-down menu 1309, loan admins are presented with an option of updating the selected template or changing the template to another template where the user is redirected to the original draw inspection template 1307. In selecting to update the selected template, loan admins are directed to an update item progress screen 1500, as illustrated in FIG. 16. Update item progress screen 1500 illustrates an exemplary item inspection template for use in constructing a building and includes a list of construction items categorized under column headings characterized as: name, showing the name of the construction item; description, for giving a brief description of the construction item; weight, reflected as a percentage; and a progress value or indicator, shown in the exemplary embodiment as a percent.

Loan admins are charged with subjectively assigning progress values 1501 or indicators to each construction item listed when updating an items template. A progress value or indicator 1501 denotes the amount of progress that has been made in building the construction item. Thus, progress indicators are used to provide a reference in determining the level of completion in building construction items. The progress indicator may be represented in percentages, loan budget values in dollars, funds disbursed or available, or as construction item budgets in dollars. In one non-limiting example, the progress indicator is represented in percentage. At the onset, all items are assigned a progress value of 0%, as construction as not started. However, as construction begins and progresses, loan admins, banks and borrowers will initiate inspections of construction items to satisfy draw requests. Inspectors will go to the construction site and conduct physical inspections and upload the results. At that point, inspectors will determine how much progress was made in constructing the item and also assign a progress value. Therefore, both loan admins and inspectors assign progress values to construction items to show the level of completion in constructing the items.

Loan admins may also create and manage loan financials, designated at 1308, in FIG. 15. Defining, and managing the terms and conditions of each construction loan is an important process and outlines the bank's loan practices in meeting borrower needs. As such, loan financials section 1308 is designed to provide information regarding the finances of construction loans. Such financial information includes, but is not limited to, loan numbers, loan amounts, property lot purchase price, soft costs, available amount of loan for construction, total amount of money drawn to date, construction start date, closed date, maturity date, interest rates, appraised value, appraisal date, loan to value in percent, general ledger account number, inspection fee, included inspections, cost center, development type, and notes. Loan financial information is entered in designated text-entry boxes, shown exemplary at 1310 and 1311.

In selecting the task identified as property 1305 from the loan task menu 1301 of FIG. 14, loan admins are presented with a create property information screen 1600, as illustrated in FIGS. 17, 18, for creating and setting-up information relating to properties. For example, property information directed to subdivisions and addresses can be entered in sections 1601 and 1602, respectively, as shown in FIG. 17. In scrolling along screen 1600, loan admins are presented with more in-depth property information section, shown at 1603, in FIG. 18. The property information section 1603 includes name and lot number of loan, any notes made to inspectors, property type, number of rooms, type of foundation, size of garage, and square footage, just to name a few types of information. Property information screen 1600 provides designated drop-down menus 1605 to better assist loan admins in entering property information. Property information screen 1600 also includes a property task menu 1604, as show in FIG. 18, to quickly and easily direct a loan admin to particular sections of interest without having to spend time scrolling or navigating the webpage. It will be understood that property task menu 1604 may be located or oriented in any portion, position, location, or section of the property information page 1600.

In selecting the inspection setting task 1306 in task menu 1301 of FIG. 14, loan admins are presented with the inspection settings section 1316, as better illustrated in FIG. 19. The inspection settings section 1316 permits loan administrators to create and manage inspectors, inspection schedules, draw settings, and rules for each loan. For example, loan admin may designate or assign inspectors and schedule inspections to occur on request or, alternatively, provide dates on which inspections are to occur. Loan admins can also schedule the frequency at which inspections will occur.

Inspection settings section 1318 includes an added benefit by allowing loan or bank admins to select various settings regarding draws and inspections, and to control viewable access. As illustrated in section 1318, loan admins can select whether or not to require itemized draws, require auto-inspections, require borrower draw approvals, or automatically request draws. For example, the loan admin may desire to require that all draws have amounts provided for specific items, to automatically schedule an inspection if a draw is requested for an amount greater than the amount available to draw, to require that any draw submitted by a builder or contractor also be approved by the borrower, and/or to ask whether the borrower would like to automatically request a draw whenever an inspection occurs. Each request may default to request the full amount available for draw after an inspection is completed. One or more settings can be overridden for an individual inspection. Thus, loan or bank admins can control or manage draw requests, inspections, and draw approvals for each construction loan of interest via the inspection settings section 1318. Again upon creating and selecting all necessary information, users can set the information active 1312, notify a loan administrator 1313 or save a draft and close the section 1314.

The construction loan management system and method, of the present invention, also permits loan admins to create and manage inspector profile information as well. With quick reference to FIG. 11, loan admins may choose the inspector designator from drop-down menu 1002. In doing so, the loan admin is directed to a create inspector screen for creating and managing inspector profile information shown at 1800, in FIG. 20. Such information includes, but is not limited to, name of inspector or company, contact information including phone and address, information regarding market areas, and identification of the inspector administrator. Create inspector screen 1800 also includes an inspector task menu, denoted 1801. Selecting a particular task from the inspector task menu 1801 directs loan admins to the corresponding section made available for immediate access and viewing.

Draw requests are premised on the inspection of construction items and the approval of such draws. For example, funds are released to borrowers, typically in set increments, based on completed inspections of construction items and approval. Hence, it is important that construction items be well defined, inclusive, and properly managed, a beneficial feature provided by the construction loan management system and method of the present invention. A loan admin may choose to create and manage inspection templates and formats regarding construction items. This feature is accessible via drop-down menu 1002, as illustrated in FIG. 11.

When selecting the inspection template task, the loan admin interface functionality presents an inspection template screen 1900, as illustrated in FIG. 21. Loan or bank admins can select, create, and manage inspection information including, but not limited to, branch and template information including name and description of template. Loan admins may select, create, or import inspection item templates, as provided in drop-down menu 1901. In creating new inspection templates, loan admins are directed to the template items section 1902 for setting-up a line-item list of construction items. Each construction item is given a name, provided a brief description, and assigned a project value or indicator.

Loan admins are also charged with the task of assigning a weight or project indicator to each construction item when creating item inspection templates. The weight or project indicator represents a part of a whole, where the part is represented by the construction item and the whole is represented by the totally constructed building, thus, many construction items, parts, form a totally constructed building, the whole. A value is assigned to represent the weight of each construction item. Such values may include percentages, total budget values in dollars, time spent or construction item budget values in dollars. Thus, in one exemplary embodiment, a loan admin may assign a project or weight to a construction item identified as electrical. Electrical forms part of the completely constructed building, and the loan admin may determine that the electrical item comprises 1.5% of the total 100% construction of the building, thus, a weight or project indicator of 1.5% is assigned to the construction item identified as electrical. In yet another example, if an inspection item was created to include a window, then the window would likely represent a small weighted percentage of the building as a whole, as a windows forms one small part of a building. Thus, a weighted percentage of 2% may be attributed to the window. The complete list of inspection items must provide a total percentage weight of 100%. Thus, if 20 items are created, the total percentage weight for the twenty items must total 100%. It will be noted that building specs, drawings, or plans, provided in consideration of a construction loan, may be used to give guidance when determining the weighted percentages of inspection items for a building.

Another beneficial feature of the inspection template screen 1900 is the ability to import an already existing inspection template, provided via a drop-down menu 1901. Upon selecting to import a custom template, the loan admin is presented with an option to import a custom template denoted 2000, as illustrated in FIG. 22. This feature may permit use of previously created inspection templates where slight modifications can be made to address future needs, thus saving time and money in creating a new inspection template each time.

A map task 2101 can be selected from the loan task bar 404 to view mapped properties on a map representing a state, city, town, streets, or subdivision, as illustrated in FIG. 23. In one non-limiting embodiment, map screen 2100 comprises a map showing various construction loan properties situated in and around the Nashville, Tenn. area. To better assist viewers and loan administrators, map page 2100 may include visual property markers or pins to identify or visually depict property locations. Such visual markers can be generated by the conjunctive operation of the verification module 214 and the mapping module 218, each shown in FIG. 2. The verification module 214 determines the latitude and longitude coordinates of property canonical addresses, and the mapping module 214 may assign visual property markers to each property coordinates. Visual markers may comprise any shape, size, color, or symbol.

Conveniently, loan admin interface 203 also allows searching for loans using a host of search filters. In selecting loan search task from loan task bar 404, users are provided with a find loans screen 2200, as illustrated in FIG. 24. Find loans screen 2200 provides a list of construction loans, each represented by a loan number, name of subdivision if any, lot number, property address, branch, name of borrower, and current status of each loan. A first set of search filters permit viewing of all loans 2201, viewing only recent loans 2202, or viewing only pending loans 2203.

Another search filter allows loan admins to search loans by date. For example, a date filter, denoted at 2204 can be used to search construction loans that were last inspected, or loans having a particular closing date, maturity date, construction start date, sale date, or other dates. Loans can also be searched according to a range of dates by entering a start date 2205 and an end date 2206. In one embodiment, the CLMS platform 200 may also include a drop-down menu to provide a calendar to better assist users in selecting dates.

A status filter, designated at 2207 and selectable via a drop-down menu, allows loan admins to search for loans that are active, paid off, frozen, or defaulted. Such search features are merely exemplary and are not deemed exclusive. Other search filters or features may be included, such as loans that are closed, transferred, in review, overdrawn, or in need of review.

A search tab, entitled, “show search”, denoted at 2208 in FIG. 24, can be selected to provide an information template 2209, as illustrated in FIG. 25. Loan admins can locate loans by entering borrower, property, and/or inspector information. Further, a loan can be flagged 2210 to visually indicate important loan-related features, comments, or issues. Setting indicator flags generally directs viewers to pay closer attention to the noted subject matter of the loan. Optionally, users may simply hide the show search feature 2211.

Another added benefit via loan task bar 404, is the ability to view and manage inspection requests. Upon selecting the inspection request tab, which is symbolized as a camera in the exemplary embodiment, loan admin interface functionally provides an inspection request screen 2300, as illustrated in FIG. 26. In one exemplary embodiment, the inspection request screen 2300 includes an line-item list of properties categorized under column headings entitled loan number, subdivision, lot, property address, borrower, branch, available to draw, and next scheduled inspection. Selecting any of the listed loans directs users to the same page layout as provided in FIG. 5 permitting users to view loan-related items, inspections, transactions, files, people, and comments. A drop-down menu 2301 is provided to search loans corresponding to specific borrowers as well. Also, one may view a complete list of requested inspections 2302 or, alternatively, view pending inspections 2303. Either option is available in viewing and managing inspection requests.

Loan admins can also view and manage borrower draw requests. The feature is selected via the draw request tab, symbolized as a dollar sign in one exemplary embodiment, from the loan task bar 404. Upon selection of the draw request tab, the loan admin interface functionally provides a manage draw request screen 2400, as illustrated in FIG. 27. The manage draw request screen 2400 includes an line-item list of draw requests categorized under column headings characterized as loan, subdivision, lot, property address, borrower, amount of funds available to draw, and amount of funds requested. Again, loan admins may select any one loan to view in-depth information including loan-related items, inspections, transactions, files, people, and comments. A drop-down menu 2401 is provided to select particular borrower-related loans. For example, loan admins may wish to view draw requests regarding a particular borrower rather than browsing through the full list of loans. Also, loan admins may wish to review only loans that are available to draw from 2402, draws pending approval 2403, or draws pending transfers 2404. An added benefit includes the ability to narrow a search to construction loans with funds available only, as shown at 2405. Thus, manage draw request screen 2400 provides variant flexibility in viewing, searching, and managing draw requests. In one embodiment, multiple draw requests can be managed simultaneously across multiple loans for a particular buyer.

The construction loan management system and method, of the present invention, maintains historical data regarding construction loans. For example, a history tab is provided to access and review historical data and information for each construction loan and borrower. Such historical data may include loan, inspection, and items history.

A reports tab is also included in loan task bar 404 to access and view loan status categories, shown at 2500 in FIG. 28. The reports screen 2500 provides an overview of loan status categories including for example categories characterized as matured loans, overfunded loans, flagged loans, presold loans, aging loans, and stale loans. These predefined categories are merely exemplary and other categories or sub-categories may be created. Report module 217 may provide historical or current loan data, loan analysis or summary information, loan-oriented statistical data, payment history of loan, and whether loans were transferred or assigned. In one embodiment, the reports screen 2500 also includes pie charts to provide visual illustration of status loans as compared with a complete loan portfolio. Other symbolic parameters may be used such as bar graphs or percentage indicators.

Loan admins may select a loan status category to access loan portfolio summaries, via download tab 2501. Upon initiating the download tab 2501, users are presented with a loan portfolio summary screen 2600, as illustrated in FIG. 29. Summary screen 2600 shows one exemplary format of providing in-depth information regarding loan portfolios. Such information may be presented as an excel spreadsheet (or other spreadsheet) and generally includes an overview of information pertaining to items, inspections, transactions, loan status, and any other information needed to better assist loan administrators in managing construction loans. The information may be exported, saved, or printed.

A files tab, is also provided in dashboard 509, as shown in FIG. 5, and used to upload, or to drag and drop files, related to the selected loan of interest. Loan documents can be uploaded to the system and stored in designated files. Exemplary documents may include closing documents, mortgages, inspection reports and notes, deeds, invoices, discharges, contracts, agreements, bill of sales, disclaimers, regulatory forms, tax forms, HUD settlement statements, title insurance documents, title searches, opinions, certifications, promissory notes, appraisals, builder's risk insurance, or releases, to name a few. Further, loan admins may also designate who has access to files, and can generate loan compliance files automatically.

Accessing the people tab, on dashboard 509, directs loan admins to a people screen that includes a list of individuals or companies affiliated with the loan of interest, along with their profiles and contact information. Examples of affiliated individuals may include, but is not limited to, loan administrators, borrowers, builders, foreman, title insurance companies, and inspectors. Profile information regarding such entities can be added, via designated text-entry boxes.

A comment page 2700, illustrated in FIG. 30, is generated when selecting the comments tab, via dashboard 509. Comments page 2700 allows interested users to access and read messages or comments that were generated by certain parties. Several exemplary comments are shown at 2701 and 2702. As shown, each comment 2701, 2702 indicates a date and time 2703 the comment was sent. Recipients may choose to reply to senders and can do so by accessing the reply tab. Alternatively, loan admins may wish to create and forward comments to particular parties of interest. Such comments may be added by selecting a comment add tab, represented by a plus symbol in one exemplary embodiment, and entering the messages in a designated text-entry box 2704. Senders may also select designated recipients of generated comments including bankers, borrowers, and inspectors, shown at 2705.

Another exemplary embodiment of a user-specific interface includes a borrower interface designed to provide functionality to borrowers in managing various aspects of construction loans. As noted, the term “borrower” means one or more individuals, groups of individuals, associations, or companies, engaged in borrowing money from a lending institution or bank, and it may include one or more, qualified builders, owners, investors, licensed brokers, licensed general contractors, sub-contractors, building developers, consumers, officers, directors, shareholders, real estate agents, land managers, or condominium or apartment complex developers.

To access the construction loan management services platform 200, borrowers initiate a control program (e.g., a browser) on any one of the client devices 112 and insert a uniform resource locator (URL) in the website address bar. Upon entry of the URL, borrowers are routed to a user log-in page, as shown in FIG. 3. Alternatively, borrowers may launch a loan app, stored on any of the client devices 112 or on any one of the servers 116, to access the CLMS platform 200. The user-login page is functionally supported by the authentication/access module 208, of FIG. 2, to provide secured authentication for gaining access to the construction loan management services platform 200. The authentication process protocol is preferably the same as that for loan administrators where authentication includes a two-step authentication log-in process that requires authentication credentials such as a username and password 301, as seen in FIG. 3. Typically, borrower authentication credentials are initially set up by a loan administrator, via the loan administrator interface. The authentication module 208 may also include a support module to better assist borrowers should they forget a username and/or password. Authentication support may comprise querying borrowers to answer one or more challenge questions, select an image, or satisfy a numerical or alphabetical captcha or challenge screen.

Turning now to FIG. 31, there is illustrated a borrower interface illustrating the functionality of a borrower task screen 3000 for managing construction loans, including a plurality of task-based tabs, a borrower task bar 3001, and a collapsible borrower account bar 3002, in accordance with one embodiment of the present invention.

Upon gaining secured access to the construction loan management service platform 200, borrowers are presented with a homepage shown as a borrower task screen 3000. Borrower task screen 3000 includes a list of selectable tasks that are available to borrowers for managing construction loan portfolios. In one exemplary embodiment, a plurality of task-based tabs are identified as “request draws” 3003 for requesting draws from funded construction loans, “request inspections” 3005 for requesting inspections of construction items, “search your loans” 3006 for searching specific construction loans from a loan portfolio, “construction portfolio summary” 3007 for viewing summary information regarding loans, “manage account settings” 3008 for managing loan and personal account information, and “support center” 3009 for assisting borrowers in using user resources. It will be noted that borrower task screen 3000 may include additional task-based tabs, and that current identified task-based tabs may be changed, replaced, added, or deleted to meet the current and future needs of borrowers.

The borrower task screen 3000 also includes a borrower task bar 3001 that includes various tabs for managing construction loans. Such tabs may include, but are not limited to: a home operative, represented by a building symbol, for directing borrowers to the homepage, borrower task screen 3000; an add new tab, represented by a plus symbol, for setting-up and adding information and/or data related to construction loans; a map tab, for viewing property locations on designated maps; search loans tab, represented by a magnifying glass, for searching construction loans; inspection request tab, represented by a camera, for managing inspection requests; draws tab, represented by a dollar sign, for managing draw requests; a history tab; for viewing historical data pertaining to construction loans, inspections, and items history; a construction portfolio summary operative, for viewing loan portfolio summaries; a manage account setting tab, for managing account settings; and a support center tab, for viewing and retrieving various resource information. It will be understood that such tabs provided on the borrower task bar 3001 are merely exemplary and that such tabs maybe changed, replaced, added, or deleted to meet borrower needs.

As with loan task bar 404 of the loan administrator interface, it will be appreciated that the borrower task bar 3001 may also include a variety of different operatives, such as a tool box operative, for providing various tools including calculators such as regular calculators and mortgage calculators, a measurement converter such as for converting inches to feet, coordinate charts, phonebooks, calendars, notepads, or clocks, to name a few. Another exemplary operative that may be included, may be a document operative for storing certain documents relating to the construction phases of a building, for example such documents may include, but are not limited to, illustrations or charts, electrical and plumbing schematics, building plans, including land diagrams, and plan amendments, blueprints, building codes, site specifications, floor plans, materials lists, or surveys. A legal operative may be included to provide one location for storing a variety of legal documents such as mortgages, deeds, discharges, bank notes, promissory notes, bill of sales, disclaimers, agreements, contracts, affidavits, land titles and title certifications, title insurance policies, leases, and other documents.

Borrower task screen 3000 further includes a collapsible borrower account bar, indicated at 3002. Collapsible borrower account bar 3002 provides additional functional attributes for managing loan accounts. Such functional attributes, are represented as “my account”, “my company”, “resources”, and “sign-off”. My accounts allows borrowers to: create, add, and manage various account information including, addresses, contact information such as phone numbers and email addresses; change or update access credentials (e.g. username and password); update authentication support by updating or changing challenge questions; set notification alerts regarding loan, draw, and inspection activity; retrieve report updates; and give notices when files or comments are shared with others. My company allows users to manage company and administrator information, user accounts, and lines of credit. For example, borrowers may create a line of credit by providing credit line information such as terms, interests, and amounts. The resource operative provides access to a number of resources regarding information relating to the loan management system and method, how to use it, videos, and available services or modules. Finally, a sign-off tab can be used to sign off the system when it is no longer in use.

It will appreciated that borrower task bar 3001, of the borrower interface, may be the same or different in comparison to the loan task bar 401, of the loan administrator interface, thus, supporting the proposition that each task bar 404, 3001 is tailored for user-specific needs. Further, both task bars 404, 3001 and collapsible account bars 411, 3002 are provided and accessible for use on most web pages of the loan administrator interface and borrower interface, respectively, without having to navigate back and forth between webpages.

As indicated, borrower task screen 3000 provides a lists of tasks made available to borrowers for managing construction loans. In one non-limiting embodiment, borrowers may wish to manage draw requests pertaining to certain loans, and can initiate the process by accessing the request draws tab 3003, as illustrated in FIG. 31. As shown, request draws tab 3003 includes a numerical indicator, shown at 3004, for indicating the number of draw requests that are currently pending approval. This feature provides borrowers with a quick, viewable reference as to how many draw requests are currently pending approval without having to navigate through webpages to locate the information.

In selecting request draws tab 3003, borrowers are linked to a manage draw request screen 4000, as illustrated in FIG. 32. The manage draw request screen 4000 provides a line-item list of constructive loans that were previously set up by a loan or bank administrator, via the loan administrator interface 203. The construction loans are categorized under column headings, entitled: loan number; subdivision; property, indicating property address; borrower, for identifying the names of borrowers; available, for indicating the amount of funds available to draw on that loan; and requested, showing the amount of funds the borrower has requested. One convenient factor is that borrowers enter the amount of funds requested in designated text-entry boxes, denoted at 4001 and 4002. Thus, borrowers may solicit a requested amount for each loan when making draw requests.

Conveniently, manage draw request screen 4000 also provides various search filters 4003, 4004, to better assist borrowers in overseeing different categories of loans without having to browse through an entire list. In one non-limiting example, one search filter 4003, represented as a drop-down menu, allows borrowers to search construction loans by subdivision, zip code, or state. Alternatively, borrowers may wish to search only loans that have available funds to draw from. Search filter 4004 permits borrowers to search funded loans only. It will be noted that other search filters may be included to assist borrowers in accessing and managing construction loans.

With continued reference to FIG. 32, manage draw request screen 4000 provides an overall presentation regarding current status of loans, as shown at 4005, 4006, and 4007. For example, borrowers are given a visual summary status of loans currently available to draw 4005, how many draw requests are pending approval by borrowers 4006, and how many draw requests are pending approval by loan admins or banks 4007. Status-viewable indicators 4005, 4406, 4007 provide an easy and efficient means for borrowers to oversee status of loans without having to navigate through webpages.

Borrowers may initiate draw requests on loans by selecting one or more construction loans of interest, indicated at 4008 and 4009. Conveniently, borrowers can make single draw requests or, alternatively, borrowers can make simultaneous draw requests in batches, by simply selecting multiple loans at once, if desired. Borrowers can make draw requests on loans, as a whole, but can also make itemized draw requests regarding individual construction items where draw disbursements are driven by draw requests made on selected construction items. The manage draw request screen 4000 includes an operative tab for making an itemize draw request 4011. In selecting the itemized draw request tab 4011, borrowers are presented with an itemized draw request screen 4012, shown in FIG. 32A. Screen 4012 includes an exemplary list of construction items available for itemized draw requests. Each construction item listed, includes a corresponding add tab 4013 and a text-entry box 4014 for entering a requested draw amount.

Banks or lenders may require borrowers to submit invoices in support of making draw requests to evidence the costs associated with construction items. Borrowers can access item-related add tabs 4013 for adding invoices in support of draw requests, shown at 4018, in FIG. 32B. Borrowers may select the “choose a file” designator 4019 to accessibly browse files including construction item invoices for uploading the invoices onto the CLMS platform 200, or they may remove unwanted invoices, via remove tab 4020. Borrowers may upload invoices, on a per-item basis, thus providing a categorized system for managing construction item invoices.

Itemize draw request screen 4012, in FIG. 32A, may include comment and lockbox code tabs for leaving comments to certain designated parties, such as loan administrators, banks, or inspectors, and for providing a lockbox code to parties if needed, such as inspectors. For example, inspectors may need to gain access to a building or property that has been securely locked to prevent unauthorized access. The inspector may need an entry code for accessing the building or property, thus, the entry code may be provided, via the add lockbox code feature of the itemized draw request page 4012.

Upon selecting and submitting draw requests, borrowers are directed to a draw request review and submit screen 5000, as better illustrated in FIG. 33. For illustrative purposes, the review and submit screen 5000 shows a series of three loans, denoted at 5001, 5002, 5003, that were previously selected from draw request screen 4000, of FIG. 32. In the exemplary embodiment, the three loans are each identified by loan number, title, or description of property, and each loan includes a corresponding draw amount requested 5004. After reviewing the draw requests, borrowers may proceed to confirm the request and authorize appropriate debit of accounts, via electronic signature 5005, for one loan or multiple loans. The verification module 214 processes the digital or electronic signature accordingly. Conveniently, upon submitting the review and submit screen 5000, borrowers are presented with a review and submit screen 6000, showing the complete list of loans and corresponding dollar amounts. Borrowers can print a copy for their records, via print tab 6001. It will be noted that a similar draw request review and submit page may be provided for managing itemizing draw requests as well. Further, borrowers receive notifications when draws are transferred.

The construction loan management services platform 200 also invites borrowers, via the borrower interface 204, to view and manage in-depth information for each loan. In referencing FIG. 32, borrowers can select a loan, via accessing the property descriptor, shown for example at 4010, where borrowers are presented with navigation tabs to view detailed information of the selected property. Such detailed information is similar to that presented in FIGS. 5 through 9 of the loan administrator interface. Thus, borrowers can view loan-related items, inspections, transactions, files, people, comments, inspection images or photos, and navigate a loan status activity menu as well.

The construction loan management system is engineered to provide a borrower interface where borrowers can access a borrower task screen and manage draw requests by making single or batch draw requests, or itemized draw requests, review and submit selected draw requests, upload invoices in support of draw requests, and view in-depth information of loans by selecting a loan property descriptor. Being involved in managing construction loan services affords borrowers comfort in knowing that such actions are initiated in an organized, manageable, and timely fashion.

Funds are typically disbursed to borrowers upon completion of item inspections, and the approval process. As construction progresses, borrowers may want to request inspections of construction items in order to release funds from loans. Borrowers can initiate inspections by visiting the borrower task screen 3000 and selecting the request inspections task 3005, shown in FIG. 31. Upon selecting the inspection task 3005, borrowers are presented with a manage inspection request screen 7000, as illustrated in FIG. 35.

Inspection request screen 7000 includes a number of line-item loans listed under column headings characterized by loan number, subdivision, lot number, property address, name of bank, availability of funds to draw, and next scheduled inspection dates. Borrowers can quickly reference scheduled inspection dates, shown at 7001. Such information may be used to make informed planning decisions and gauge loan financials accordingly. Borrowers can make single or batch inspection requests, shown at 7002. In selecting one or more properties, borrowers are functionally presented with an inspection review and submit screen 8000, as illustrated in FIG. 36. The inspection review and submit screen 8000 indicates the properties selected 8001 and allows borrowers to schedule the inspection date by entering the date in a designated text-entry box, shown at 8002. In one embodiment, the borrower interface may provide a drop-down menu, or pop-up window (not shown) to provide a calendar to better assist borrowers in scheduling inspections. It will be noted that in one exemplary embodiment, the CLMS system 100 may permit borrowers to make itemized inspection requests where inspection requests are based on individual construction items. Thus, for example, borrowers may make single or batch inspection requests on individual property loans or on individual construction items listed in each property loan.

The inspection review and submit screen 8000, of the present invention, also includes an automatic draw request selection 8003. This feature is beneficial in that once activated by a borrower, a draw request will automatically be initiated upon the completion of the scheduled inspection, thus, eliminating the need of having to log-in to the CLMS platform to track inspections, and make manual draw requests. Auto draw selection is also recorded in the loan activity menu identified in FIG. 41.

With continued reference to FIG. 36, inspection review and submit screen 8000 also provides the name of the assigned inspector or inspection company corresponding to the line-item property 8001. Advantageously, borrowers may want to leave a comment or message to the assigned inspector and may do so by activating the add tab 8004 located under the comment heading. In selecting add tab 8004, borrowers are presented with an add comment screen 9000, as shown in FIG. 37. Borrowers can leave a message to the assigned inspector by entering the message in the designated text-entry box and confirming the entry. The comment may be displayed, in one embodiment, on the comments screen, FIG. 30.

Review and submit screen 8000 also includes a lockbox feature with an associated add tab, shown at 8005. Initiating add tab 8005 allows borrowers to enter an entry code for inspectors, as shown at 10000 in FIG. 38. Add Lockbox code screen 10000 permits borrowers to provide a security code to inspectors for gaining access to a building or property. For example, a building or property may be safeguarded via a locking mechanism or system. Assigned inspectors will need a key or code to gain access to the premises to conduct scheduled inspections. Thus, borrowers may provide access security codes to inspectors via the add lockbox code screen 10000. Borrowers receive notification when each inspection is completed.

Referencing FIG. 35, borrowers may also review in-depth information pertaining to loans. Borrowers may select the property descriptor to view detailed information of the selected property. Such detailed information is similar to that presented in FIGS. 5 through 9 of the loan administrator interface. Thus, borrowers can view loan-related items, inspections, transactions, files, people, and comments, view loan related inspection images or photos, and navigate a loan status activity menu as well.

Borrowers can also search for particular loans by accessing the “search your loans” tab, shown at 3006, in FIG. 31. In doing so, borrowers are routed to a find loan screen 11000, as illustrated in FIG. 39. Find loan screen 11000 includes a list of loans categorized under column headings characterized as loan number, subdivision, lot, property address, bank, loan administrator, and status. It is mentioned that borrowers can quickly view the status of each loan listed under the column heading status, at 11001. Borrowers may search for loans using a variety of search filters. For example, borrowers may view all loans 11002 or, alternatively, just the most recent loans 11003.

Another search filter includes a date filter 11004 where borrowers can search loans that are activated or last inspected. It will be understood that date filter 11004 is not limited to searching only loans that were last inspected. Other filter parameters may be included, such as loans pending inspections or inspections performed in the last number of set days, such as the last 15 days or 30 days. Alternatively, borrowers may search loans based on a range of dates by entering a start date 11005, and an ending date 11006 in designated text-entry boxes. The CLMS platform 200 may provide one or more drop-down calendar menus to better assist borrowers in selecting date ranges.

The find loan screen 11000 includes additional loan search filters, such as status filter 11007. In one embodiment, status filter 11007 provides a drop-down menu including a list search parameters to select from, including, but not limited to, loans that are, active, paid off, frozen, or defaulted. The list of search results may be exported via tab 11008, illustrated in the exemplary embodiment as a gear. It will be noted that the CLMS platform may allow the exportation of search results in XML, JSON format, and may be designed to allow exporting information in a variety of different formats.

As illustrated in FIG. 39, another search protocol includes show search 11009. Selecting the show search tab 11009, borrowers are presented with a loan search screen 12000, as better illustrated in FIG. 40. Loan search screen 12000 includes an information template 12001 for inserting bank, property, and loan information, which is entered via text-entry boxes or, alternatively, can be selected from various drop-down menus. Further, borrowers may assign a flag indicator 12002 to signify important matters, comments, or issues regarding loans. When searching for loans using the information template 12001, the results list is distinctly viewable at 12005. Optionally, users may choose to hide the show search feature when not in use, shown at 12003.

In-depth review of loan-related information is initiated by selecting a particular construction loan of interest, shown in FIGS. 32, 35, and 39, and also at 12006 in FIG. 40. Accessing loan-related designators, such as for example, accessing the property descriptor in FIG. 32, the borrower interface presents a construction items screen 13000 corresponding to the selected loan, as better illustrated in FIG. 41.

In one exemplary embodiment, construction items screen 13000 includes a line-item list of building construction items for a pending loan of interest. An exemplary embodiment of the line-item list includes construction items categorized under column headings, noted at 13001, and characterized as: item, showing a brief description of the construction item; inspections, showing a number of inspections completed to date regarding each item; weight, shown exemplary as a percentage and assigned to construction items to signify the percentage that the item encompasses of a constructed building; budgeted, showing the budgeted dollar amount designated for completely constructing the item; change orders, showing any changes made for the items; released, reflecting the dollar amount that has been disbursed to date on the construction loan; and progress values, to show construction progress of items, shown at 13002, 13003. In one exemplary embodiment, progress values may comprise a progress value represented as a loan budget value or an item budget value. In one non-limiting example, progress value may be represented as a percentage. As shown in FIG. 41, progress value 13002 represents a percentage, based on a completed percentage of 100%, of completing the construction item for the building. For example, if the roof framing, as shown at 13002, was only 50% complete, then a progress value of 50% is assigned. In yet another example, if construction on the outside windows and doors of the building has not begun, then a progress value of 0% will be assigned, as shown at 13003 to illustrate that no progress has been made to date.

The construction items screen 13000 includes a line-item list of building construction items for a pending loan of interest. In circumstances where such construction items have been inspected, the number of items inspected are correspondingly indicated near each item, as shown at 13010, 13011. In one exemplary embodiment, the number of items inspected are enclosed in designated box areas. Thus, the box designated 13010 shows one item has been inspected, and the box designated 13011, shows that two items have been inspected. Borrowers may select any of the designated boxes, 13010, 13011, to view thumbnail images of such inspections, as better illustrated in FIG. 43.

Construction items screen 13000 further includes a task tab 13004, shown exemplary as a gear and accessible to navigate additional loan management tools. It will be understood that tab 13004 may be represented by any one or more symbols, features, elements, or characters, and it may include a number of loan management functions. In one exemplary embodiment, tab 13004 may include an export function to export loan related information, a print option, to print loan information, and a refresh option, to refresh the web page to reload and update with any new information since the last browsing session.

With continued reference to FIG. 41, the construction items display screen 13000 further includes a loan activity menu, shown at 13005, for providing a synopsis of pertinent loan activity, including inspection and draw requests. It will be noted that loan activity menu 13005 may be situated anywhere on the webpage and is not confined to a particular layout. Thus, the loan activity menu may be positioned on the left, middle, or right side of the webpage, may be provided in a pop-up or collapsible format, may include drop-down menus, text-entry boxes, or may be accessible via borrower task bar 3001, as shown in FIG. 31.

Loan activity menu 13005 permits borrowers to quickly view and manage certain aspects of construction loans. In one non-limiting embodiment, borrowers may request draws via a request draw tab. Further, loan activity menu provides borrowers with status of loans, defined as active, pending, defaulted, frozen, paid off, or the like. Loan activity menu 13005 indicates the status of loans, via 13006. Loan activity menu 13005 further includes an inspection request block, shown at 13007. The inspection request block provides information including, but not limited to, the date an inspection request was made and scheduled, whether an automatic draw request was initiated, the percentage funded to date on the construction of the building, the percentage of construction progress made, the percentage of progress construction funded, and the maturity date. Borrowers may view scheduled inspections, via scheduled inspections block 13008. The scheduled inspection block 13008 indicates whether auto-draws or itemized draws have been automatically activated.

Further along activity menu 13007, there is also provided additional loan attribute tabs, each selectively expandable, for showing loan-related information such as, account and loan terms, balance sheet, property financials, disbursement details, construction details, bank branch, property details, and utilities. Thus, borrowers can navigate loan activity menu 13005 to view status of loan, inspection requests, scheduled inspections, whether draws are set automatically, and other loan information.

It is noted that the loan activity menus 504 and 13005 include different user-specific functional attributes. For example, the loan admin interface 203 functions to provide a loan activity menu 504 that includes the ability for loan admins to request draws, change loan status, approve or deny draw requests, cancel and modify inspections, add disbursement methods, change bank branches, edit property addresses, edit financials, export loan data, refresh calculations, and flag loans. The borrower interface 204 functions to provide a loan activity menu 13005 that allows borrowers to request draws, select auto-draw parameters, and provide a lockbox code to inspectors. Loan admins are charged with setting up and managing construction loans and, thus, are provided with more tools. Each user-specific interface is tailored accordingly to meet user-specific needs and may be changed, added, deleted, or suspended.

The borrower interface 204 functions to provide a construction items screen 13000 that includes a dashboard 13012 for hosting a number of loan manageable tabs. In one non-limiting embodiment, dashboard 13012 includes: an items tab, for viewing detailed information regarding construction items; inspections tab, for viewing detailed information regarding inspections; files tab, for managing and storing loan-related files; people tab, for managing profile and contact information pertaining to individuals associated with a loan; and a comments tab, for viewing or generating comments pertaining to a loan. Dashboard 13012 may include other loan-manageable tabs, and may comprise a drop-down menu and pop-up box, and it can be oriented using any webpage layout.

Borrower interface 204 allows borrowers to view completed inspections including images taken of construction items during the inspection process. Such inspection information is easily accessible by selecting the inspections tab, via dashboard 13012. In accessing the inspection tab, borrowers are functionally presented with a borrower inspection display screen 14000 including the loan activity menu 13005, as better illustrated in FIG. 42.

Borrower inspection screen 14000 includes an up-to-date line-item list of inspections that have been completed by inspectors. The list of inspections corresponds to the selected loan of interest which is identified by loan ID number, at 14001. An exemplary embodiment of the line-item list includes a list of inspections categorized under column headings characterized as: inspection, showing the number of inspections completed to date; submitted, showing the date inspection reports were submitted; items, showing a number of construction items inspected; released, showing the amount of funds that were released as a result of the inspection; change, showing a change in construction as a result of the completed inspection; construction, showing the percentage of construction completed for the item; and comments, for viewing comments that were generated by inspectors during the inspection process. It will be noted that although change and progress is shown in percentages, other values assignments may be used, such as for example, change and progress based on loan or construction item budget values.

Inspection screen 14000 allows borrowers to selectively view images of construction items that have been inspected. Such inspection images can be used to determine stages of completion, whether there are possible deviations from building plans, provide guidance in structuring timelines, and manage draw requests. Each listed inspection includes a corresponding items tab, illustrated at 14002. Each item tab 14002 includes a number that represents the total number of items that have been inspected to date, illustrated, in one exemplary embodiment, as a number three. Thus, a quick visual reference of item tab 14002 shows how many items have been inspected to date. Borrowers may access any of the items tabs 14002, to view thumbnail images of inspected construction items, as shown in FIG. 43. In one exemplary embodiment, inspection tab 14002 is accessed to show thumbnail inspection images corresponding to a clear lot and rough grade 14003, footing 14004, and foundation walls and piers 14005, as better illustrated in FIG. 43. Each thumbnail image may include information such as a percentage of completion, or date and time the image was taken. In one embodiment, the inspection items screen can display an error if there are differences between the geotagged information uploaded by a user for a particular item and the information expected based on the address or other information and coordinates stored for that item. Users may print the images, via a print tab, if desired.

Borrowers may enlarge any of the thumbnail images 14003, 14004, 14005 for closer review by simply selecting the desired image. FIG. 44 illustrates an image screen 15000 showing an enlarged image or photo of a selected thumbnail image 14003. As shown, the enlarged image includes a title heading 15001 defining the construction item, a progress value represented as a percentage of construction in the exemplary embodiment 15002, and the date the image was taken, shown at 15003. A forwarding tab, shown at 15004, is also provided to allow borrowers to sequentially view additional enlarged images of construction items, if any, without having to navigate back and forth through webpages. It will be understood that other data or information may be included in each image, including, but not limited to, angle of view, address of property, time of day, geographical coordinates, or weather conditions of the day, to name a few.

Borrowers may navigate dashboard 13012, to access the file tab, as shown in FIG. 41. The file tab is used to upload files or to drag and drop files pertaining to loans. Thus, files including a number of documents can be uploaded to the system and stored for the designated loan. Such documents may include, but are not limited to, closing documents, mortgages, inspection notes, deeds, discharges, contracts, agreements, bill of sales, disclaimers, regulatory forms, tax forms, HUD settlement statements, title insurance documents and title searches and certifications, or promissory notes, to name a few.

Navigating dashboard 13012 to access the people tab routes borrowers to a people screen 16000, as better illustrated in FIG. 45. In one non-limiting example, screen 16000 includes profile and contact information directed to loan-affiliated people including administrator 16001, borrower 16002, builder 16003, foreman 16004, title insurance company 16005, and inspector 16006. Profile information regarding such entities may also be added, via text-entry boxes. For example, borrowers can add information pertaining to builders in text-entry box 16007 or to a foreman in text-entry box 16008. It will be understood that other loan-affiliated parties and text-entry boxes may be included to assist borrowers in managing loans. In one embodiment, the inspector interface and administrator interface access the same navigating dashboard 13012.

Accessing the comment tab, via dashboard 13012, presents borrowers with a comment screen similar to comment screen 2700, illustrated in FIG. 30. The comment page can be accessed to submit messages, via a designated text-entry box, and to notify various recipients. Borrowers may also read comments that were sent to them and to reply to such comments.

Turning again to FIG. 31, borrowers may select the task, “construction portfolio summary” 3007 to review information pertaining to construction loan portfolios shown in the portfolio summary screen 17000. The portfolio summary screen 17000 provides a comprehensive list of construction loans, as better illustrated in FIG. 46, where each loan is identified and characterized under a column heading 17001 as: bank; loan number; subdivision; property address; borrower; loan amount; funded amount; balance remaining; available; construction progress; property type; presold; maturity date; days; and status. Loan search filters allow borrowers to search particular construction loans without having to browse the entire list. For example, borrowers may search loans that were issued from a particular bank 17002, to a certain geographical area 17003, such as particular subdivision, zip code or state, and loans that have acquired certain status 17004, such as loans that are active, paid off, or frozen. Resulting loan information may be exported, via tab 11008.

Borrowers manage particular aspects of their accounts, via task-based manage account settings 3008 on the borrower task screen 3000, as illustrated in FIG. 31. When selecting manage account settings 3008, borrowers are presented with an accounts settings screen 18000, as shown in FIG. 47. Here, borrowers manage their account settings, such as by changing authentication credentials username 18001, changing a password 18002, editing challenge questions 18003, and activating various notifications 18004. Borrowers may wish to be kept up to date and receive notifications regarding loan, draw, and inspection activity, updates for periodic reports, and alerts when files and comments are being shared.

Support center task 3009, shown in FIG. 31, provides a host of resources designed to assist borrowers in using and navigating the construction loan management system of the present invention. Support resources may include, but are not limited to, an informative list of facts and questions, videos, audio files, articles, recordings, publications, letters, illustrations, books, system navigation assistance materials, lending support services, loan management support services, banking and construction information, defined industry terms, tips on making draw requests, suggestions, pamphlets, brochures, or any other support materials deemed necessary for better assisting users.

The construction loan management system, of the present invention, also supports the coordinated efforts of inspectors throughout the loan services process. Lenders rely on the expertise and experience of inspectors to assure that the construction of building projects are in compliance with building codes. Property inspections are generally defined and managed by loan or bank admins when creating and setting-up construction property loans, and also by borrowers when initiating inspection requests, as better summarized in FIG. 48. Users, such as loan admins or borrowers, use a browser 19000 supported client device 112, to navigate the internet and access the construction loan management platform 200. Upon satisfying log-in authentication protocols, users are routed to respective interface webpages 19001, as shown in FIG. 48. For example, loan admin interface 203 functions to present loan admins with homepage 400 in FIG. 4, and borrower interface 204 functions to present borrowers with borrower task page 3000, as shown in FIG. 31.

Loan admins are initially charged with the task of creating and setting-up inspection related information for each construction loan, via inspection management module 211. Loan admins create and set up, user profile information by identifying borrowers and their contact information, set up loan financials, and create inspection item templates to identify and characterize construction items used in the constructing building projects. Such construction items are initially defined, via the create inspection template process 19002, shown also in FIG. 21. Loan admins identify and outline construction items by determining the name of the item, giving a brief description of the item, and assigning a weighted value to each item where the weighted value may be defined, in one example, as a percentage of the complete 100% construction of the building. Upon completion, the created item inspection templates are stored in the CLMS system 100 for future use.

Funds disbursed to satisfy draws are predicated on completed inspections of identified construction items, and the approval process. Thus, draw inspection templates are also generated to identify construction items in determining the allocation of loan disbursements, shown at 19003. Such draw inspection templates generally comprise the same templates as the create construction item templates that were generated and previously store by loan administrators, however, loan admins may create customized draw inspection templates, as shown in FIG. 15. As exemplary draw inspection template includes a line-item list of identified construction items where each construction item is assigned a funding amount, a progress value, and a disbursement amount. Thus, so as not to confuse the two separate templates, a create inspection template provides a list of identified construction items, including weighted values showing item construction based on the total construction of the building, and the draw inspection template provides the same or different list of identified construction items including building progress values showing the progress in constructing the items. Although the two templates may comprises identical construction items, each template may include different assigned values. For example, the create inspection template assigns weighted values to each construction item where the value may be defined, in one example, as a percentage of the overall construction of the building. The draw inspection template assigns progress values to each construction item where the progress value may be defined, in one example, also as a percentage of construction of the item to date. As noted earlier, in one exemplary embodiment, values may be reflected in percentages, dollar amounts, funds disbursed, or budget values.

With continued reference to FIG. 48, loan admins also create inspector profiles, including name and address of inspection companies, assign inspectors to various loans, and manage and create inspection settings and requests 19004, also shown in FIGS. 11, 19, 20, and 26. Further, loan admins set-up inspection schedules that outline property addresses, construction items to inspect, and the dates on which the inspections are to occur.

Inspection information and data is not only created by loan admins but can also be generated by borrowers. As reflected by the inspection management module 211, borrowers, via borrower interface 204, can manage loan or item-related inspection requests 19005, also shown in FIG. 35. Because draw disbursements are predicated on completed inspections, borrowers may initiate inspection requests for select loans, and provide requested inspection dates, via text-entry box 8002, as shown in FIG. 36. Thus, as shown in FIG. 48, loan administrators may generate and manage inspector profiles, inspection templates, and inspection requests, and borrowers may manage inspection requests in conjunction with draw requests.

Once inspection information is completed and entered into the CLMS system, loan and bank admins and borrowers are free to make inspection requests, via their respective interfaces 203 and 204. Loan admins notify assigned inspectors, via email, of scheduled inspections to initiate the inspection process. The created inspection information including inspector profiles, construction item templates, and inspection requests are accessible by inspectors.

A governing aspect of the construction loan management system 100 includes a field inspector interface 205 defined as a mobile inspection application that is used by inspectors in the field for managing inspections and inspection reports while on-site at property locations. In one exemplary embodiment, the field inspector interface app may comprise a native app defined as one or more application programs that have been specifically developed for use with the loan management platform 200. As a native app, the field inspection app interacts with various operating system features and other software that is generally installed on the CLMS platform 200, and allows users to take advantage of various features that mobile devices offer, such as a built-in camera and built-in global positioning satellite (GPS) receiver. The field inspection app may be loaded and stored directly on a mobile device, such as a smartphone or tablet, or, alternatively, it can be downloaded from the CLMS 100 and installed on the mobile device. Hence, the native app essentially lives on the smartphone and includes a host of operative icons or tabs situated on the device's home screen. Information or data can be stored on the mobile device (i.e. smartphone) or accessibly stored remotely on the loan management system host computer 114, servers 116, or database 131. In one exemplary embodiment, the native app may be written in native code such as C, C++, Go/Rust or the like.

Alternatively, a field inspector app may comprise a web application (or mobile website) that includes one or more application programs stored on a computer system 114, a remote server 116, or database 131, as shown in FIG. 1. The web app is accessible over the internet, via network 118, by a smartphone or tablet. The web app may be developed using a host of web technologies such as HTML5, Sencha, jQuery, and others, where the underlying technologies are JavaScript, HTML, and CSS. Hence, a mobile web app combines the versatility of the web with the functionality of touch-enabled devices. The web app can be installed on a mobile device by accessing the CLMS system 100 home screen, via a uniform resource locator (URL), and creating a designated bookmark.

Responsive web design can be used in creation of the field inspection application of the present invention. Viewing the layout of a webpage on a desktop computer is often different than viewing the same layout on a mobile device. Responsive web design technologies automatically adapt to accommodate users when viewing webpages on smartphones or tablets, thus eliminating the need for resizing, panning and scrolling by users. One area of interest for using responsive web design may be directed to viewing maps, routes, and directions which are often image heavy. Auto-adjustment is an essential tool supported in responsive web design allowing users to zoom or re-size the screen so as to view maps or routes closer and with more clarity.

In one alternative embodiment, the field inspection app may comprise a mobile cloud app or a hybrid application. Hence, the construction loan management system 100 includes a field inspection application that can be designed as a native app, a web app (HTML app), a mobile cloud app, or as a hybrid application. The mobile field inspection app may be written in java, for an android system, objective C, or swift, for an iOS system. The field inspection app can be developed, for example, as a native application for android phones or tablets, a native application for iPhone or Ipads, a Windows phone application, a mobile web site application, or a native blackberry application.

Referring now to FIG. 49, there is shown a client device comprising a smartphone 19000 having access to, or loaded with, a field inspector interface functionally illustrating a construction loan management user log-in page 19001, in accordance with one embodiment of the present invention. Smartphone 19000 includes a variety of built-in features including a camera 19002 and internal GPS (global positioning satellite) receiver 19003, and it may comprise an android, iPhone, or blackberry device. Alternatively, smartphone 19000 may be replaced by a tablet or PDA including a built-camera and GPS receiver, if preferred. As noted, the field inspection app may comprise a native app or, alternatively, a web app where inspectors may operate a control program (e.g. a browser) and insert a uniform resource locator (URL) that directs the inspector onto the CLMS application platform 200 where users can simply bookmark the page.

Loan admins created user profiles, construction item templates, and related loan information during the construction loan set-up process. Subsequently, loan, admins bank admins, and borrowers are situated to initiate inspection requests at any time. When loan admins make inspection requests, or are notified that borrowers have made inspection requests, the loan admins notify inspectors of scheduled inspections. Loan admins may notify inspectors via email, telephone, or through the field inspector interface.

Inspectors receive notification of scheduled inspections from loan admins and, when ready, launch the field inspection app, where inspectors are presented with a user log-in page 19001. The user log-in page 19001 is functionally supported by authentication access module 208 to provide secure access to the CLMS platform 200. In one non-limiting example, the authentication protocol includes a password authentication log-in process that requires username and password credentials, shown at 19004. As provided in FIG. 3, the field inspection app may also include access support to inspectors should they forget their authentication credentials. For example, access support may include, but is not limited to, directing inspectors to answer one or more challenge questions, selecting one or more proper images, providing numerical or alphabetical information in a captcha text-entry box, or providing a gesture or encrypted code.

Authenticated access directs inspectors to a schedule inspection screen 20000, as illustrated in FIG. 50. Schedule inspection screen 20000 shows an exemplary list of scheduled inspections, denoted 20001, 20002, where each scheduled inspection is identified by lot number, a property location address, and an inspection date 20003.

Inspection requests are initiated anytime by loan admins, banks, and borrowers. The schedule inspection screen 20000, includes a refresh tab 20004 for refreshing the inspection schedule in the event any newly scheduled inspections have been entered into the system. Inspectors are encouraged to utilize the refresh tab 20004 to access scheduled inspections in real-time. In one embodiment, the inspection screen 20000 refreshens automatically at regular time intervals. Further, a menu tab 20005 is also provided, at the top left-hand side of the page 20000, to direct inspectors to an inspector task menu 30000, as better illustrated in FIG. 51.

Inspector task menu 30000 includes task-based tabs designed to assist inspectors in managing field inspections, taking images of construction items, and generating inspection reports. In one non-limiting example, task-based tabs include, but are not limited to, attributes characterized as: today's schedule, for providing a list of scheduled inspections; my calendar, for viewing scheduled inspections on particular day, month, and/or year; upload, for uploading inspection reports including images; map, for visually mapping property addresses on geographic maps and retrieving driving instructions; submit an error, which allows inspectors to notify loan admins, banks, or borrowers regarding inspection errors; comments, for creating and forwarding comments to certain parties; and logout, for logging out of the CLMS system 100. It will be noted that the inspector menu 30000 is not limited to a set number of tasks and may include additional tasks and associated tabs to provide additional support, resources, or management tools for inspectors. Representative examples of additional resources may include: a form tab, for accessing inspection forms; a tools tab, for using certain tools such as calculators or measurement converters; a code tab, for accessing local building codes or specifications, plots, surveys, or plans; a document tab, for accessing certain documents; a checklist tab, for reviewing property inspection related checklists to assist inspectors while on-site; a files tab, for saving inspection reports in loan-related files or any other inspection management tool.

When accessing the, “my calendar” tab, on inspector menu 3000, inspectors are presented with a calendar screen 31000, as better illustrated in FIG. 52. In one exemplary embodiment, calendar screen 31000 illustrates a scheduled property inspection dated Apr. 19, 2016. A calendar selector 31001 is provided to assist inspectors in selecting dates and seeing if there are any scheduled inspections on the selected date. Thus, inspectors can utilize the scroll calendar selector 31001 to determine and view scheduled inspections listed, if any. This option coordinates advanced scheduling and permits inspectors to plan ahead.

There may be times when inspectors are not able to accommodate previously scheduled inspections and need to reschedule. In such cases, the mobile inspection app allows inspectors to reschedule inspections by selecting the reschedule tab 32000, shown in FIG. 53. Initiating the reschedule tab 32000 prompts inspectors with a rescheduling screen 33000, shown in FIG. 54. Inspectors may reschedule the previously assigned inspection by selecting a new scheduling date. An edit tab 33001 is used to remove the previously scheduled inspection date, and a new date is entered, via a date selector 33002. As shown, date selector 33002 includes scrolling dates, presented in month, day, and year, to better assists inspectors in selecting a new inspection dates. When finished selecting a new date, the inspector simply selects the done operator 33001, and the newly selected date is entered into the designated text-entry box. Inspectors save the entry, via save operator, and are subsequently presented with a confirmation 34001, as shown in FIG. 55. It will be understood that notice of rescheduled dates may be forwarded to parties of interest such as to the loan admin, bank, or borrower who made the inspection request.

Loan administrators initially set up and create loan information regarding property information that includes property addresses. The field inspection app includes a mapping tool for mapping locations of such properties on a geographic map. In one embodiment, mapping locations of properties are determined using latitude/longitude coordinates. Alternatively, mapping property addresses may be done using location approximation methods based on property addresses, zip codes, street names, or other property information. The mobile inspection app may utilize or have access to, private or public software mapping programs or services for mapping location of properties, such as Apple Maps, Google Maps™ or Google Maps for Mobile.

Inspectors may visually reference geographic maps to see locations of scheduled properties. In selecting the map tab, on the inspector task menu 30000, inspectors are presented with a geographic map screen 35000, as shown in FIG. 56. Geographic map screen 35000 includes visual property markers 35001, 35002, 35003, each representing a latitude/longitude coordinate of a scheduled inspection property. Alternatively, a location approximation method is used to map scheduled inspection properties using, for example, property addresses or streets, as shown in map screen 36000 in FIG. 57. Map screen 36000 illustrates an enlarged view of a geographic map identifying various streets and provides a pin marker 36001 corresponding to an approximate location of a scheduled inspection property. As illustrated in FIG. 58, inspectors can select any property marker 35001, 35002, 35003, mapped in FIG. 56, or property marker 36001, mapped in FIG. 57, and either retrieve driving directions 37001 or open scheduled inspection details associated with each mapped property 37002.

In one embodiment, the field inspection application may host or have access to route scheduling or optimization software for generating optimized inspection routing plans. In one non-limiting example, the routing optimization software may comprise a web-based GPS tracking application for scheduling inspection routes and for reorganizing routing plans in real-time in consideration of newly scheduled inspections. Thus, dynamic route scheduling software can be used to better assist inspectors to organize, prioritize, and manage inspection routes based on various attributes, including, but not limited to, subdivisions, addresses, towns, type of buildings, distance between properties, or any other determining factors.

Inspectors may view in-depth information pertaining to selected inspections, as better illustrated in FIG. 59. Inspection items screen 38000 shows an exemplary list of inspection items identified as first floor framing 38001 and second floor framing 38002. As noted, loan admins are charged with the task of assigning a project value or weighted value when creating item inspection templates. In one non-limiting embodiment, the project value 38003 is represented in percent. Thus, for example, when creating an item inspection template, loan administrators use their subjective judgment when assigning each line-item a certain project percentage. In the exemplary embodiment, a loan admin predetermined that the line-item, identified as first floor framing 38001, should be assigned a project percentage of 2.63. Thus, the loan admin determined that the first floor framing comprises 2.63% of the total 100% construction of the building. The project value may be based on a percentage, budgeted value, loan value, time projected to completion or amount of funds disbursed.

As shown in FIG. 59, each inspection item is also assigned a progress value 38004. Loan admins and/or banks also use their subjective judgment when assigning progress values to construction items. The progress value is used to provide some method of reference in determining the level of completion for each constructing item. In one example, progress value 38004 is represented in percent. Initially, all construction items are assigned a progress value of 0%. The progress values will increase as construction begins and continues. Progress values may be represented in percentages, amounts, budget values, weights, time projected to completion, funds disbursed or available, or other loan-related attributes.

There may be situations where inspectors come across errors that were unintentionally made such as errors in scheduling, in defining construction items, or errors that are simply attributed to construction methods, materials, or supplies, for example. The field inspection app allows inspectors to submit comments pertaining to such errors. Inspector task menu 30000 provides a submit error tab selected to access an inspector submit error screen 39000, shown in FIG. 60. Inspectors can create and submit messages regarding errors to interested parties such as, for example, to loan admins, bank admins, or borrowers. It will be noted that in one embodiment, the submit error screen 39000 may include selectable indicators such as colored flags or priority insignias, which may be attached to the message to alert designated recipients to the message and level of importance.

Inspectors may also leave messages or comments pertaining to the inspection process or other related information by accessing the comments tab, accessible in the inspector task menu 30000, shown in FIG. 51. Inspectors may wish to make suggestions or leave comments regarding certain issues pertaining to the inspection process, including for example, issues relating to the inspection property, construction items, materials, supplies, physical structures, cleanliness of site, or safety hazards found on-site, to name a few. In accessing the comment tab, inspectors are prompted with a comment screen 40000, as shown in FIG. 61, where they can generate comments. Inspectors can also view any responses made to previously submitted comments. Such responses can be viewed by selecting the response indicator 40001, where inspectors are prompted with a discussion page 41000, as seen in FIG. 62. Further, inspectors may also reply 41001 to such responses, if desired.

When browsing the scheduled list of inspections 20000 in FIG. 50, inspectors can easily view more in-depth information pertaining to each scheduled inspection by simply selecting the scheduled inspection of interest, where inspectors are presented with a corresponding inspection items screen 42000, as better illustrated in FIG. 63. Inspection items screen 42000 provides an itemized list of construction items to inspect. As shown, progress values 42001, 42002 are included to show the construction progress of each construction item to date. In the exemplary embodiment, progress values 42001 and 42002 are represented as percentages and show progress values of 5% assigned to bedrooms and living and 20% assigned to the construction item identified as electrical. Thus, to date, the bedrooms and living room is only 5% constructed and the electrical is only 20% completed. Progress values are based on a construction reference of 100% to reflect fully constructed items. Progress indicators or markers 42003 are included to provide visual reference of progress to correspond with the progress values of each construction item. Thus, progress markers 42003 correspond to changes in progress values 42002.

With continued reference to FIG. 63, there is also shown an information tab 42004 for accessing and reviewing further details regarding an inspection property of interest. Initiating the information tab 42004 provides a property details overview screen 43000, better illustrated in FIG. 64. The property details overview screen 43000 includes property information such as, but not limited to, property address, lot identification, borrower name, and property details such as footage, number of rooms, and contact information. The property details overview screen 43000 also includes information identified as lockbox key 43001. There may be instances where inspectors need an entry code for accessing buildings or properties that are safeguarded by a locked entry. Inspectors can easily access the details overview screen 43000 to acquire the entry code to gain access to the locked entry.

When inspectors are finished inspecting scheduled construction items, they are charged with the task of assigning progress values to each inspected item. Assigning progress values is a subjective task that is based on the inspector's experience, training, and knowledge. Such progress values assist loan admins and borrowers in managing draw requests, and assists inspectors in managing scheduled inspections. Inspection items screen 44000, in FIG. 65, illustrates several construction items that are scheduled for inspection. Each construction item listed includes a corresponding progress tab. For example, one construction item identified as electrical 44001 includes a corresponding progress tab 44002. To better illustrate the assignment of progress values, once an electrician has completed working on the electrical item 44001, an inspector will inspect the job and assign a progress value for the work that was completed on the electrical item on that day. To assign a progress value, inspectors initiate the progress tab 44002 and are presented with a progress indicator 44003. In one exemplary embodiment, progress indicator 44003 includes a digital scrolling of percentages ranging from 0 to 100, in predetermined increments. Inspectors use the progress indicator 44003 to select a progress percentage from the list of percentages and assign the progress value to the corresponding construction item, via the done tab. In one example, a progress percent of 20% is selected from progress indicator 44003, and assigned to the construction item, identified as electrical 44001. The assigned progress value also results in the progress marker 44004 showing a corresponding increase. It will be noted that once inspectors assign a progress value to each construction item inspected, the progress value remains definite. Thus, only the bank admin can reset inspection progresses made by inspectors. Inspectors may access the submit error tab or comment tab, via inspector task menu 30000, to indicate that an error was made in assigning progress values. Further, it will be understood that assigned progress values are not reflected in the CLMS system until inspectors upload the completed inspection report to the CLMS platform 200. It will be understood that progress markers 44004 may comprise same or different colors, and may be represented by a pie chart, bar graph, hour glass, or other symbolic image to show progression. In one non-limiting example, the progress markers may change color when situated above or at a predetermined percentage. For example, progress markers may be green in color when below 100%, and turn red when at 100% to indicate that the item has been completed finished or inspected.

Turning now to FIG. 66, there is shown an exemplary embodiment of an inspection items screen 45000 showing an items banner 45001, a camera tab 45004, and a review inspection tab 45005. When construction items have been fully constructed and completely inspected, the completed items are relocated at the bottom of the inspection list under an items banner 45001, entitled, “completed items”. Thus, inspectors can scroll down the scheduled list of items, and quickly determine what construction items have been completed to date. It is noted that a 100% progress value 45002, and corresponding visual indicator 45003 are shown for completed items.

An important feature of the field inspector interface 205, is to correlate images or videos of construction items while conducting inspections on-site at property locations. The field inspection app takes advantage of various features provided in the smartphone 19000 including a built-in camera 19002 for taking digital photos. Thus, the smartphone 19000 is not only used for navigating the construction loan maanagement platform, but also comprises a portable, compact device, that can be easily stored in a pocket while traveling, and it provides an efficient means of capturing images of various construction items.

To initiate an inspection imaging process, inspectors select the camera tab 45004, shown in FIG. 66, manipulate the smartphone 19000 in the direction of inspected items, and take photos, images or videos. As shown in the exemplary embodiment of FIG. 67, smartphone 19000, via the built-in camera 19002, is maneuvered to capture an image of a construction item, shown as a door. Inspectors may take a host of images or videos during the inspection process and store such images, as shown at 47000, in FIG. 68. Inspectors can simply browse through the images, delete unwanted images, and selectively store the relevant images to include in the final inspection report.

The field inspector interface 206, of the present invention, also takes advantage of other features provided in smartphone 19000, including a built-in GPS receiver 19003 and geotagging features. Preferably, smartphone 19000 includes one or more built-in GPS chips and geotag software for geotagging images or photos taken during the inspection process. Geotagging generally comprises a process of adding geographical identification metadata (geo-info) to images by storing the information in exchangeable image file (Exif) or Extensible Metadata Platform (XMP) format. The GPS functions to determine the location of the smartphone device that houses the GPS receiver 19003, and since the smartphone is typically operated by the inspector, the GPS functions to provide information regarding the physical location or point-position of inspectors. Point-position of inspectors can provide a host of information including, but not limited to, latitude & longitude coordinates, elevation, dates, and times, and other variety of other information. Some smartphones may also include a compass to indicate the direction in which the camera was facing when the photos were taken. Thus, the position of the user of the smartphone (i.e., the position of inspectors) is associated with the digital images or videos that were taken on-site during the inspection process. The GPS receiver 19003 is used to log the location of the image (via the location of the user) where the GPS information is automatically or manually added to the Exif data of images.

Although many smartphones automatically geotag images or photos by default, it will be noted that it is important for inspectors to verify that the geotagging feature is activated on the smartphone 19000. Activation settings can be determined by accessing the settings menu and selecting the correct settings for activating the GPS feature, and geo-tag features. Some representative geotag features may be entitled, “Store Location in Pictures”, or “Geo-tag Photos”. In one non-limiting example, the field inspections app may alert inspectors to make sure the geotag features are set and operational, by sending inspectors a comment, message or other communication indicating to set the geotag features.

Though a smartphone 19000 with a built-in camera, GPS receiver 19003, and geotagging features, provides an effective means for taking images, inspectors may use other electronic devices to take photos or images of construction items throughout the inspection process. For example, inspectors may use a digital camera with a built-in GPS receiver. Many GPS-ready digital camera manufacturers offer digital cameras that include built-in GPS receivers. The geotagged images can be uploaded to the CLMS platform 200, where the geo-module 213 extracts the geotagged information from the images to determine image location coordinates.

In situations where a camera does not contain a built-in GPS receiver, inspectors may use a digital camera that supports an external GPS receiver, where the GPS receiver is connected to the digital camera, via a cable, or is inserted into a memory card slot or flash shoe. Though this method may be a little more cumbersome for inspectors, it allows for continued use of the camera should the GPS be damaged. Alternatively, inspectors may use a digital camera and a separate, standalone GPS device. This method, however, requires inspectors to synchronize the clocks of each device. Geotag module 213 may include software for analyzing synchronized time of the camera and standalone GPS, to determine location of images. Again, the inspector interface 205 may alert or remind inspectors to synchronize device clocks.

Automatically geotagging images or videos is efficiently accomplished by capturing GPS data at the time of taking the images or videos, however, the geotagging process requires use of a GPS receiver. In situations where inspectors do not have access to a GPS receiver, then a method of determining location coordinates of images is to manually geotag the images using location approximation methods based on property addresses, zip codes, street names, or other property information. The mobile inspection app may utilize or have access to, private or public software mapping programs or services for mapping location of properties based on approximation data.

The field inspector interface app provides flexibility for inspectors to use a variety of devices to take images during the inspection process and upload the images onto the CLMS platform 200. Inspectors may use a device such as a smartphone 19000 that includes a built-in camera 19002 and built-in GPS receiver 19003, a digital camera that includes a built-in GPS receiver, a digital camera that supports an external GPS receiver, via a cable or memory slot, a digital camera and a separate handheld GPS device where the clocks of the devices are synchronized, or a digital camera and no GPS receiver, using location approximation techniques.

The inspection items screen 45000, as shown in FIG. 66, includes a review inspection tab 45005 that, when selected, directs inspectors to a review inspection screen 48000, illustrated in FIG. 69. As shown, review inspections screen 48000, provides several progress values that are identified as: previous progress 48001, showing the progress value since the last inspection conducted, if any; inspection 48002, showing the progress value as a result of the currently inspected items; and new total 48003, showing the total progress to date of constructing the building; where the total progress is represented by the progress value of the previous progress and the progress value attributed to the current inspections. It will be noted that in the exemplary embodiment, such progress values are represented as percentages, but other values may be used such as loan or item budget funds. In the example, a previous progress indicator 48001 shows that 43% of a building was constructed on the listed property before inspections were conducted. Inspections were made on several construction items, such as HVAC system, plumbing, and/or bedrooms and living. An inspection progress value, attributed to the completed inspections of the current day, is determined and the completed inspection is assigned a progress percentage, shown at 48002. The previous progress percentage and the current inspection progress percentage are added to provide a total, overall progress percentage, shown at 48003. Thus, inspectors can access review screen 48000 to visually determine previous, current, and total progress values regarding the construction building of interest. It will be understood that the new total progress value is not the same as progress values assigned to individual construction items. The new total progress value 48003 indicates the total progress of constructing the building as a whole. Progress values assigned to individual construction items indicate the progress in constructing each corresponding item.

Once inspectors have finished inspecting items, have assigned item progress values, have taken images of relevant construction items, and have reviewed inspections, the inspectors may proceed to complete the inspection report by selecting complete inspection tab 48004, as shown in FIG. 69 where inspectors are prompted with a finalize inspection screen 49000, shown in FIG. 70. Inspectors may use a pop-up keyboard 49001 provided, via smartphone 19000, to add summary notes or messages regarding completed inspections. When finished, inspectors simply initiate the finalize inspection tab 49002.

Turning again to FIG. 51, inspectors may upload the finalized inspection report onto the CLMS system platform, by selecting the upload tab in the inspector task menu 3000. In selecting the upload tab, inspectors are presented with an upload screen 50000, shown in FIG. 71. The upload screen 50000 includes a list of completed inspection reports for each listed property that are readily available for submission, via submit tab 50001.

Inspector signatures are solicited to provide final confirmation of completed inspection reports before submitting the inspection reports, as better illustrated in FIG. 72. Soliciting inspector signatures gives credibility to the inspection process and reports, confirms the identity of the person doing the inspections, allocates accountability to inspectors in providing accurate, and correct results, and assures integrity in the construction loan management process. Inspector signatures may be processed via the verification module 214 that includes software encryption or cryptographic protocols, such as public-key cryptography, which uses a signature scheme including public and private key generation algorithms, signing algorithms, and signature verifying algorithms. Alternatively, smartphone 19000 may include digital signature software for mobile devices based on RSA public key algorithms for example. The signed inspection report is submitted and uploaded onto the CLMS platform, via submit tab 60001 where the inspection report is stored on the CLMS system.

It will be noted that either the verification module 214 or the digital signature software for mobile devices, may include jurisdiction-based signature modules where inspectors are prompted with proper digital signature or electronic signature protocols to satisfy e-signature laws of various states or jurisdictions. The jurisdiction-based signature modules may be separately included in the services module block 202 or made part of the jurisdiction module 215.

In promoting efficiency, accuracy, and credibility throughout the inspection management process, the construction loan management system 100, of the present invention, includes a geotag verification protocol for verifying uploaded inspection reports. An important aspect of the present invention is to verify inspections were conducted, on correct properties, on the right scheduled dates, on correct construction items, and by property assigned inspectors. The verification protocol eliminates the need of having to reschedule inspections as a result of such errors, reduces costs and expenses, eliminates unnecessary traveling, assures accuracy of inspections and inspection results, and corroborates system integrity.

Geotag module 213, as shown in FIG. 2, hosts, or has access to public or private, geotagging extraction software for extracting geotagged information that is embedded in images that are taken on-site by inspectors, via smartphone 19000. In one representative example, the geotagged information includes latitude/longitude coordinates, and time stamp information such as date and time. The geotagged information, including the latitude/longitude coordinates and time stamp information, is extracted from the images taken on-site at property locations, and saved in loan-related geo-files that may be stored in system memory 130, on servers 116, or in database 131.

Verification module 214, hosts, or has access to, public or private, property location software for determining geographic latitude/longitude coordinates from canonical addresses of properties that were initially setup by loan administrators. The determined latitude/longitude coordinates are saved in loan-related, property files, and stored in system memory 130, on servers 116, or in database 131.

Verification module 214 processes the information derived from both the loan-related geo-files and property files and compares the latitude/longitude coordinates of each property with the latitude/longitude coordinates of the images or inspection reports taken on each property to determine whether the inspector was at the correct property location, on the scheduled date, and inspecting the correct building-related construction items. If the comparison process results in a proper match, the images are filed and stored accordingly for access by users. However, if the comparison process results in an improper match, where location coordinates of a property do not match with the extracted geotag coordinates of images taken, then notification is given to loan or bank administrators prompting further review and analysis.

Turning now to FIG. 73, there is shown a block diagram illustrating a synopsis of the inspection and geotag verification process, in accordance with one embodiment of the present invention. It is noted that loan admins have previously set up construction loan accounts and created loan information such as borrower and inspector profile information, created construction item templates, and included loan financials. Disbursement of funds is not only predicated on draw requests, and the approval process, but also on completed inspections. The inspection process generally starts 61000 with inspection requests being initiated from loan or bank admins, or from borrowers who initiate inspection requests in contemplation of satisfying draw requests and receiving allocated funds. Loan or bank admins forward notification of inspection requests to assigned inspectors, via email 61002.

Once inspectors receive email(s) regarding inspection requests, inspectors uses a client device, such as a smartphone 19000, in one exemplary embodiment, that includes a built-in camera 19002, and a built-in GPS receiver 19003 to launch the field inspector interface app 61004. Inspectors may access a bookmark that was previously created for the field inspector interface app or access an icon situated on the phone's homepage to launch a native app. Upon launching the field inspector interface app, inspectors are prompted with a log-in screen for accessing the construction loan management system platform 200.

Upon authenticated access to the CLMS platform 200, inspectors are directed to the homepage which includes the schedule inspection page 20000, shown in FIG. 50, showing a list of scheduled inspection properties 61006. Inspectors can view which properties are scheduled for inspection, and plan their driving routes accordingly. Inspectors may utilize the map tab in the inspector task menu 30000 to acquire driving directions that may be generated from an optimized routing software system and based on locations of inspections.

Inspectors travel to scheduled inspection property locations to conduct inspections. Inspectors select listed properties on schedule inspection page 20000 to review details of inspection items as provided on inspection items screen 42000, shown in FIG. 63. Inspectors inspect designated construction items in accordance with building codes, specifications, and regulations. Inspectors utilize the built-in camera 19002 of the smartphone 19000 to take photos of inspected construction items. The photos or images are stored in the loan-related file for further processing. Inspectors assign progress values to inspected items in accordance with their training, experience, and knowledge 61008.

Upon completion of the inspection process, inspectors prepare and finalize inspection reports and upload the completed inspection reports onto the CLMS system, denoted at 61010. Thus, inspectors browse through stored images, delete unwanted images, and select relevant images of interest for the inspection report. Inspectors may leave comments regarding inspections, include inspection summaries, and review inspection reports. Inspectors sign or initialize the completed inspection reports and submit the reports by uploading the inspection reports onto the CLMS platform.

Geotag module 213 extracts geotagged information that was embedded in the inspection images to determine latitude/longitude coordinates, and time stamp information such as date and time, which is saved in loan-identified geo-files, and stored in memory 130 or database 131, 61012.

Verification module 214 determines geographic latitude/longitude coordinates from canonical addresses of properties that were initially setup by the loan administrator, and compares the latitude/longitude coordinates of each property with the latitude/longitude coordinates of the images or inspection reports to determine whether the inspector was at the correct property location on the scheduled date, shown at 61014.

If the comparison process results in a proper match, the images are filed and stored accordingly for access by users in corresponding loan items list, shown at 61016. However, if the comparison process results in an improper match, where location coordinates of a property do not match with the extracted geotag coordinates of images taken, then loan admins, bank admins, or borrowers are notified of the discrepancy, as illustrated at 61018.

In one embodiment, verification module 214 may also extract loan-related information regarding assigned inspectors, scheduled inspection dates, and construction items, and include the information in each property file. For example, verification module 214 may compare e-signatures of inspectors with the names of inspectors assigned by loan admins, and may also compare inspection images taken with the construction items scheduled for inspection to confirm identity of inspectors and proper inspection of construction items.

The construction loan management system 100 also includes a bank administrator (bank admin) interface 206 as provided in the services interface block 201. The bank admin interface 206 functionalities include at least the same logical processes, functions, operations, parameters, tasks, operatives, tabs, and accessible loan management information as provided to the loan admins, via the loan admin interface 203. Thus, in one exemplary embodiment, the bank admin interface functions to allow banks or associated branches to: view and manage construction loans; view, approve, and decline draw requests; view items, inspections, transactions, files, people, and comments regarding construction loans; view thumbnail images; edit draw tickets; add, set up, create, and manage new construction loan information regarding borrowers, builders, loans, properties, inspectors, inspection templates, branch, loan, and draw administrators; assign progress values; view mapped property locations on maps; find loans; manage inspection and draw requests; see historical and reports of construction loans; review borrower loan portfolios; create and view comments; and manage account settings. Bank admins may also access the loan activity menu 540 to request draws, change loan status, approve or deny draw requests, cancel and modify inspections, add a disbursement method, change bank branches, edit property address, edit financials, export loan data, refresh calculations, and flag loans.

The construction loan management system 100 includes user-specific interfaces defined by a loan admin interface 203, a borrower interface 204, a field inspector interface 205, a bank admin interface 206, and other interfaces 207. Each interface includes user-defined roles and functionalities for managing construction loan services. Such user-defined roles are governed by a hierarchy of permissions and operative levels assigned to individuals for administrating construction loan services including granting control access to various aspects of the system, allowing certain actions such as, approving or denying draws, requesting draws and inspections, or setting up accounts, and providing restrictive permissions such as reading only information with no permission to write or enter information.

Some non-limiting examples of user-defined roles include: 1.) bank admin users having full read/write access into all bank loans and settings (the bank admin has the most permissions of all bank users); 2.) bank read-only users having full read access into all bank loans and reports (many times bank executives and audit users will be assigned to this role); 3.) branch admin users having full read/write access into all loans and settings of the associated branch (branch may refer to a geographic location or an individual such as a lender) and any child branches (this user may often be associated with branch managers and may or may not receive individual notifications for draw or inspection requests); 4.) branch read-only users having full read access into all loans and reports of the associated branch and any child branches; 5.) draw admin users having read access into all loans of the associated branch and any child branches. These users can process draws at an associated branch or any child branches. This role assigned to draw admins (at banks with centralized processing) or tellers (at banks with local processing) who are processing the funds for the draws; 6.) elevated loan admin users having full read/write access into all loans and settings of the associated branch and any child branches, however, unlike the branch admin role, elevated loan admins receive notifications regarding inspection completion and draw requests. This user is typically an everyday user generally responsible for loan servicing; 7.) elevated loan originator users having full read access into all loans and reports of the associated branch and any child branches, however, this user can input draft loans as well as request inspections and draws; 8.) elevated read-only users having full read access into all loans and reports of the associated branch and any child branches, however, this user can also request inspections and draws; 9.) loan admin users having read access into all loans of the associated branch and any child branches. These users can add loans, request inspections, and request/process draws at associated branch or any child branches. These users may or may not be able to edit financial information after the loan has been activated. Loan admin users receive individual notifications for each inspection and draw request of the loans in which they are assigned; 10.) loan originator users having full read access into all loans and reports of the associated branch and any child branches, however, this user can input draft loans; 11.) builder/borrower admin users having full read access into all loans of associated company accounts. These users can request inspections and draws, upload files, post comments. The primary builder/borrower admin receives email notifications when inspections are completed and draws are transferred; 12.) builder/borrower read-only users having full read access into all loans of associated company account(s); 13.) inspector admin users having full read access into all loans of associated company accounts. These users can perform inspections, upload files, and post comments. All properties assigned to these users by default, but they can reassign them to field inspectors; 14.) field inspector users having read access into assigned properties. These users can perform inspections, upload files, and post comments on assigned properties; and 15.) inspector read-only users having full read access into all loans of associated company account(s).

As variations, combinations and modifications may be made in the construction and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but defined in accordance with the foregoing claims appended hereto and their equivalents.

1. A method of managing tasks related to real estate construction loans, said method comprising:
using a construction loan management computer accessible by one or more client devices over a communication network, each client device comprising a display screen, memory, and one or more processors able to receive, send, and display information, the construction loan management computer including one or more computer processors, computer readable memory, and a loan management software application stored in the computer-readable memory and executed by the one or more processors, said loan management software application comprising:
a plurality of loan service modules including a geotag module and a verification module, each of said plurality of loan service modules in operation with user-specific interfaces navigated by users to set-up, operate, and manage construction loans, said user-specific interfaces including a mobile inspector interface comprising a native application stored on, or a mobile web application accessible by, said one or more client devices, said mobile inspector interface providing authenticated access to said loan management computer, to display on said display screen of said one or more client devices, a plurality of tasks associated with a plurality of task-based screens and scheduled inspection properties and managed by said construction loan management computer, each of said plurality of tasks selected by inspectors, to manage scheduled inspections, where inspectors upload completed inspection reports onto said construction loan management computer and where said geotag module extracts geotag information from said uploaded inspection reports and images taken by said one or more client devices, where said verification module determines geographic coordinates from canonical addresses of scheduled inspection properties and compares said geographic coordinates of said scheduled inspection properties with said extracted geotag information to verify attributes of said completed inspection reports and said images, said attributes including any of location of inspectors, location of images, identity of construction items, identity of inspectors, longitude and latitude coordinates, dates or times, where notification is generated and displayed to determine whether to loan money to borrowers to satisfy pending draw requests and future draw requests, if said geographic coordinates of said scheduled inspection properties do not match with said extracted geotag information, and where said uploaded inspection reports and said images are accessibly stored in data files associated with said scheduled inspection properties, and money is made available to borrowers to satisfy said pending draw requests and said future draw requests, if said geographic coordinates of said scheduled inspection properties match with said extracted geotag information.

2. A method of managing tasks related to real estate construction loans of claim 1, wherein said plurality of tasks includes a calendar task enabling inspectors to access a calendar screen to view scheduled inspections corresponding to particular calendar dates, and further enabling inspectors to change previously scheduled inspection dates by entering new rescheduling dates, selectable from a date selector provided in said calendar screen, where upon selection of said new rescheduling dates, inspectors are directed to a confirmation screen to confirm entry of rescheduling dates.

3. A method of managing tasks related to real estate construction loans of claim 2, wherein said plurality of tasks includes a map task, enabling inspectors to access a geographical map screen showing mapped scheduled inspection properties, each inspection property represented by a corresponding property marker, and mapped according to either, latitude/longitude coordinates, or location approximation data, each mapped property marker selectable by inspectors, to at least view detailed information, corresponding to the scheduled inspection property associated with said selected mapped property marker.

4. A method of managing tasks related to real estate construction loans of claim 3, wherein each of a plurality of inspection items, provided in an inspection screen, is assigned a project value for representing a part of a completely constructed building, and an item progress value for representing a value of completed construction of said item, each of said plurality of inspection items including, a corresponding progress value tab enabling inspectors to change assigned item progress values of each of said inspection items, and a visual indicator corresponding to said item progress value.

5. A method of managing tasks related to real estate construction loans of claim 4, wherein said inspection screen further includes an information tab, selectable by inspectors, to access a property details screen showing details of selected scheduled inspection properties, and a map-it tab, selectable by inspectors, to access said geographical map screen to view mapped property markers corresponding to selected scheduled inspection properties.

6. A method of managing tasks related to real estate construction loans of claim 5, wherein said plurality of tasks includes a submit error task and a comment task, each enabling inspectors to access a submit error screen, and a comment screen, respectively, to generate and send comments pertaining to errors, inspection processes, scheduled inspection properties, or any of said inspection items, said comment screen including generated responses, if any, represented by a response indicator, said response indicator, selectable by inspectors to access a discussion screen showing details of said generated responses.

7. A method of managing tasks related to real estate construction loans of claim 6, where said inspection screen further includes a camera tab selectively enabling inspectors to utilize one of said client devices including a built-in camera and built-in global positioning system receiver, to capture images of said inspection items associated with scheduled inspection properties, and to store selected images, each of said selected images and said completed inspection report geotagged with geotag information including at least geographic coordinates defined by latitude and longitude coordinates, date and time.

8. A method of managing tasks related to real estate construction loans of claim 7, where said inspection screen further includes a review inspection tab enabling inspectors to access a review screen including: a list of finalized inspection items; building progress values including, a previous progress value representing a construction value of a completely constructed building before completion of one or more inspections; an inspection progress value representing a change in said construction value of said completely constructed building after completion of said one or more inspections; and a total progress value representing an added sum of said previous progress value and said inspection progress value.

9. The method of managing tasks related to real estate construction loans of claim 8, where said review screen includes a complete inspection tab, enabling inspectors to access a finalize inspection screen to enter inspection summaries using a virtual keyboard provided on said one or more client devices, said finalize inspection screen including a finalize inspection tab enabling inspectors to access an upload screen to submit inspection reports including selected images, where inspectors are presented with a confirmation screen to enter inspector's signatures, the confirmation screen including a submit tab for uploading completed inspection reports and said selected images to said construction loan management computer, said upload screen also being accessible, via an upload task included in said plurality of tasks.

10. (canceled)

11. The method of managing tasks related to real estate construction loans of claim 10, wherein said user-specific interfaces further include a loan administrator interface, and a bank administrator interface, each interface displaying, on said display screen of said one or more client devices, a plurality of loan admin management screens including a loan task bar, and a loan account bar, for setting-up, managing, and reviewing, construction loans and loan-related information, where such loan-related information includes borrower and inspector profile information, loan financials, property information, construction items templates, inspection settings, inspection requests, general and itemized draw requests, loan-related transactions, loan-related files, people contact information, and inspection images.

12. The method of managing tasks related to real estate construction loans of claim 11, wherein said user-specific interfaces further include a borrower interface displaying, on said display screen of said one or more client devices, a plurality of borrower loan screens, one of said plurality of borrower loan screens including a list of selectable borrower tasks, a borrower task bar, and a borrower account bar, said interfaces for managing construction loans and loan-related information, and said list of selectable borrower tasks including, a request draws task, a request inspections task, a search for loans task, a construction portfolio summary task, a manage account settings task, and a support center task.

13. The method of managing tasks related to real estate construction loans of claim 12, wherein said communication network comprise a wired, or wireless network, and where said one or more client devices includes any of a kiosk, a desktop computer, a tablet, a PDA, a notebook or laptop computer, or a thin client hardware comprising a computer terminal including I/O interfaces and open, serial or parallel ports, and client software including cloud access agents, a web browser, or graphical user interface.

14. A method of managing real estate construction loans, said method comprising the steps of:
storing a loan management software application in a computer-readable memory executed by one or more processors of a construction loan management computer, said construction loan management computer accessible by one more client devices over a communication network, each client device including a display, a processor, and capable of receiving and sending information, said loan management software application including a plurality of loan service modules operating with user-specific interfaces including, a loan administrator interface, a bank administrator interface, a borrower interface, and a mobile inspection interface, said interfaces viewable in said display of said one or more client devices;
downloading said mobile inspector interface onto said one or more client devices, or accessing said mobile inspector interface that is stored on said loan management computer with said one or more client devices, said mobile inspector interface including a plurality of tasks, managed by said construction loan management computer, and associated with a plurality of task-based screens;
presenting a log-on screen to users accessing said construction loan management computer with said one or more client devices over said communication network, said log-in screen soliciting entry of user authentication credentials;
granting authenticated access to users, and presenting users with user-specific loan management screens tailored for each user-specific interface, and navigated by users to perform user-defined roles and functionalities for administrating and managing construction loans;
presenting one or more of said plurality of tasks to field inspectors, said one or more of said plurality of tasks selected for accessing one or more of said plurality of task-based screens for managing scheduled inspections;
determining geographic coordinates from canonical addresses of scheduled inspection properties;
uploading completed inspection reports and images onto said construction loan management computer;
extracting geotag coordinates from said completed inspection reports, and from said images;
verifying attributes of said uploaded completed inspection reports and said images by comparing said geographic coordinates of said scheduled inspection properties with said extracted geotag coordinates of said completed inspection reports and said images, said attributes including any of location of inspectors, location of images, identity of inspection items, identity of inspectors, longitudinal or latitude coordinates, dates, and times;
generating and displaying one or more notice indicators to determine whether to loan money for pending draw requests and future draw requests, if said geographic coordinates of said scheduled inspection properties do not match with said extracted geotag coordinates of said completed inspection reports and images; and
storing said completed inspection reports and said images in data files associated with said scheduled inspection properties, and loaning money to satisfy said pending draw requests and said future draw requests, if said geographic coordinates of said scheduled inspection properties match with said extracted geotag coordinates of said completed inspection reports and said images.

15. The method of claim 14, wherein the step of presenting one or more of said plurality of tasks includes the step of presenting a schedule task, selected to access a schedule screen including scheduled inspection properties, said schedule screen enabling inspectors to select said scheduled inspection properties to access an inspection screen including inspection items corresponding to said selected scheduled inspection property, said schedule screen further including a menu tab enabling inspectors to access a menu screen including said plurality of tasks.

16. The method of claim 15, wherein the step of presenting one or more of said plurality of tasks includes the step of presenting a calendar task, selected to access a calendar screen including scheduled inspection properties corresponding to particular calendar dates, and further enabling inspectors to change previously scheduled inspection dates by entering new rescheduling dates selected from a date selector provided in said calendar screen, where upon entering said new rescheduling dates, inspectors are directed to a confirmation screen confirming entry of said newly entered rescheduling dates.

17. The method of claim 16, wherein the step of presenting one or more of said plurality of tasks includes the step of presenting a map task, selected to access a geographical map screen to view mapped scheduled properties on said geographical map screen, each mapped scheduled property is represented by a corresponding property marker, each property marker mapped according to latitude/longitude coordinates, or location approximation data of each scheduled property, each property marker accessible by inspectors to at least view detailed information regarding inspection items associated with each scheduled inspection property.

18. The method of claim 17, wherein the step of accessing one or more of said plurality of tasks-based screens includes the step of accessing said inspection screen, including said inspection items, each inspection item being assigned a project value representing a part of a completely constructed building, and an item progress value, representing a value of completed construction of said item, each inspection item including a corresponding item progress value tab enabling inspectors to change assigned item progress values of each inspection item, and a visual indicator corresponding to said item progress value.

19. The method of claim 18, wherein the step of accessing one or more of said plurality of task-based screens includes the step of accessing said inspection screen, said inspection screen further including an information tab, selected for accessing a property details screen including detailed information of said selected scheduled inspection property, and a map it tab, selected for accessing said geographical map screen to view property markers of selected scheduled inspection properties.

20. The method of claim 19, wherein the step of presenting one or more of said plurality of tasks includes the step of presenting a submit error task and a comment task, each selected for accessing a submit error screen and a comment screen, respectively, for generating and sending comments pertaining to errors, inspection processes, scheduled inspection properties, or any of said inspection items, said comment screen including generated responses, if any, represented by a response indicator, said response indicator selected for accessing a discussion screen showing details of said generated responses.

21. The method of claim 20, wherein the step of accessing one or more of said plurality of task-based screens includes the step of accessing said inspection screen, said inspection screen further including a camera tab selectively enabling inspectors to utilize one of said client devices including a built-in camera and a built-in global positioning system receiver to capture and store images of said inspection items associated with scheduled inspection properties, each of said images and said completed inspection report geotagged with said geotag coordinates defined by latitude and longitude coordinates, and date and time.

22. The method of claim 21, wherein the step of accessing one or more of said plurality of task-based screens includes the step of accessing said inspection screen, said inspection screen further including a review inspection tab enabling inspectors to access a review screen, said review screen including a list of finalized inspection items and building progress values, including a previous progress value representing a construction value of a completely constructed building before completion of one or more inspections, an inspection progress value representing a change in said construction value of said completely constructed building after completion of said one or more inspections, and a total progress value defined by an added sum of said progress value and said inspection progress value.

23. The method of claim 22, wherein the step of accessing one or more of said plurality of task-based screens includes the step of accessing said review screen, said review screen further including a complete inspection tab, enabling inspectors to access a finalize inspection screen to enter inspection summaries using a virtual keyboard provided on said one or more client devices, said finalize inspection screen including a finalize inspection tab, enabling inspectors to access an upload screen to submit inspection reports, where inspectors are presented with a confirmation screen for entering inspector signatures or initials, said confirmation screen including a submit tab for uploading completed inspection reports to said construction loan management computer, said upload screen also accessible via, an upload task included in said plurality of tasks.

24. (canceled)

25. The method of claim 24, further including the step of verifying digital or electronic signatures of inspectors using software encryption or cryptographic protocols, such as public-key cryptography, which uses a signature scheme including public and private key generation algorithms, signing algorithms, and signature verifying algorithms, or using digital signature software for mobile devices.

26. A method of managing tasks related to real estate construction loans of claim 4, wherein said inspection screen further includes a list of completed inspection items that are grouped under an identifying banner situated subsequent to a list of non-completed inspection items.

27. The method of claim 21, wherein the step of accessing said inspection screen includes the step of grouping a list of completed inspection items under an identifying banner situated under a list of non-completed inspection items.
